(19) United States
(12) Patent Application Publication
(10) Pub. No.: US 2026/0000175 A1
(43) Pub. Date: Jan. 1, 2026

(54) BAGS AND BAG ASSEMBLIES

(71) Applicant: Acushnet Company, Fairhaven, MA (US)

(72) Inventors: Brian J. McGuire, Phoenix, AZ (US); Christian B. Brown, Somerville, MA (US); John T. Byrne, Norwell, MA (US); Zujie Zhang, Dongguan (CN); Yongliang Xie, Dongguan (CN); Qibin Lu, Dongguan (CN); Songlin Qu, Dongguan (CN)

(73) Assignee: Acushnet Company, Fairhaven, MA (US)

(21) Appl. No.: 19/320,001

(22) Filed: Sep. 5, 2025

Related U.S. Application Data
(63) Continuation-in-part of application No. 19/197,250, filed on May 2, 2025.
Application No. 19/197,250 is a continuation-in-part of application No. 18/977,565, filed on Dec. 11, 2024.
Application No. 18/977,565 is a continuation-in-part of application No. 18/882,697, filed on Sep. 11, 2024.
Application No. 18/882,697 is a continuation-in-part of application No. 29/945,981, filed on Jun. 6, 2024.
Application No. 29/945,981 is a continuation-in-part of application No. 29/946,015, filed on Jun. 6, 2024.
Application No. 29/946,015 is a continuation-in-part of application No. 29/946,022, filed on Jun. 6, 2024.
Application No. 29/946,022 is a continuation-in-part of application No. 29/946,039, filed on Jun. 6, 2024.

(51) Int. Cl. A45C 13/38; A45C 5/03; A45C 13/00; A45C 13/26; B62B 3/02

(52) U.S. Cl. CPC A45C 13/385; A45C 5/03; A45C 13/001; A45C 13/262; A45C 2005/037; A45C 2013/267; A45C 2200/10; B62B 3/025

(57) ABSTRACT

A bag comprising a body, a shell, a leg mechanism comprising a first leg pivotably coupled to a first portion of the shell, a second leg pivotably coupled to a second portion of the shell, and a cross member extending between the first leg and the second leg, a handle assembly comprising a handle and a first member pivotably coupled to a third portion of the shell, wherein the handle assembly is configured to pivot between a first position and a second position; a latch mechanism integrated with the first member and operatively coupled to the handle, wherein the latch mechanism comprises an engagement feature that is operable by manipulating the handle, and a second member connecting the first member to the cross member, wherein the second member is configured to receive the engagement feature in order to lock the leg mechanism in an extended position.

### CROSS REFERENCE

This application is a Continuation-in-Part of U.S. patent application Ser. No. 19/197,250 filed on May 2, 2025, which is a Continuation-in-Part of U.S. patent application Ser. No. 18/977,565 filed on Dec. 11, 2024, which is a Continuation-in-Part of U.S. patent application Ser. No. 18/882,697 filed on Sep. 11, 2024, which is a Continuation-in-Part of U.S. patent application Ser. No. 29/945,981 filed on Jun. 6, 2024, U.S. patent application Ser. No. 29/946,015 filed on Jun. 6, 2024, U.S. patent application Ser. No. 29/946,022 filed on Jun. 6, 2024, and U.S. patent application Ser. No. 29/946,039 filed on Jun. 6, 2024, each of which is incorporated herein by reference in its entirety for all purposes.

### BACKGROUND

The movement and transportation of items and/or equipment can involve the storage or placement of the items and/or equipment in one or more bags. In some cases, the bags used to move and transport the items and/or equipment can play an important role in how easily and how safely the items and/or equipment can be moved or transported.

### SUMMARY

The present disclosure provides various non-limiting examples of bags that can be used to carry or transport items and/or equipment. In some cases, the bags disclosed herein may be configured for subjects who travel frequently with multiple bags containing personal items and/or professional equipment. In some cases, the bags disclosed herein may be configured to meet the demands of avid travelers who expect their bags to reliably protect their personal items and/or professional equipment day in and day out. In some cases, the bags disclosed herein may be configured to withstand tough travel conditions or environments with ease so that travelers can move or transport their personal items and/or professional equipment without worrying about damaging their bags or the contents within their bags.

In some cases, the bags disclosed herein may include one or more covers that can shield and protect the bags and the contents of the bags from damage or wear due to physical impacts and/or exposure to external climates or conditions. In some cases, the covers may be contoured to allow the bags to be nested together in series or in tandem for convenient and stable transport.

In some cases, the bags disclosed herein may be linked or connected to one or more other bags to simplify the movement and transport of multiple bags at once. In some cases, the bags disclosed herein may be linked or connected together to form a self-stabilizing or a self-stabilized bag assembly so that a subject can simultaneously move or transport multiple bags together with minimal effort.

In one aspect, the present disclosure provides one or more bags for transporting or moving items and/or equipment. In some embodiments, the one or more bags may be connected or linked together to form a bag assembly. In some embodiments, the bag assembly may comprise at least a first bag and a second bag.

In some embodiments, the bag assembly may comprise a first bag. In some embodiments, the first bag may comprise a top surface, a bottom surface, a front surface, a back surface, and a plurality of side surfaces arranged to form an enclosed interior region for storing items or equipment within the first bag. In some embodiments, the first bag may comprise a first protective cover extending along the back surface of the first bag. In some embodiments, the first bag may comprise a first handle assembly comprising a first handle and a first plurality of support members attached to the first handle. In some embodiments, the first handle assembly may be positioned (i) external to the enclosed interior region of the first bag and (ii) between the first protective cover and the back surface of the first bag so that the first handle assembly is retractable into a partially enclosed region provided between the first protective cover and the back surface of the first bag. In some embodiments, the first bag may comprise a first connector assembly comprising a first external strap with a single connecting fastener attached to the first external strap. In some embodiments, the connecting fastener may be positionable or securable along the front surface of the first bag.

In some embodiments, the bag assembly may comprise a second bag. In some embodiments, the second bag may have a greater length, height, and/or width than the first bag or a larger storage volume than the first bag. In some embodiments, the second bag may comprise a top surface, a bottom surface, a front surface, a back surface, and a plurality of side surfaces arranged to form an enclosed interior region for storing items or equipment within the second bag.

In some embodiments, the second bag may comprise a second protective cover extending along the back surface of the second bag. In some embodiments, the second bag may comprise a second handle assembly comprising a second handle and a second plurality of support members attached to the second handle. In some embodiments, the second handle assembly may be positioned (i) external to the enclosed interior region of the second bag and (ii) between the second protective cover and the back surface of the second bag so that the second handle assembly is retractable into a partially enclosed region formed between the second protective cover and the back surface of the second bag. In some embodiments, the second bag may comprise a second connector assembly with a different configuration or arrangement of connectors than the first connector assembly. In some embodiments, the second connector assembly may comprise a second external strap with a first fastener and a second fastener attached to the second external strap. In some embodiments, the first fastener may be provided along the top surface of the second bag and the second fastener may be positionable or securable along the front surface of the second bag. In some embodiments, the first fastener may be configured to engage the connecting fastener attached to the first external strap of the first bag. In some embodiments, the first external strap may be configured to extend under the second handle and between the second plurality of support members to facilitate a coupling between the connecting fastener of the first bag and the first fastener of the second bag.

In some embodiments, the first connector assembly may comprise a first complementary fastener provided along the front surface of the first bag. In some embodiments, the first complementary fastener may be configured to engage the connecting fastener of the first bag when the connecting fastener and the first fastener are decoupled. In some embodiments, the connecting fastener may be positionable along the front surface of the first bag to facilitate a coupling between the connecting fastener and the first complementary fastener. In some embodiments, the connecting fastener may be extendable towards the top surface of the second bag to facilitate a coupling between the connecting fastener and the first fastener of the second bag.

In some embodiments, the second connector assembly may comprise a second complementary fastener provided along the front surface of the second bag. In some embodiments, the second complementary fastener may be configured to engage the second fastener to secure the second fastener along the front surface of the second bag.

In some embodiments, the first fastener may be oriented in a first direction when the first fastener is secured to the connecting fastener. In some embodiments, the second fastener may be oriented in a second direction that is perpendicular or orthogonal to the first direction when the second fastener is secured to the second complementary fastener. In some embodiments, the second fastener may be oriented towards the bottom surface of the second bag when the second fastener is secured to the second complementary fastener. In some embodiments, the first fastener may be oriented towards the back surface of the second bag and towards the front surface of the first bag when the first fastener is secured to the connecting fastener. In some embodiments, the first fastener may be oriented towards the back surface of the second bag and towards the front surface of the first bag when the first fastener and the connecting fastener are decoupled.

In some embodiments, the second connector assembly of the second bag may include a same number of connectors or a same type of connector as the first connector assembly of the first bag. In some embodiments, the second connector assembly of the second bag may include a different number of connectors or a different type of connector than the first connector assembly of the first bag.

In some embodiments, the first protective cover may be sized and/or shaped differently than the second protective cover. In some embodiments, the first protective cover and the second protective cover may have one or more common surface features. In some embodiments, the second protective cover may include one or more surface features defining a surface contour that corresponds to a surface contour of the front surface of the first bag. In some embodiments, the first protective cover and/or the second protective cover may include one or more apertures or windows configured to expose or reveal one or more other components or sub-assemblies of the first bag or the second bag.

In some embodiments, the first bag and/or the second bag may comprise a divider flap. In some embodiments, the divider flap may have a first end secured to a bottom portion of the first bag or the second bag. In some embodiments, the divider flap may have a second end that is securable to a top portion of the first bag or the second bag.

In some embodiments, the bag assembly may optionally comprise a third bag with a third protective cover attached to the third bag. In some embodiments, the third bag may comprise a same type of bag as the first bag and/or the second bag. In some embodiments, the third bag may comprise a third handle assembly comprising a third handle and a third plurality of support members attached to the third handle. In some embodiments, the third bag may comprise a third connector assembly comprising a third fastener provided along a top surface of the third bag and a fourth fastener that is positionable or securable along a front surface of the third bag. In some embodiments, the second external strap of the second bag may be configured to extend under the third handle and between the third plurality of support members to facilitate a coupling between the second fastener and the third fastener.

In some embodiments, the bag assembly may optionally comprise a third bag comprising an elongated travel bag that is sized and/or shaped differently than the first bag and/or the second bag. In some embodiments, the elongated travel bag may comprise a third connector assembly comprising a third fastener provided along a back surface of the elongated travel bag. In some embodiments, the third fastener may be positioned directly above an upper edge of the third protective cover. In some embodiments, the second fastener of the second bag may be configured to engage the third fastener to detachably couple the third bag to the second bag.

In some embodiments, the second connector assembly of the second bag and/or the third connector assembly of the third bag may have a same configuration or arrangement of connectors as the first connector assembly of the first bag. In some embodiments, the second connector assembly of the second bag and/or the third connector assembly of the third bag may have a different configuration or a different arrangement of connectors than the first connector assembly of the first bag.

In another aspect, the present disclosure provides a bag. In some embodiments, the bag may comprise an elongated body configured to receive golf equipment. In some embodiments, the bag may comprise a protective cover extending along a back side of the elongated body, the protective cover comprising a recessed portion formed along a back side of the protective cover. In some embodiments, the bag may comprise one or more wheels or rollers integrated with the protective cover. In some embodiments, the bag may comprise a leg assembly pivotably coupled to the protective cover.

In some embodiments, the leg assembly may comprise a leg member configured to move between a plurality of different locked positions. In some embodiments, the leg member may be movable between (i) a retracted position in which at least a portion of the leg member is positioned within the recessed portion of the protective cover and (ii) an extended position in which at least a portion of the leg member is positioned outside of the recessed portion of the protective cover.

In some embodiments, the leg assembly may comprise a hinged connection coupling the leg member to the protective cover. In some embodiments, the hinged connection may be disposed within the recessed portion of the protective cover.

In some embodiments, the leg assembly may comprise a foot pedal provided along the leg member. In some embodiments, the foot pedal may be configured to release the leg member from the plurality of different locked positions.

In some embodiments, the leg assembly may comprise a foot-activated release mechanism configured to release the leg member from the recessed portion of the protective cover. In some embodiments, the foot-activated release mechanism may be provided within the recessed portion of the protective cover.

In some embodiments, the leg assembly may comprise an additional wheel disposed on a distal end of the leg member. In some embodiments, the additional wheel may be rotatably coupled to the leg member. In some embodiments, the additional wheel may be configured to swivel about the distal end of the leg member. In some embodiments, the additional wheel may be configured to swivel between (i) a first configuration in which the additional wheel is deployable to support or transport the bag and (ii) a second configuration in which the additional wheel is positionable within the recessed portion of the protective cover. In some embodiments, the additional wheel may be configured to rotate about a first axis when the additional wheel is in the first configuration. In some embodiments, the first axis may be parallel to a rotational axis of the one or more wheels or rollers integrated with the protective cover. In some embodiments, the additional wheel may be configured to rotate about a second axis that is different than the first axis when the additional wheel is in the second configuration. In some embodiments, the second axis may be skewed relative to a rotational axis of the one or more wheels or rollers integrated with the protective cover.

In some embodiments, the leg member may be movable between (i) a fully extended position in which the leg member is positioned along an upper portion of the elongated body and (ii) a retracted position in which at least a portion of the leg member is positioned within the recessed portion of the protective cover. In some embodiments, the leg member may be movable between (i) the fully extended position and (ii) one or more other extended positions in which at least a portion of the leg member is positioned outside of the recessed portion of the protective cover.

In some embodiments, the protective cover may include a gap or a spacing provided along an upper edge of the protective cover. In some embodiments, the leg member may be configured to pivot beyond the upper edge of the protective cover by moving through the gap or spacing provided along the upper edge of the protective cover.

In some embodiments, the bag may further comprise a leg member receiving structure provided along the upper portion of the elongated body. In some embodiments, the leg member may be configured to lock into the leg member receiving structure to form a protective spine extending along the back side of the elongated body. In some embodiments, the bag may further comprise an actuator configured to release the leg member from the leg member receiving structure.

In some embodiments, the bag may further comprise a panel or a layer of material configured to cover the recessed portion of the protective cover. In some embodiments, the panel or a layer of material may be used to cover the recessed portion of the protective cover when the leg assembly is retracted into or positioned within the recessed portion of the protective cover.

In another aspect, the present disclosure provides a bag comprising a body and a shell that is attached or coupled to the body. In some embodiments, the shell may comprise a central recessed region and a plurality of recessed regions disposed along the central recessed region.

In some embodiments, the central recessed region may have a different length, width, and/or depth than the plurality of recessed regions. In some embodiments, the central recessed region and the plurality of recessed regions may have a same length, width, and/or depth.

In some embodiments, an upper edge of the central recessed region may be configured to extend along an upper edge of the shell. In some embodiments, the upper edge of the central recessed region may be positioned a first distance from the upper edge of the shell. In some embodiments, an upper edge of the plurality of recessed regions may be positioned a second distance from the upper edge of the shell. In some embodiments, the first distance may be less than the second distance. In some embodiments, the first distance may be greater than the second distance.

In some embodiments, a system may be attached to or integrated with the shell. In some embodiments, the system may be configured to facilitate the handling, maneuvering, movement, and/or transportation of one or more bags.

In some embodiments, the system may comprise a leg mechanism. In some embodiments, the leg mechanism may comprise a plurality of legs comprising a first leg pivotably coupled to a first portion of the shell and a second leg pivotably coupled to a second portion of the shell. In some embodiments, the leg mechanism may comprise a cross member extending between the first leg and the second leg. In some embodiments, the plurality of legs may be pivotable between a retracted position in which the plurality of legs are positioned entirely within the plurality of recessed regions and an extended position in which one or more end portions of the plurality of legs are positioned outside of the plurality of recessed regions.

In some embodiments, the system may comprise a handle mechanism. In some embodiments, the handle mechanism may comprise a first handle portion with a first end pivotably coupled to a third portion of the shell and a second handle portion pivotably coupled to a second end of the first handle portion. In some embodiments, the second handle portion may comprise a first engagement feature that is pivotable relative to the first handle portion. In some embodiments, the handle mechanism may be configured to pivot between a first position in which the first handle portion and the second handle portion are disposed entirely within the central recessed region and a second position in which the second handle portion and the second end of the first handle portion are positioned outside of the central recessed region.

In some embodiments, the first handle portion has a first width and the second handle portion has a second width that is equal to the first width. In some embodiments, the first and second portions of the shell are spaced apart by a distance that is greater than the first width and the second width. In some embodiments, the first and second portions of the shell are spaced apart from a lateral side and a medial side of the shell by a first distance. In some embodiments, the third portion of the shell is spaced apart from the lateral and medial sides of the shell by a second distance that is greater than the first distance.

In some embodiments, the second end of the first handle portion may be disposed above the first portion of the shell and the second portion of the shell when the plurality of legs are in the retracted position. In some embodiments, the second handle portion may be disposed above the first and second portions of the shell when the plurality of legs are in the retracted position. In some embodiments, the handle mechanism may be recessed or retracted further into the shell than the plurality of legs when the plurality of legs are in the retracted position.

In some embodiments, the system may comprise a linking member connecting the first handle portion to the cross member. In some embodiments, the linking member may comprise a first end that is pivotably coupled to the first handle portion and a second end that is pivotably coupled to the cross member. In some embodiments, the linking member may be disposed entirely within the central recessed region when the plurality of legs are in the retracted position. In some embodiments, the linking member may be positioned entirely outside of the central recessed region when the plurality of legs are extended outwards.

In some embodiments, the linking member may comprise a second engagement feature configured to engage the first engagement feature in order to lock the plurality of legs in the extended position. In some embodiments, the first and/or second engagement features may comprise a protrusion, a hook, a latch, or a male connector. In some embodiments, the first and/or second engagement features may comprise a slot, an opening, an aperture, a notch, a recess, a depression, an indentation, a receptacle, or a female connector. In some embodiments, the first and second engagement features may comprise complementary male/male fasteners. In some embodiments, the first and second engagement features may comprise complementary male/female fasteners.

In some embodiments, the system may comprise a latch mechanism. In some embodiments, the latch mechanism may be configured to engage and lock the handle mechanism in the first position. In some embodiments, the latch mechanism may comprise a deflectable member with a notched region configured to engage a distal end of the second handle portion. In some embodiments, the latch mechanism may comprise a cantilevered member extending through the central recessed region. In some embodiments, the latch mechanism may be disposed entirely within the central recessed region.

In another aspect, the present disclosure provides a bag comprising a body; a shell coupled to the body, wherein the shell comprises a central recessed region and a plurality of recessed regions disposed along the central recessed region; a leg mechanism comprising (i) a plurality of legs comprising a first leg pivotably coupled to a first portion of the shell and a second leg pivotably coupled to a second portion of the shell and (ii) a cross member extending between the first leg and the second leg, wherein the plurality of legs are pivotable between (1) a retracted position in which the plurality of legs are positioned entirely within the plurality of recessed regions and (2) an extended position in which one or more end portions of the plurality of legs are positioned outside of the plurality of recessed regions; a handle assembly comprising a handle and a first member pivotably coupled to a third portion of the shell, wherein the handle assembly is configured to pivot between (1) a first position in which the handle assembly is disposed entirely within the central recessed region and (2) a second position in which the handle assembly is positioned outside of the central recessed region; a latch mechanism integrated with the first member and operatively coupled to the handle, wherein the latch mechanism comprises an engagement feature that is operable by manipulating the handle; and a second member connecting the first member to the cross member, wherein the second member is configured to receive the engagement feature in order to lock the plurality of legs in the extended position.

In some embodiments, the latch mechanism comprises one or more arms with a distal end that is angled upwards. In some embodiments, the distal end is configured to disengage one or more locking pins from one or more slots formed along or through a surface or a sidewall of the central recessed region when the handle is pulled. In some embodiments, the handle assembly is pivotable about the third portion of the shell when the one or more locking pins are disengaged from the one or more slots. In some embodiments, the latch mechanism is configured to release the one or more locking pins when the handle is released so that the locking pins reengage the one or more slots. In some embodiments, the handle assembly is fixed in place within the central recessed region when the one or more locking pins reengage the one or more slots.

In some embodiments, the first member comprises a recessed region configured to receive the second member. In some embodiments, the first member and the second member are pivotably coupled along an axis extending through the recessed region. In some embodiments, the recessed region comprises a sloped bottom surface, a left side wall, a right side wall, and a sloped front wall. In some embodiments, the recessed region comprises an aperture or a window extending through the sloped bottom surface and/or the sloped front wall. In some embodiments, a portion of the second member is configured to extend or pivot through the aperture or the window.

In some embodiments, the second member comprises a first end pivotably coupled to the first member and a second end pivotably coupled to the cross member. In some embodiments, the second member comprises a body and one or more lobes that are eccentrically shaped. In some embodiments, the one or more lobes comprise a slot configured to receive the engagement feature when the plurality of legs are in the extended position. In some embodiments, the one or more lobes are configured to extend or pivot through a portion or a section of the first member. In some embodiments, the body of the second member is wider and/or longer than the one or more lobes. In some embodiments, the one or more lobes have a greater height and/or thickness than the body of the second member. In some embodiments, the one or more lobes are positionally offset from a center line extending laterally across the body of the second member. In some embodiments, the one or more lobes are configured to extend past the first end of the body of the second member. In some embodiments, the second member comprises an opening or a window extending through the body of the second member.

Additional aspects and advantages of the present disclosure will become readily apparent to those skilled in this art from the following detailed description, wherein only illustrative embodiments of the present disclosure are shown and described. As will be realized, the present disclosure is capable of other and different embodiments, and its several details are capable of modifications in various obvious respects, all without departing from the disclosure. Accordingly, the drawings and description are to be regarded as illustrative in nature, and not as restrictive.

### BRIEF DESCRIPTION OF THE DRAWINGS

Non-limiting and non-exhaustive examples and embodiments of the present disclosure are described with reference to the following figures.

FIGS. 1A-1E schematically illustrate various perspective views of an exemplary bag, in accordance with some embodiments.

FIGS. 2A-2C schematically illustrate a rear view, a bottom view, and a top view of a cover that can be attached or secured to at least one surface or at least one edge of a bag, in accordance with some embodiments.

FIGS. 3A-3B schematically illustrate a left side view and a right side view of a cover that can be attached or secured to at least one surface or at least one edge of a bag, in accordance with some embodiments.

FIGS. 4A-4B schematically illustrate a bag and an organizer flap that can be attached to or integrated with the bag, in accordance with some embodiments.

FIGS. 5A-5B schematically illustrate different examples of a bag with an integrated organizer flap, in accordance with some embodiments.

FIGS. 6A-6B schematically illustrate a front view and a rear view of another exemplary bag, in accordance with some embodiments.

FIGS. 7A-7B schematically illustrate a right side view and a left side view of another exemplary bag, in accordance with some embodiments.

FIGS. 8A-8B schematically illustrate a front view and a rear view of another cover that can be attached or secured to at least one surface or at least one edge of a bag, in accordance with some embodiments.

FIGS. 9A-9B schematically illustrate a left side view and a right side view of another cover that can be attached or secured to at least one surface or at least one edge of a bag, in accordance with some embodiments.

FIGS. 10A-10B schematically illustrate a front view and a rear view of another exemplary bag, in accordance with some embodiments.

FIGS. 11A-11B schematically illustrate a right side view and a left side view of another exemplary bag, in accordance with some embodiments.

FIGS. 12A-12B schematically illustrate an exemplary bag with one or more pockets for storing and/or organizing various items and/or accessories, in accordance with some embodiments.

FIGS. 13A-13C schematically illustrate an interior layout of an exemplary bag that can be used to carry or transport equipment, in accordance with some embodiments.

FIG. 14 schematically illustrates an exemplary system for connecting multiple bags for transport, in accordance with some embodiments.

FIGS. 15A-15B schematically illustrate another exemplary system for connecting multiple bags for transport, in accordance with some embodiments.

FIG. 16 schematically illustrates a travel bag with a deployable leg assembly, in accordance with some embodiments.

FIG. 17 schematically illustrates a tripod configuration that can be formed when the leg assembly of the travel bag is deployed, in accordance with some embodiments.

FIGS. 18A-18B schematically illustrate a deployable leg assembly for a travel bag, in accordance with some embodiments.

FIG. 19 schematically illustrates a deployable leg assembly that can be stowed away when not in use, in accordance with some embodiments.

FIG. 20 schematically illustrates another example of a travel bag with a deployable leg assembly, in accordance with some embodiments.

FIGS. 21-36 schematically illustrate various non-limiting examples of a system that can be used to facilitate the handling, maneuvering, movement, and/or transportation of any of the bags disclosed herein, in accordance with some embodiments.

FIGS. 37-56 schematically illustrate an exemplary system configured to facilitate the handling, maneuvering, movement, and/or transportation of any of the bags disclosed herein.

### DETAILED DESCRIPTION

### Overview

In one aspect, the present disclosure provides various non-limiting examples of bags that can be used to carry or transport various items and/or equipment. The bags disclosed herein may be configured to endure tough travel conditions and to protect personal items and/or professional equipment from damage or wear by shielding such items and/or equipment from (i) direct physical contact with external objects or surfaces and (ii) direct exposure to external environments, climates, and/or conditions.

In some cases, the bags may be configured to protect or shield the items or equipment from damage or wear as the bags move between two or more locations. In some cases, the bags may be configured to protect or shield the items or equipment from damage or wear as the bags are being transported across or over a ground surface. In some cases, the bags may be configured to protect or shield the items or equipment from damage or wear as the bags are being transported on a vehicle. In some cases, the bags may be configured to protect or shield the items or equipment from damage or wear as the bags are being moved into a vehicle. In some cases, the bags may be configured to protect or shield the items or equipment from damage or wear as the bags are being removed from a vehicle.

### Check in Bags

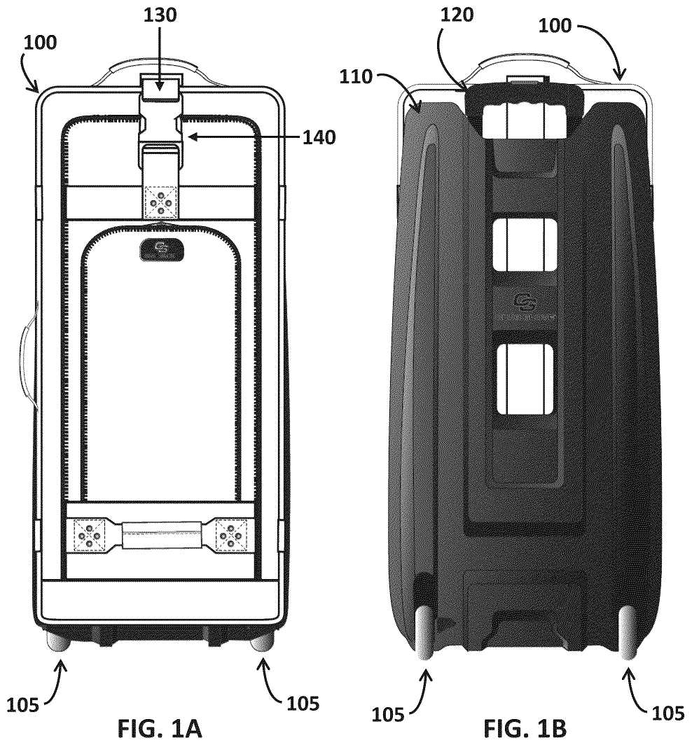

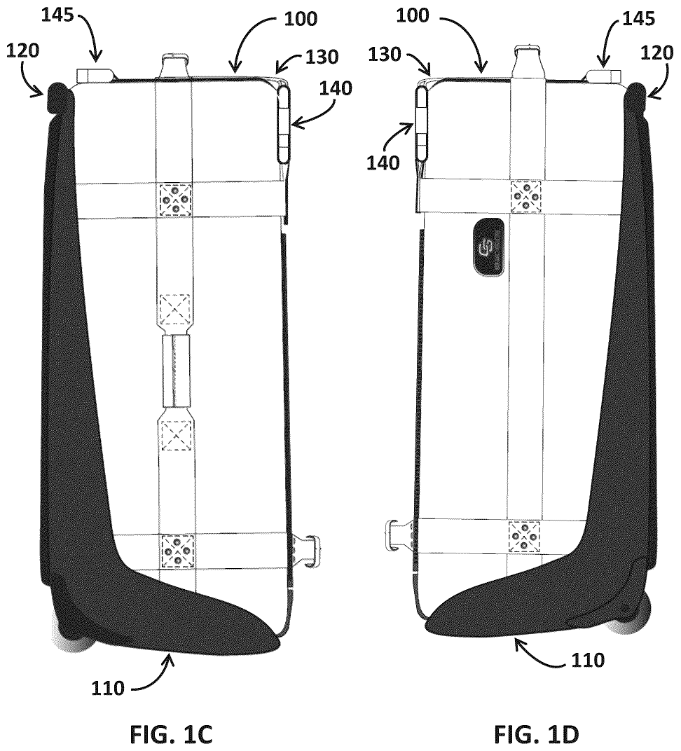

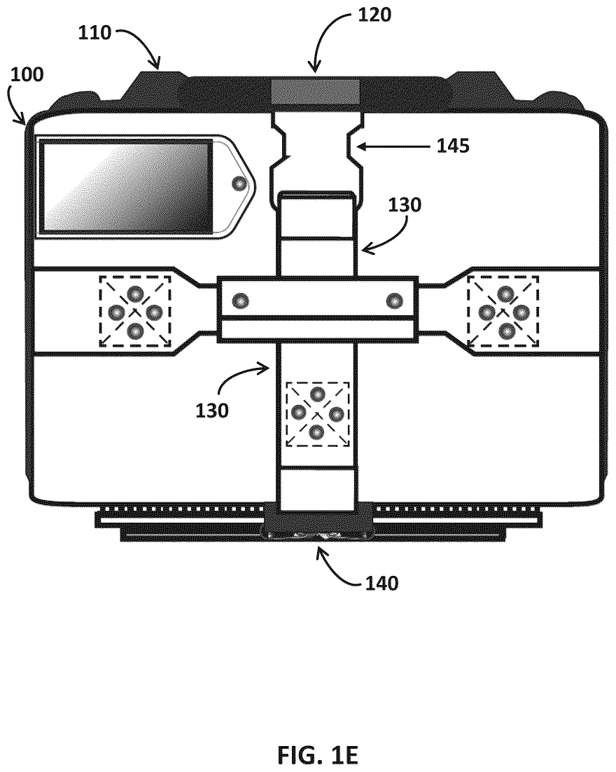

FIGS. 1A-1E schematically illustrate an example of a bag 100 that can be used to transport various items or equipment. In some embodiments, the bag 100 may comprise a bag that can be checked in for transport on a vehicle from one location to another location.

### Wheels/Rollers

In some embodiments, the base of the bag may comprise one or more wheels or rollers 105 for enhancing or facilitating a transportability of the bag. In some cases, the one or more wheels or rollers 105 may have a fixed position and/or orientation relative to the base of the bag. In some cases, the one or more wheels or rollers 105 may be configured to rotate about one or more fixed or predetermined axes. In some cases, the one or more wheels or rollers 105 may be configured to swivel about a lateral or vertical axis to adjust a direction in which the bag can be rolled. In some cases, the lateral or vertical axis may be different than the one or more fixed or predetermined axes. In some cases, the one or more wheels or rollers 105 may be configured to pivot or articulate about another axis that is different than (i) the lateral or vertical axis and/or (ii) the one or more fixed or predetermined axes.

In some embodiments, the bag may comprise one or more wheels or rollers 105 that are fixed or coupled to a movable component of the bag. In some cases, the movable component may include an articulating arm or leg that is configured to extend the one or more wheels or rollers 105 away from the bag so that the bag can be rolled while in a tilted configuration. In some cases, the articulating arm or leg may be configured to retract the one or more wheels or rollers 105 back towards the bag so that the bag can be stored or transported in an upright configuration.

In some embodiments, the bag may comprise a plurality of wheels or rollers 105. In some cases, the plurality of wheels or rollers 105 may include a first set of wheels or rollers disposed on or attached to the base of the bag, and a second set of wheels or rollers disposed on or attached to an articulating arm or leg of the bag. In some cases, the first set of wheels or rollers may be used to roll the bag in a desired direction when the bag is in an upright configuration and/or when the bag is in a tilted configuration. In some cases, the first set of wheels or rollers may be positioned at or near a perimeter or an edge of the base so that the bag can be rolled in a desired direction when the bag is in either an upright configuration or a tilted configuration. In some cases, the second set of wheels or rollers may be used to roll the bag in a desired direction when the bag is in an upright configuration and/or when the bag is in a tilted configuration. In some cases, the second set of wheels or rollers may be positioned at or near a distal end of the articulating arm or leg so that the second set of wheels or rollers can contact the surface under the bag when the bag is in either the tilted configuration or the upright configuration.

### Handle Assembly

In some embodiments, the bag may comprise a handle assembly. In some embodiments, the handle assembly may comprise a handle 120 for maneuvering the bag. In some embodiments, the handle assembly may comprise a plurality of support members attached to the handle 120.

In some cases, the handle 120 may comprise a retractable handle that can be extended upwards and/or retracted downwards. In some cases, the handle 120 may be configured to retract into a partially enclosed region formed between an exterior surface of the bag and a cover surrounding the exterior surface of the bag. In some cases, the handle assembly may be positioned (i) external to the interior region of the bag and (ii) between the back surface of the bag and the cover surrounding the exterior surface of the bag so that the handle assembly can be retracted into the partially enclosed region provided between the cover and the exterior surface of the bag.

### Tolerances

In some cases, the support members of the handle assembly may include a set of members that are telescopically arranged to facilitate the extension and retraction of the handle. In some cases, the set of members may be retractable into a housing that is sized and shaped to receive the set of members. In some cases, the housing may be positioned or formed between the back surface of the bag and the cover surrounding the exterior surface of the bag. In some cases, the set of members may be extendable from the housing to deploy the handle.

In some cases, the set of members may be sized and shaped to minimize or reduce the spacing or clearance between the telescopically arranged members. In some cases, the set of members and the interior of the housing may be sized and shaped to minimize or reduce the spacing or clearance between the telescopically arranged members and the interior of the housing.

In some cases, the spacing or clearance may be reduced and tightened to within a predetermined tolerance that allows the handle and the support members to remain in a fixed position and/or a fixed orientation when a subject exerts a force on the handle or otherwise manipulates the handle to maneuver the bag around. In some cases, the spacing or clearance may be configured to reduce or eliminate any wiggling of the handle or the support members relative to the housing or the rest of the bag when the handle and the support members are extended upwards and deployed.

In some cases, the spacing or clearance may still allow the set of members to easily (i) translate relative to each other and (ii) collapse or retract into the housing so that the handle can simply drop from an extended position to a fully retracted position with minimal user input. For example, in some cases, when the subject engages a pressure-sensitive actuator associated with the handle assembly to disengage any mechanical or physical locks holding the handle up in an extended position, the handle may be configured to drop from the extended position to the fully retracted position without any other manual or physical inputs from the subject beyond the engagement of the pressure-sensitive actuator.

### Connector Assembly

In some embodiments, the bag may comprise a connector assembly that can be used to connect the bag to another bag. In some embodiments, the connector assembly may comprise one or more fasteners attached or coupled to the bag. In some embodiments, the one or more fasteners may be provided along a top surface, a bottom surface, a front surface, a back surface, and/or one or more side surfaces of the bag.

### Fastener

In some cases, the one or more fasteners may include a fastener 140 that is positionable along the front surface of the bag. In some cases, the fastener 140 may comprise a clip or a buckle. In other cases, the fastener may comprise a hook, a loop, a latch, a snap closure, a hook and loop fastener, a magnetic element, or any other type of coupling element that can be used to form a physical connection with another component or another coupling element that is complementary to the coupling element. In some cases, the coupling element and/or the complementary coupling element may include one or more male fasteners and/or one or more female fasteners.

In some cases, the fastener 140 may be securable to a complementary fastener provided along the front surface of the bag. In some cases, the fastener 140 may be oriented towards the bottom surface of the bag when the fastener is secured to the complementary fastener provided along the front surface of the bag.

In some cases, the fastener 140 may be positionable along the front surface of the bag to facilitate a coupling between the fastener and the complementary fastener. In some cases, the fastener 140 may be movable or extendable towards the top surface(s) of one or more other bags to facilitate a coupling between the fastener 140 and one or more other fasteners disposed on the top surface(s) of the one or more other bags.

### Additional Fastener

In some cases, the one or more fasteners may include an additional fastener 145 provided on or along the top surface of the bag. In some cases, the additional fastener 145 may be oriented towards the back surface of the bag. In some cases, the additional fastener 145 may be configured to engage one or more fasteners provided on or associated with one or more other bags in order to connect the bag to said one or more other bags. In some cases, the additional fastener 145 may be oriented towards the front surface(s) of the one or more other bags so that the additional fastener can engage the one or more other fasteners provided on the one or more other bags.

In some cases, the additional fastener 145 may be oriented towards the back surface of the bag or towards the front surface(s) of the one or more other bags when the additional fastener 145 is coupled to the one or more other fasteners provided on the one or more other bags. In some cases, the additional fastener 145 may be oriented towards the back surface of the bag or towards the front surface(s) of the one or more other bags when the additional fastener 145 and the one or more other fasteners provided on the one or more other bags are decoupled.

In some cases, the fastener 140 and the additional fastener 145 may be oriented in different directions. In some cases, the fastener 140 may be oriented in a first direction when the fastener is secured to a complementary fastener provided along the front surface of the bag. In some cases, the additional fastener 145 may be oriented in a second direction that is perpendicular or orthogonal to the first direction when the additional fastener is secured to a connecting fastener associated with one or more other bags. In some cases, the additional fastener 145 may be oriented in a second direction that is perpendicular or orthogonal to the first direction when the additional fastener is decoupled from the connecting fastener associated with the one or more other bags.

In some cases, the bag may not or need not include any complementary fastener for the additional fastener 145. In such cases, the additional fastener 145 may always be readily accessible so that the additional fastener 145 can be directly attached or coupled to one or more other fasteners provided on one or more other bags without having to first decouple the additional fastener 145 from a complementary (mating) fastener.

### External Strap

In some embodiments, the bag may comprise one or more external straps extending across a top surface, a bottom surface, a front surface, a back surface, and/or one or more side surfaces of the bag. In some cases, the one or more external straps may include an external strap 130 that is attached to an external surface of the bag. In some cases, the external strap 130 may be attached to the external surface of the bag at one or more locations. In some cases, the external strap 130 may be attached to the external surface of the bag at a plurality of different locations along the top, bottom, front, back, left, and/or right side surfaces of the bag. In some cases, a portion or a section of the external strap may be detached from the external surface of the bag. In some cases, the detached portions of the external strap may include one or more end portions that can be freely manipulated or moved relative to the external surface of the bag.

In some cases, one or more fasteners may be attached or coupled to the one or more external straps. In some cases, the one or more fasteners may be attached or coupled to the end portions of the one or more external straps so that the fasteners can be freely manipulated or moved relative to the external surface of the bag. In some cases, the one or more fasteners may be attached or coupled to a fixed portion or section of the external straps. In some cases, the fixed portion or section of the external straps may include a part of the external straps that is secured to the external surface of the bag (e.g., using a fastener, an adhesive, or any other type of coupling element).

In some embodiments, the bag may comprise an external strap 130 with a fastener 140 provided on or attached to the external strap 130. In some embodiments, the external strap 130 may be secured along a front side of the bag by connecting the fastener 140 to a complementary fastener disposed on the front side of the bag. In some embodiments, a distal end of the external strap 130 may be disconnected from the front side of the bag and reattached to another bag by connecting the fastener 140 to another complementary fastener disposed on another bag.

In some embodiments, the external strap 130 may extend across a top surface of the bag between a front side edge of the top surface of the bag and a rear side edge of the top surface of the bag. In some cases, the fastener 140 may be attached to a first end of the external strap along the front side edge of the top surface of the bag. In some cases, an additional fastener 145 may be attached to a second end of the external strap 130 that is proximal to the rear side edge of the top surface of the bag, so that the additional fastener 145 can be positioned along and/or oriented towards the rear side edge of the top surface of the bag.

In some cases, the end of the external strap 130 with the fastener 140 attached thereto may be positionable along the front surface of the bag to facilitate a coupling between the fastener 140 and a complementary fastener provided along the front surface of the bag. In some cases, the end of the external strap 130 with the fastener 140 attached thereto may be movable or extendable towards the top and/or back surface(s) of one or more other bags to facilitate a coupling between the fastener 140 and one or more other fasteners disposed on the top and/or back surface(s) of the one or more other bags.

In some cases, the end of the external strap 130 with the fastener 140 attached thereto may be movable or extendable towards one or more surfaces of one or more other bags to facilitate a coupling between the fastener 140 and one or more other fasteners disposed on the one or more surfaces of the one or more other bags. In some cases, the one or more surfaces may include the top surface, the bottom surface, the front surface, the back surface, the left side surface, and/or the right side surface of the one or more other bags. In some cases, the one or more surfaces may include an internal surface portion or an external surface portion of the one or more other bags.

### Cover

In some embodiments, the bag 100 may comprise a cover 110 extending along at least one surface or at least one edge of the bag. In some cases, the cover 110 may be configured as a shell that can protect one or more surfaces or edges of the bag from damage or wear. In some cases, the cover may be attached to the bag using one or more mechanical fasteners (e.g., rivets, screws, bolts, etc.).

In some cases, the cover 110 may extend along a back side of the bag. In some cases, the cover 110 may extend from an upper edge of the bag to a lower edge of the bag. In some cases, the cover 110 may extend along a right side and/or a left side of the bag. In some cases, the cover 110 may be configured to extend around a left side edge and/or a right side edge of the bag.

In some embodiments, the cover 110 may extend across a portion or a section of the back surface area of the bag 100. In some non-limiting embodiments, the cover 110 may extend across at least about 80% of the back surface area of the bag 100 to at most about 100% of the back surface area of the bag 100. In some embodiments, the cover 110 may have a height that is approximately the same as or slightly less than the height of the bag 100. In some non-limiting embodiments, the ratio between the height of the cover 110 and the height of the bag 100 may range from at least about 0.80 to at most about 1.00.

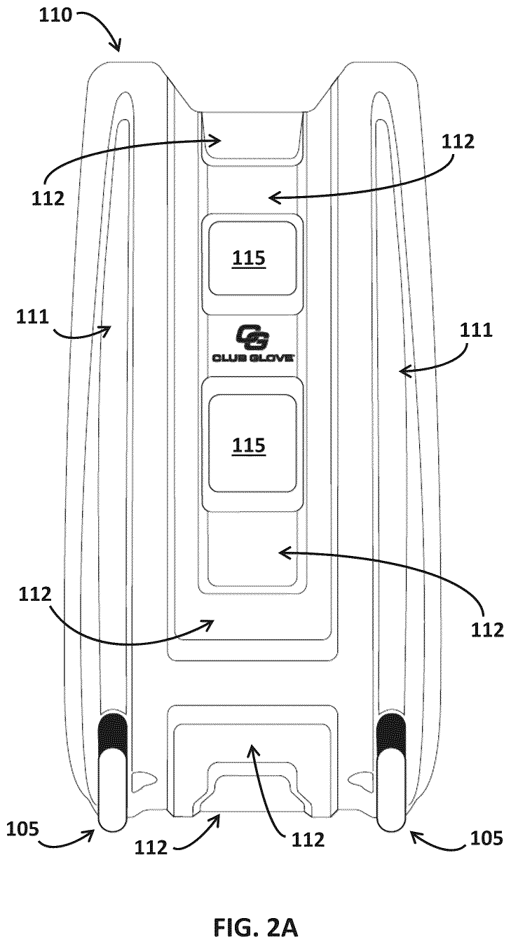

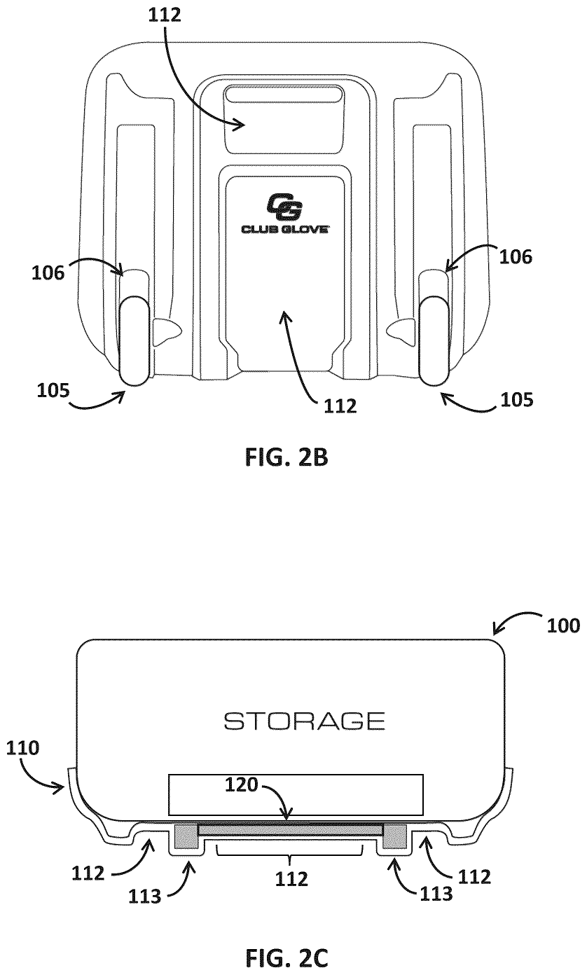

FIG. 2A schematically illustrates a detailed rear perspective view of the cover 110. In some embodiments, the cover 110 may comprise one or more reinforcement features 111 extending longitudinally and/or laterally across the cover 110 to strengthen the cover 110 against flexing. In some cases, the one or more reinforcement features 111 may be configured to protrude outwards and away from the cover 110.

In some embodiments, the one or more reinforcement features 111 may comprise one or more reinforcement ribs configured to run across a length and/or a width of the cover 110. In some cases, the reinforcement ribs may be formed by one or more ridges or protrusions rising from a surface of the cover. In some cases, the one or more ridges or protrusions may be formed to strengthen the cover against bending, thereby increasing the overall strength of the cover 110.

In some cases, the one or more ridges or protrusions may be configured to fix a position and/or an orientation of the bag relative to a front side of another bag that is being transported with the bag. In some cases, the one or more ridges or protrusions may be configured to secure the bag to the front side of another bag that is of a same size and/or shape as the bag. In some cases, the one or more ridges or protrusions may be configured to secure the bag to the front side of another bag that is of a different size and/or a different shape than the bag.

In some cases, the cover 110 may comprise one or more recessed regions 112 extending inwards into the cover 110. In some cases, the one or more recessed regions 112 may be configured to secure the bag to a front side of another bag that is being transported with the bag. In some cases, the one or more recessed regions 112 may be configured to fix a position and/or an orientation of the bag relative to the front side of another bag that is of a same size and/or shape as the bag. In some cases, the one or more recessed regions 112 may be configured to fix a position and/or an orientation of the bag relative to the front side of another bag that is of a different size and/or a different shape than the bag.

In some embodiments, one or more apertures or windows 115 may be formed within or along a portion of the cover 110 to reduce the overall weight of the cover 110. In some cases, the one or more apertures or windows 115 may be provided between the one or more ridges or protrusions of the cover. In some cases, the one or more apertures or windows 115 may be formed within the one or more recessed regions 112 of the cover. In some cases, the one or more apertures or windows may be configured to expose or reveal one or more external straps extending across or along a surface of the bag.

FIG. 2B illustrates a bottom perspective view of the cover 110. In some embodiments, the bottom of the cover 110 may include one or more wheel wells 106 for receiving one or more wheels or rollers 105. In some cases, the one or more wheel wells 106 may be formed adjacent to a rear bottom edge portion of the cover 110. In some cases, the one or more wheel wells may be recessed into the rear bottom edge of the cover.

In some embodiments, the bottom of the cover 110 may include one or more recessed regions 112 positioned along a rear bottom edge of the cover. In some embodiments, the bottom of the cover 110 may include one or more recessed regions 112 positioned adjacent to a front bottom edge of the cover 110. In some cases, the one or more recessed regions 112 may be configured as built-in handles that can be gripped or held to facilitate a movement, a handling, or a transport of the bag.

FIG. 2C illustrates a top perspective view of a cover 110 that can be attached to a bag 100. In some cases, the cover 110 may include one or more recessed regions 112 and one or more protruding regions 113 that are arranged alongside each other in an alternating fashion to accommodate a handle 120 for maneuvering the bag. In some cases, the handle 120 may be retractable into a partially enclosed region disposed between an inner surface of the cover and an outer surface of the bag. In some cases, the handle 120 may be positioned between an inner surface portion of the cover 110 and an outer surface portion of the bag 100, so that the handle 120 is positioned external to the interior storage region of the bag 100. The placement of the handle 120 outside the interior storage region makes it possible to have a flat surface along the bottom of the interior storage region, and maximizes the storage volume of the interior storage region compared to other conventional bags which have the handle positioned within or protruding into the interior storage region of the bag.

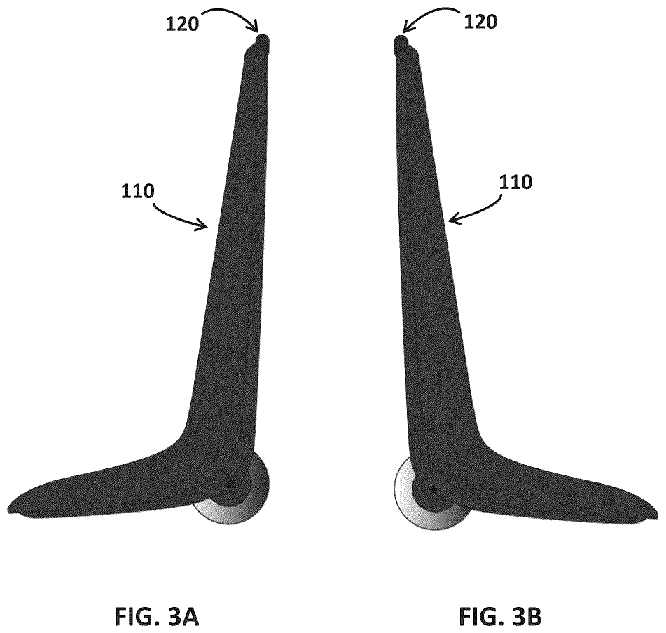

FIGS. 3A and 3B schematically illustrate a left and right side view of the cover 110. In some cases, the cover 110 may be configured to extend downwards from an upper portion of the bag and curve around a rear bottom edge of the bag. In some cases, the cover 110 may be configured to extend forward and away from the rear bottom edge of the bag towards a front end of the bag. In some cases, the front end of the cover 110 may be positioned adjacent to, alongside, or under a front bottom edge of the bag.

In some cases, the cover 110 may have a thickness that changes or varies as the cover extends between an upper edge of the bag and a rear bottom edge of the bag. In some cases, the thickness of the cover may gradually increase as the cover extends from the upper edge of the bag to the rear bottom edge of the bag. In some cases, the cover 110 may have a thickness that changes or varies as the cover extends between a rear bottom edge of the bag and a front end of the bag. In some cases, the thickness of the cover may gradually decrease as the cover extends from the rear bottom edge of the bag to the front end of the bag.

### Storage

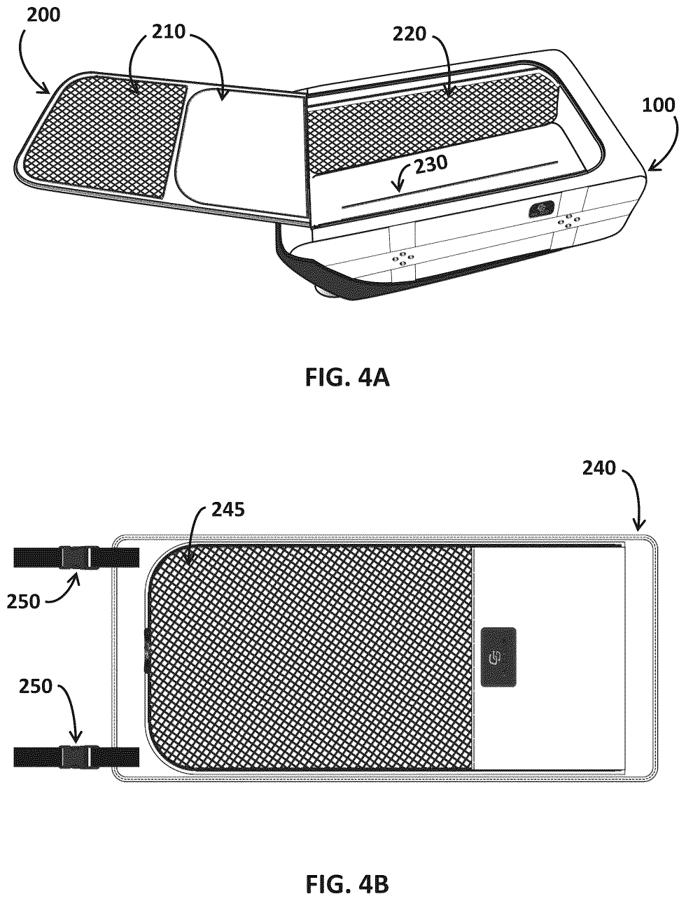

Referring now to FIG. 4A, in some embodiments, the bag 100 may include a flap 200 providing access to an interior storage region of the bag. In some cases, the flap 200 may be detachably coupled to the bag using one or more sliding fasteners.

In some cases, the flap 200 may include one or more compartments 210 for storing items or equipment. In some cases, the one or more compartments 210 may include an open mesh compartment and/or a textile compartment.

In some embodiments, the inner walls of the bag may include one or more mesh zippered pockets 220 that can be used to organize various items or equipment. In some cases, the one or more mesh zippered pockets 220 may be stretchable to accommodate objects of various different shapes and sizes.

In some embodiments, the bottom lining of the bag may include a zippered portion 230 extending along or across the bottom of the bag. In some cases, the zippered portion 230 may be opened using a sliding fastener to provide direct access to the internal parts or the internal assemblies of the bag.

As shown in FIG. 4B, in some embodiments, the bag 100 may include a divider flap 240. In some embodiments, the divider flap 240 may comprise a zippered pocket 245 for storing items or objects. In some cases, a first side of the divider flap 240 may be attached to an upper portion or a lower portion of the bag, and a second side of the divider flap 240 may have one or more fasteners configured to detachably couple the second side of the divider flap 240 to the upper or lower portion of the bag.

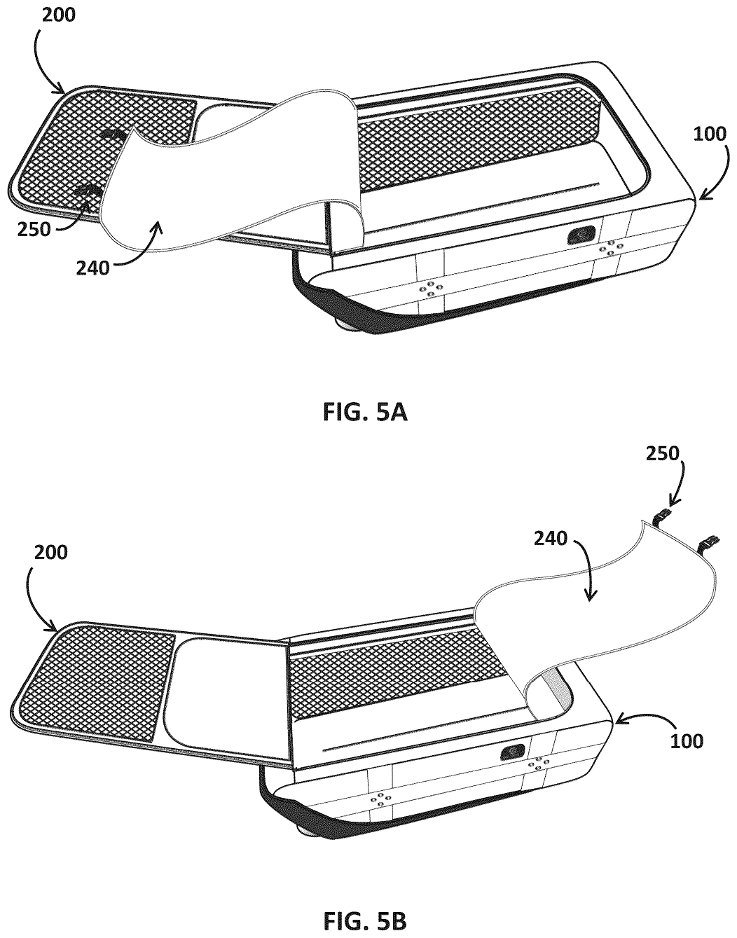

FIG. 5A schematically illustrates one non-limiting example of a bag 100 comprising a divider flap 240 with a first end attached to a first side of the bag and a second end comprising one or more fasteners 250 for attaching a second end of the divider flap 240 to a second side of the bag. In some cases, the first side of the bag may correspond to a lower side of the bag (i.e., a side of the bag that is closest to the ground surface under the bag). In some cases, the second side of the bag may correspond to an upper side of the bag (i.e., a side of the bag that is furthest away from the ground surface under the bag and/or closest to the top of the bag).

In some cases, the first end of the divider flap 240 may be fastened to a same side of the bag as the flap 200 providing access to the interior of the bag. In some cases, the second end of the divider flap 240 may be unfastened or decoupled from the second side of the bag and moved from the second side of the bag to the first side of the bag to reveal or expose an interior storage region of the bag.

FIG. 5B schematically illustrates another non-limiting example of a bag 100 comprising a divider flap 240 with a first end attached to a first side of the bag and a second end comprising one or more fasteners 250 for attaching a second end of the divider flap 240 to a second side of the bag. In some cases, the first side of the bag may correspond to an upper side of the bag (i.e., a side of the bag that is furthest away from the ground surface under the bag and/or closest to the top of the bag). In some cases, the second side of the bag may correspond to a lower side of the bag (i.e., a side of the bag that is closest to the ground surface under the bag).

In some cases, the first end of the divider flap 240 may be fastened to a different side of the bag than the flap 200 providing access to the interior of the bag. In some cases, the second end of the divider flap 240 may be unfastened or decoupled from the second side of the bag and moved from the second side of the bag to the first side of the bag to reveal or expose an interior storage region of the bag.

### Carry on Bag

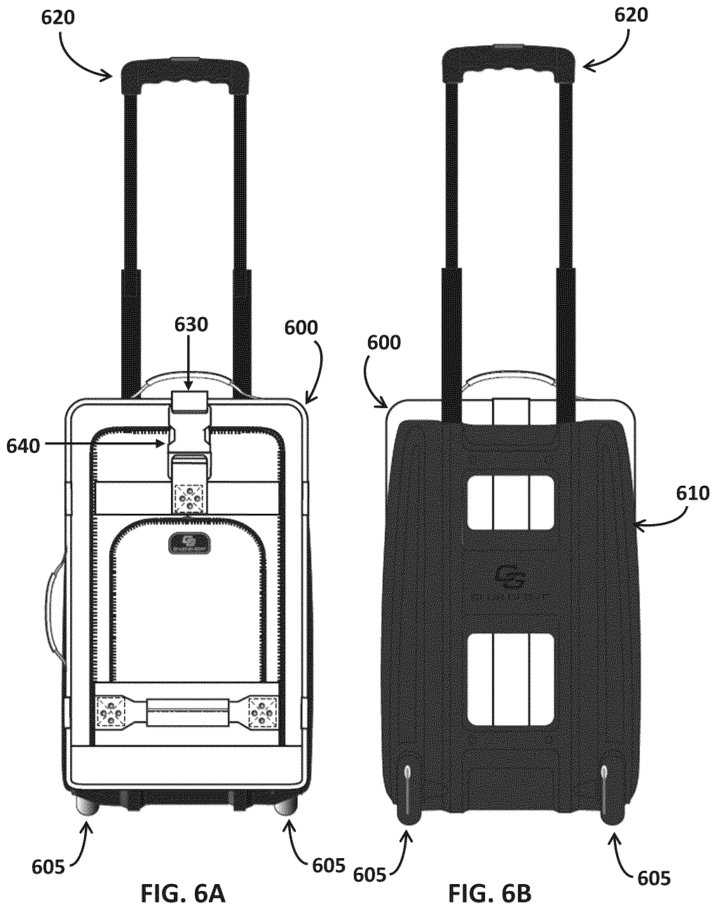

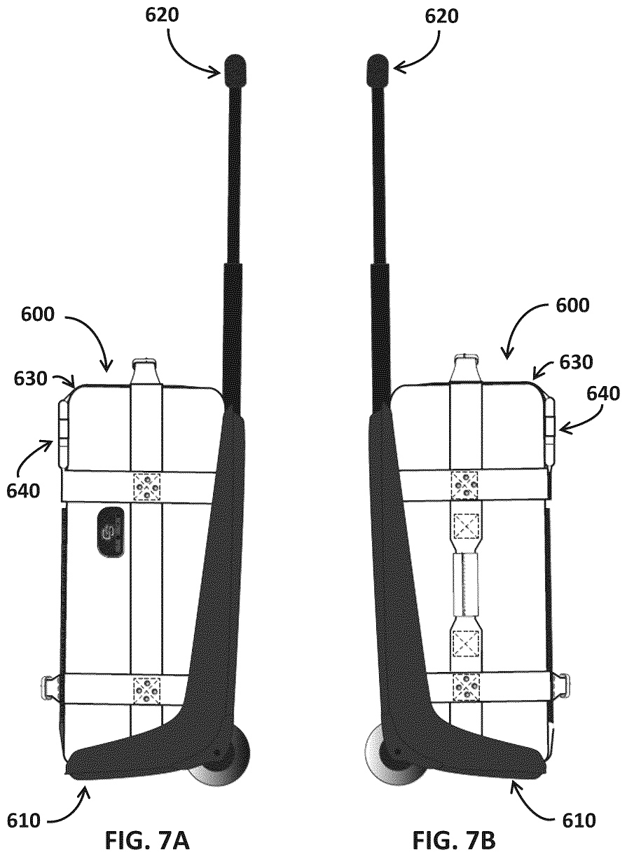

Turning now to FIGS. 6A-6B and FIGS. 7A-7B, in some embodiments, the bags 600 disclosed herein may include a bag 600 that can be carried onto a vehicle for transport from one location to another location.

### Wheels/Rollers

In some embodiments, the bag 600 may include one or more rollers or wheels 605 for transporting the bag 600 across or over a surface. The one or more rollers or wheels 605 may include any of the roller or wheel mechanisms and assemblies disclosed elsewhere herein.

### Cover

In some embodiments, the bag 600 may include a cover 610 extending along one or more sides or edges of the bag 600 to shield or protect the bag from impacts that can damage or wear the materials or the construction of the bag. In some cases, the cover may be attached to the bag using one or more mechanical fasteners (e.g., rivets, screws, bolts, etc.).

In some embodiments, the cover 610 may extend across a portion or a section of the back surface area of the bag 600. In some non-limiting embodiments, the cover 610 may extend across at least about 80% of the back surface area of the bag 600 to at most about 100% of the back surface area of the bag 600. In some embodiments, the cover 610 may have a height that is approximately the same as or slightly less than the height of the bag 600. In some non-limiting embodiments, the ratio between the height of the cover 610 and the height of the bag 600 may range from at least about 0.80 to at most about 1.00.

As described elsewhere herein, in some embodiments, the cover 610 may comprise one or more reinforcement features extending longitudinally and/or laterally across the cover to strengthen the cover against flexing. In some cases, the one or more reinforcement features may be configured to protrude outwards and away from the cover.

In some embodiments, the one or more reinforcement features may comprise one or more reinforcement ribs configured to run across a length and/or a width of the cover. In some cases, the reinforcement ribs may be formed by one or more ridges or protrusions rising from a surface of the cover. In some cases, the one or more ridges or protrusions may be formed to strengthen the cover against bending, thereby increasing the overall strength of the cover.

In some cases, the one or more ridges or protrusions may be configured to fix a position and/or an orientation of the bag relative to a front side of another bag that is being transported with the bag. In some cases, the one or more ridges or protrusions may be configured to secure the bag to the front side of another bag that is of a same size and/or shape as the bag. In some cases, the one or more ridges or protrusions may be configured to secure the bag to the front side of another bag that is of a different size and/or a different shape than the bag.

In some cases, the cover may comprise one or more recessed regions extending inwards into the cover. In some cases, the one or more recessed regions may be configured to secure the bag to the front side of another bag that is being transported with the bag. In some cases, the one or more recessed regions may be configured to fix a position and/or an orientation of the bag relative to the front side of another bag that is of a same size and/or shape as the bag. In some cases, the one or more recessed regions may be configured to fix the position and/or the orientation of the bag relative to the front side of another bag that is of a different size and/or a different shape than the bag.

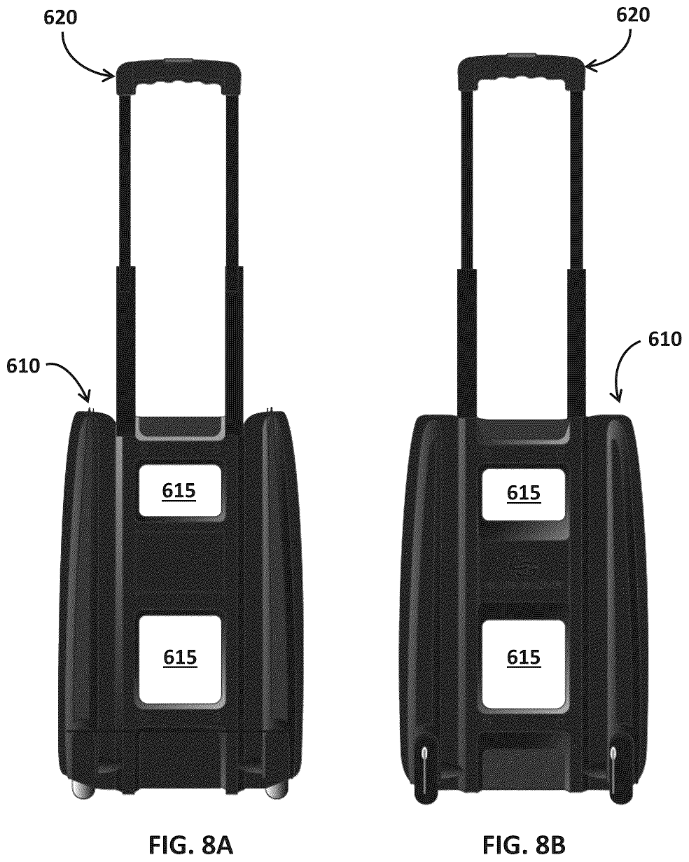

As shown in FIGS. 8A-8B, in some embodiments, one or more apertures or windows 615 may be formed within or along a portion of the cover 610 to reduce the overall weight of the cover. In some cases, the one or more apertures or windows 615 may be provided between the one or more ridges or protrusions of the cover. In some cases, the one or more apertures or windows 615 may be formed within the one or more recessed regions of the cover. In some cases, the one or more apertures or windows may be configured to expose or reveal one or more external straps extending across or along a surface of the bag.

In some embodiments, the cover 610 may include one or more recessed regions and one or more protruding regions that are arranged alongside each other in an alternating fashion to accommodate a handle 620 for maneuvering the bag. In some cases, the handle 620 may be retractable into a partially enclosed region disposed between an inner surface of the cover and an outer surface of the bag. In some cases, the handle 620 may be positioned between an inner surface portion of the cover 610 and an outer surface portion of the bag 600, so that the handle 620 is positioned external to the interior storage region of the bag 600. The placement of the handle 620 outside the interior storage region makes it possible to have a flat surface along the bottom of the interior storage region, and maximizes the storage volume of the interior storage region compared to other conventional bags which have the handle positioned within or protruding into the interior storage region of the bag.

In some embodiments, the bottom of the cover 610 may include one or more wheel wells for receiving one or more rollers or wheels 605. In some cases, the one or more wheel wells may be formed adjacent to a rear bottom edge portion of the cover. In some cases, the one or more wheel wells may be recessed into the rear bottom edge of the cover.

In some embodiments, the bottom of the cover 610 may include one or more recessed regions positioned along a rear bottom edge of the cover. In some embodiments, the bottom of the cover may include one or more recessed regions positioned adjacent to a front bottom edge of the cover. In some cases, the one or more recessed regions may be configured as built-in handles that can be gripped or held to facilitate a movement, a handling, or a transport of the bag.

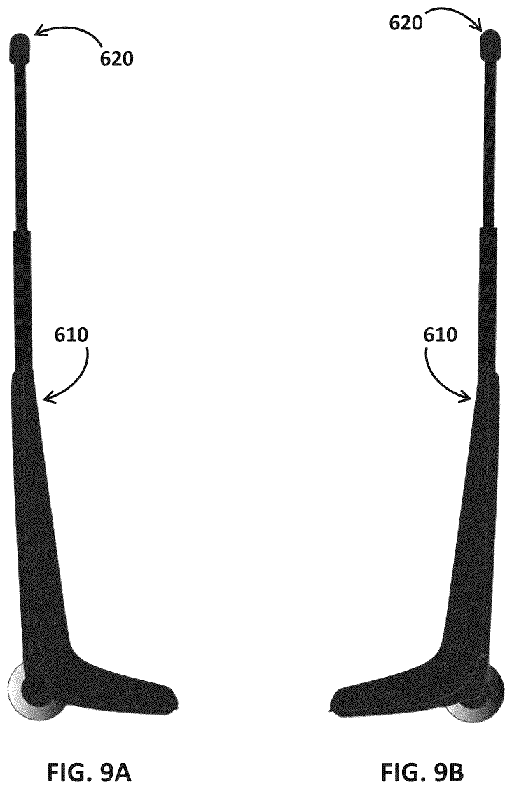

FIGS. 9A and 9B schematically illustrate a right side view and a left side view of the cover 610. In some cases, the cover 610 may be configured to extend downwards from an upper portion of the bag and curve around a rear bottom edge of the bag. In some cases, the cover 610 may include a base section configured to extend forward and away from the rear bottom edge of the bag towards a front end of the bag. In some cases, the front end of the cover 610 may be positioned adjacent to, alongside, or under a front bottom edge of the bag.

In some cases, the cover 610 may have a thickness that changes or varies as the cover extends between an upper edge of the bag and a rear bottom edge of the bag. In some cases, the thickness of the cover may gradually increase as the cover extends from the upper edge of the bag to the rear bottom edge of the bag. In some cases, the cover may have a thickness that changes or varies as the cover extends between a rear bottom edge of the bag and a front end of the bag. In some cases, the thickness of the cover may gradually decrease as the cover extends from the rear bottom edge of the bag to the front end of the bag.

### Handle Assembly

In some embodiments, the bag may comprise a handle assembly. In some embodiments, the handle assembly may comprise a handle 620 for maneuvering the bag. In some embodiments, the handle assembly may comprise a plurality of support members attached to the handle 620.

In some cases, the handle 620 may comprise a retractable handle that can be extended upwards and/or retracted downwards. In some cases, the handle 620 may be configured to retract into a partially enclosed region formed between an exterior surface of the bag and a cover 610 surrounding the exterior surface of the bag. In some cases, the handle assembly may be positioned (i) external to the interior region of the bag and (ii) between the back surface of the bag and an inner surface of the cover so that the handle assembly can be retracted into the partially enclosed region provided between the cover and the exterior of the bag.

### Tolerances

In some cases, the support members of the handle assembly may include a set of members that are telescopically arranged to facilitate the extension and retraction of the handle. In some cases, the set of members may be retractable into a housing that is sized and shaped to receive the set of members. In some cases, the housing may be positioned or formed between the back surface of the bag and the cover surrounding the exterior surface of the bag. In some cases, the set of members may be extendable from the housing to deploy the handle.

In some cases, the set of members may be sized and shaped to minimize or reduce the spacing or clearance between the telescopically arranged members. In some cases, the set of members and the interior of the housing may be sized and shaped to minimize or reduce the spacing or clearance between the telescopically arranged members and the interior of the housing.

In some cases, the spacing or clearance may be reduced and tightened to within a predetermined tolerance that allows the handle and the support members to remain in a fixed position and/or a fixed orientation when a subject exerts a force on the handle or otherwise manipulates the handle to maneuver the bag around. In some cases, the spacing or clearance may be configured to reduce or eliminate any wiggling of the handle or the support members relative to the housing or the rest of the bag when the handle and the support members are extended upwards and deployed.

In some cases, the spacing or clearance may still allow the set of members to easily (i) translate relative to each other and (ii) collapse or retract into the housing so that the handle can simply drop from an extended position to a fully retracted position with minimal user input. For example, in some cases, when the subject engages a pressure-sensitive actuator associated with the handle assembly to disengage any mechanical or physical locks holding the handle up in an extended position, the handle may be configured to drop from the extended position to the fully retracted position without any other manual or physical inputs from the subject beyond the engagement of the pressure-sensitive actuator.

### Connector Assembly

In some embodiments, the bag may comprise a connector assembly that can be used to connect the bag to another bag. In some embodiments, the connector assembly may comprise one or more connecting fasteners attached or coupled to the bag. In some embodiments, the one or more connecting fasteners may be provided along one or more surfaces of the bag. In some embodiments, the one or more connecting fasteners may be provided along a top surface, a bottom surface, a front surface, a back surface, and/or one or more side surfaces of the bag.

### Fastener

In some cases, the one or more connecting fasteners may include a fastener 640 that is positionable along the front surface of the bag. In some cases, the fastener 640 may be securable to a complementary fastener provided along the front surface of the bag. In some cases, the fastener 640 may be oriented towards the bottom surface of the bag when the fastener is secured to the complementary fastener provided along the front surface of the bag.

In some cases, the fastener 640 may be positionable along the front surface of the bag to facilitate a coupling between the fastener and the complementary fastener. In some cases, the fastener 640 may be movable or extendable towards the top surface(s) of one or more other bags to facilitate a coupling between the fastener 640 and one or more other fasteners disposed on the top surface(s) of the one or more other bags. In some cases, the complementary fastener may be configured to engage the fastener 640 when the fastener 640 and the one or more other fasteners are decoupled.

### Additional Fastener

In some embodiments, the bag may not or need not include any additional fasteners provided on or along the top surface of the bag. In some cases, the bag may be configured as the first bag or the lead bag when the bag is connected to one or more other bags to form a bag assembly. When the bag is configured as the first bag or the lead bag in a bag assembly, there are no other bags positioned in front of the first or lead bag. In such cases, the connector assembly of the first or lead bag may not or need not require any additional fasteners to connect another bag in front of the first or lead bag.

In other embodiments, the connector assembly of the bag may comprise an additional fastener provided on or along the top surface of the bag. In some cases, the additional fastener may be oriented towards the back surface of the bag. In some cases, the additional fastener may be configured to engage one or more fasteners provided on one or more other bags in order to connect the bag to one or more other bags. In some cases, the additional fastener may be oriented towards the front surface(s) of the one or more other bags so that the additional fastener can engage the one or more other fasteners provided on the one or more other bags.

In some cases, the additional fastener may be oriented towards the back surface of the bag or towards the front surface(s) of the one or more other bags when the additional fastener is coupled to the one or more other fasteners provided on the one or more other bags. In some cases, the additional fastener may be oriented towards the back surface of the bag or towards the front surface(s) of the one or more other bags when the additional fastener and the one or more other fasteners are decoupled.

In some cases, the fastener and the additional fastener may be oriented in different directions. In some cases, the fastener may be oriented in a first direction when the fastener is secured to a complementary fastener provided along the front surface of the bag. In some cases, the additional fastener may be oriented in a second direction that is perpendicular or orthogonal to the first direction when the additional fastener is secured to a connecting fastener associated with one or more other bags. In some cases, the additional fastener may be oriented in a second direction that is perpendicular or orthogonal to the first direction when the additional fastener is decoupled from the connecting fastener associated with the one or more other bags.

In some cases, the bag may not or need not include any complementary fastener for the additional fastener. In such cases, the additional fastener may always be readily accessible so that the additional fastener can be directly attached or coupled to one or more other fasteners provided on one or more other bags without having to first decouple the additional fastener from a complementary (mating) fastener.

### External Strap

In some embodiments, the bag may comprise one or more external straps extending across a top surface, a bottom surface, a front surface, a back surface, and/or one or more side surfaces of the bag. In some embodiments, the one or more fasteners of the connector assembly may be attached or coupled to the one or more external straps.

In some embodiments, the bag may comprise an external strap 630 with a fastener 640 provided on or attached to the external strap 630. In some embodiments, a distal end of the external strap 630 may be secured along a front side of the bag by connecting the fastener 640 to a complementary fastener disposed on the front side of the bag. In some embodiments, the external strap 630 may be disconnected from the front side of the bag and attached to another bag by connecting the fastener 640 to another complementary fastener disposed on the other bag.

In some embodiments, the external strap 630 may extend across a top surface of the bag between a front side edge of the top surface of the bag and a rear side edge of the top surface of the bag. In some cases, the fastener 640 may be attached to an end of the external strap along the front side edge of the top surface of the bag. In cases where an additional fastener is provided, the additional fastener may be attached to another end of the external strap 630 that is proximal to the rear side edge of the top surface of the bag, so that the additional fastener can be positioned along or oriented towards the rear side edge of the top surface of the bag.

In some cases, the end of the external strap 630 with the fastener 640 attached thereto may be positionable along the front surface of the bag to facilitate a coupling between the fastener 640 and a complementary fastener provided along the front surface of the bag. In some cases, the end of the external strap 630 with the fastener 640 attached thereto may be movable or extendable towards the top and/or back surface(s) of one or more other bags to facilitate a coupling between the fastener 640 and one or more other fasteners disposed on the top and/or back surface(s) of the one or more other bags.

### Attachment to Check-in Bag

In some embodiments, the external strap 630 may be configured to extend under the handle of one or more other bags and between a plurality of support members attached to the handle of the one or more other bags to facilitate a coupling between the fastener 640 and one or more other fasteners provided on the one or more other bags.

In some cases, the fastener 640 may be configured to engage one or more fasteners disposed on or along one or more surfaces of the one or more other bags.

In some cases, a fastener disposed on or along the top surface of the one or more other bags (e.g., as shown in FIGS. 1A-1E) may be configured to engage the fastener 640 attached to the external strap 630 of the bag 600.

### Travel Bag

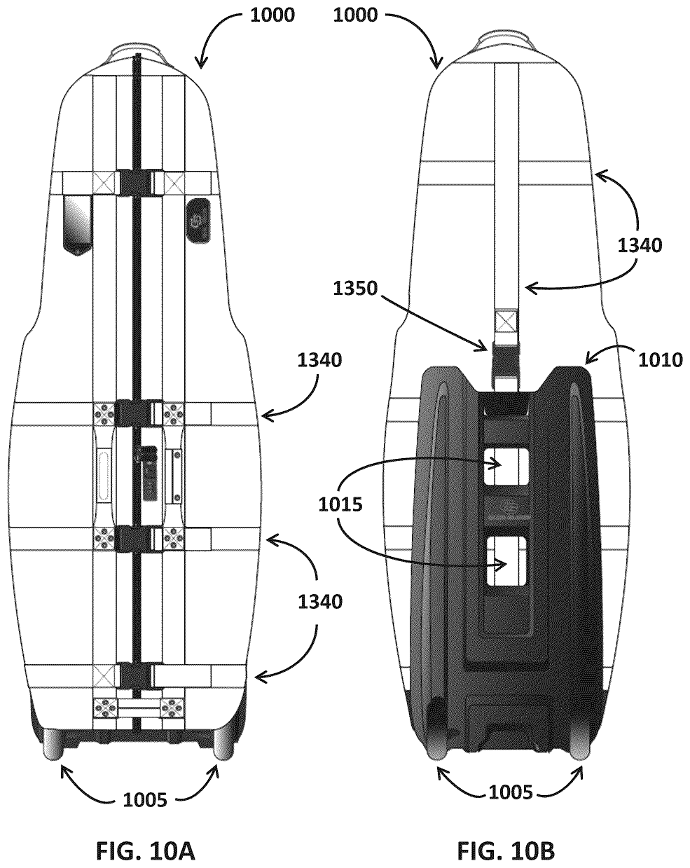

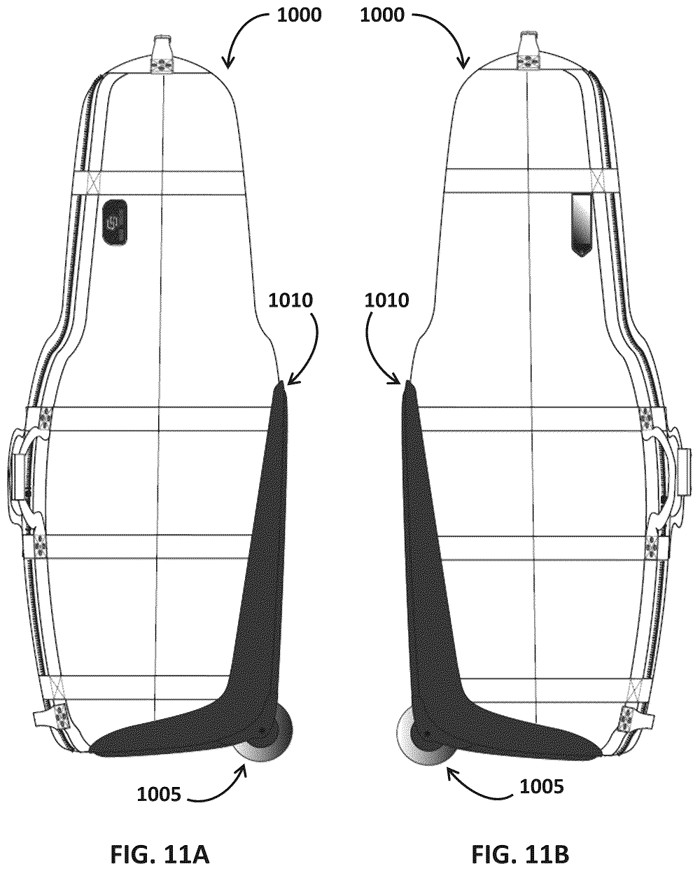

Referring now to FIGS. 10A-10B and FIGS. 11A-11B, in some embodiments, the bags disclosed herein may include a bag 1000 configured as a travel bag that can be checked in and/or carried onto a vehicle for transport from one location to another location.

In some cases, the travel bag may comprise an elongated travel bag configured to transport one or more items or objects. In some cases, the one or more items or objects may have an elongated form factor. In some cases, the one or more items or objects may include a piece of equipment (e.g., sporting equipment). In some cases, the equipment may include, for example, a golf bag, one or more golf clubs, one or more golf balls, one or more golf shoes, golf apparel, and/or one or more golf-related accessories. In some cases, the equipment may include one or more skis or boards, ski or snowboarding apparel, and/or one or more ski or snowboarding-related accessories.

### Wheels/Rollers

In some embodiments, the bag 1000 may have one or more wheels or rollers 1005 for enhancing or facilitating a transportability of the bag. In some cases, the one or more wheels or rollers 1005 may have a fixed position and/or orientation relative to the base of the bag. In some cases, the one or more wheels or rollers 1005 may be configured to rotate about one or more fixed or predetermined axes. In some cases, the one or more wheels or rollers 1005 may be configured to swivel about a lateral or vertical axis to adjust a direction in which the bag can be rolled. In some cases, the lateral or vertical axis may be different than the one or more fixed or predetermined axes. In some cases, the one or more wheels or rollers 1005 may be configured to pivot or articulate about another axis that is different than (i) the lateral or vertical axis and/or (ii) the one or more fixed or predetermined axes.

In some cases, the bag may comprise one or more wheels or rollers 1005 that are fixed or coupled to a movable component of the bag. In some cases, the movable component may include an articulating arm or leg that is configured to extend the one or more wheels or rollers 1005 away from the bag so that the bag can be rolled while in a tilted configuration. In some cases, the articulating arm or leg may be configured to retract the one or more wheels or rollers 1005 back towards the bag so that the bag can be stored or transported in an upright configuration.

In some cases, the one or more wheels or rollers 1005 may include a first set of wheels or rollers disposed on or attached to the base of the bag, and a second set of wheels or rollers disposed on or attached to an articulating arm or leg of the bag. In some cases, the first set of wheels or rollers may be used to roll the bag in a desired direction when the bag is in an upright configuration and/or when the bag is in a tilted configuration. In some cases, the first set of wheels or rollers may be positioned at or near a perimeter or an edge of the base so that the bag can be rolled in a desired direction when the bag is in either an upright configuration or a tilted configuration. In some cases, the second set of wheels or rollers may be used to roll the bag in a desired direction when the bag is in an upright configuration and/or when the bag is in a tilted configuration. In some cases, the second set of wheels or rollers may be positioned at or near a distal end of the articulating arm or leg so that the second set of wheels or rollers can contact the surface under the bag when the bag is in either the tilted configuration or the upright configuration.

### Cover

In some embodiments, the bag 1000 may comprise a cover 1010 as described elsewhere herein. In some embodiments, the cover 1010 may be configured to extend along one or more sides or edges of the bag 1000 to shield or protect the bag from impacts that can damage or wear the materials or the construction of the bag. In some cases, the cover may be attached to the bag using one or more mechanical fasteners (e.g., rivets, screws, bolts, etc.).

In some embodiments, the cover 1010 may extend across a portion or a section of the back surface area of the bag 1000. In some non-limiting embodiments, the cover 1010 may extend across at least about 40% of the back surface area of the bag 1000 to at most about 80% of the back surface area of the bag 1000. In some embodiments, the cover 1010 may have a height that is less than or substantially less than the height of the bag 1000. In some non-limiting embodiments, the ratio between the height of the cover 1010 and the height of the bag 1000 may range from at least about 0.40 to at most about 0.80.

As described elsewhere herein, in some embodiments, the cover 1010 may comprise one or more reinforcement features extending longitudinally and/or laterally across the cover to strengthen the cover against flexing. In some embodiments, the one or more reinforcement features may comprise one or more reinforcement ribs configured to run across a length and/or a width of the cover to strengthen the cover against bending. In some embodiments, the one or more reinforcement ribs may be formed by one or more surface features extending across a portion or a section of the cover. In some cases, the one or more surface features may include one or more ridges or protrusions extending from the surface of the cover. In some cases, the one or more surface features may include one or more recessed regions extending into the surface of the cover.

In some cases, the back side of the cover 1010 may have a surface contour or profile defined by the placement and orientation of the one or more surface features. In some cases, the surface contour or profile may be configured to fix a position and/or an orientation of the bag relative to the front side of another bag that is being transported with the bag. In some cases, the one or more surface features defining the surface contour or profile of the cover may be configured to secure the bag to the front side of another bag that is of a same size and/or shape as the bag. In some cases, the one or more surface features defining the surface contour or profile of the cover may be configured to secure the bag to the front side of another bag that is of a different size and/or a different shape than the bag.

In some embodiments, the cover 1010 may include one or more apertures or windows 1015 formed within or along a portion of the cover to reduce the overall weight of the cover. In some cases, the one or more apertures or windows 1015 may be provided between the one or more ridges or protrusions of the cover. In some cases, the one or more apertures or windows 1015 may be formed within the one or more recessed regions of the cover. In some cases, the one or more apertures or windows may be configured to expose or reveal one or more external straps extending across or along a surface of the bag.

In some cases, an additional panel of material may be positioned between the cover and the exterior of the bag to reinforce the construction of the bag. In some cases, the additional panel of material may be configured as a rigid or semi-rigid reinforcement layer that provides additional strength and structural support to the cover, the bag, and/or the attachment interface between the cover and the bag. In some cases, the additional panel of material may cover at least a portion of the one or more apertures or windows formed within or along a portion of the cover. In some cases, the additional panel of material may be configured to overlie at least a portion or a section of the one or more external straps extending across or along a surface of the bag.

In some cases, the cover 1010 may be configured to extend downwards from an upper portion of the bag and curve around a rear bottom edge of the bag. In some cases, the cover 1010 may include a base section configured to extend forward and away from the rear bottom edge of the bag towards a front end of the bag. In some cases, the front end of the cover 1010 may be positioned adjacent to, alongside, or under the front bottom edge of the bag.

In some cases, the cover 1010 may have a thickness that changes or varies as the cover extends between an upper edge of the bag and a rear bottom edge of the bag. In some cases, the thickness of the cover may gradually increase as the cover extends from the upper edge of the bag to the rear bottom edge of the bag. In some cases, the cover may have a thickness that changes or varies as the cover extends between a rear bottom edge of the bag and a front end of the bag. In some cases, the thickness of the cover may gradually decrease as the cover extends from the rear bottom edge of the bag to the front end of the bag.

In some embodiments, the bottom of the cover 1010 may include one or more wheel wells for receiving one or more wheels or rollers. In some cases, the one or more wheel wells may be formed adjacent to a rear bottom edge portion of the cover. In some cases, the one or more wheel wells may be recessed into the rear bottom edge of the cover.

In some embodiments, the bottom of the cover 1010 may include one or more recessed regions positioned along a rear bottom edge of the cover. In some embodiments, the bottom of the cover may include one or more recessed regions positioned adjacent to a front bottom edge of the cover. In some cases, the one or more recessed regions may be configured as built-in handles that can be gripped or held to facilitate a movement, a handling, or a transport of the bag.

### Handle Assembly

In some non-limiting embodiments, the bag 1000 may not or need not include a retractable handle for maneuvering the bag. In such embodiments, the bag 1000 may be maneuvered using a fixed handle provided on a top portion of the bag 1000. In some cases, the fixed handle provided on the top portion of the bag may not or need not be retractable into the cover 1010. In other non-limiting embodiments, the bag 1000 may include a retractable handle assembly such as those described elsewhere herein. In some optional embodiments, the retractable handle assembly may include components and/or sub-assemblies that are manufactured with certain tolerances such as those described elsewhere herein, to preserve the functionality and ease-of-use of the handle assembly.

### Pockets

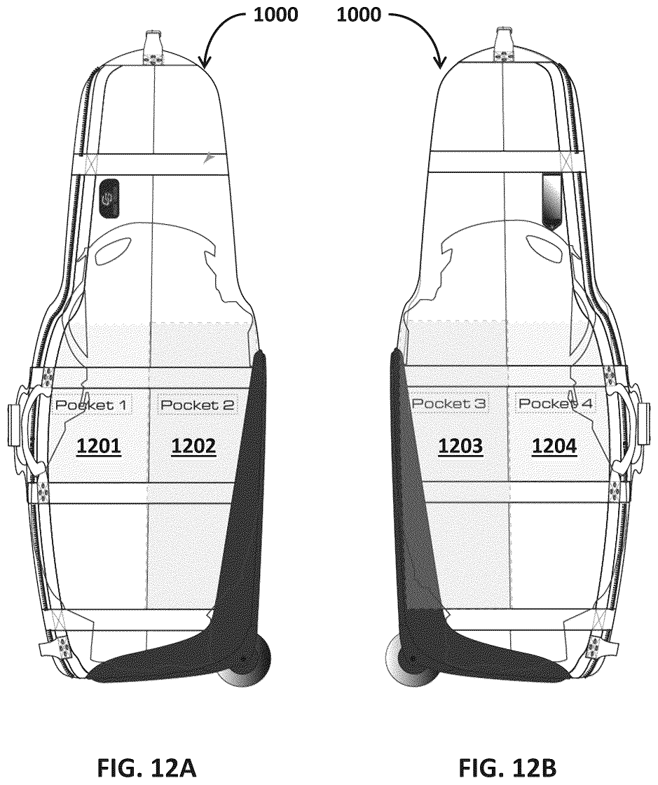

Referring now to FIGS. 12A and 12B, in some embodiments, the bag 1000 may include one or more pockets for securely storing various objects or items. In some cases, the one or more pockets may include a plurality of pockets arranged along an outer portion and/or an inner portion of the bag 1000. In some cases, the plurality of pockets may include a first pocket 1201 and a second pocket 1202 arranged along a first side of the golf bag. In some cases, the plurality of pockets may further include a third pocket 1203 and a fourth pocket 1204 arranged along a second side of the golf bag.

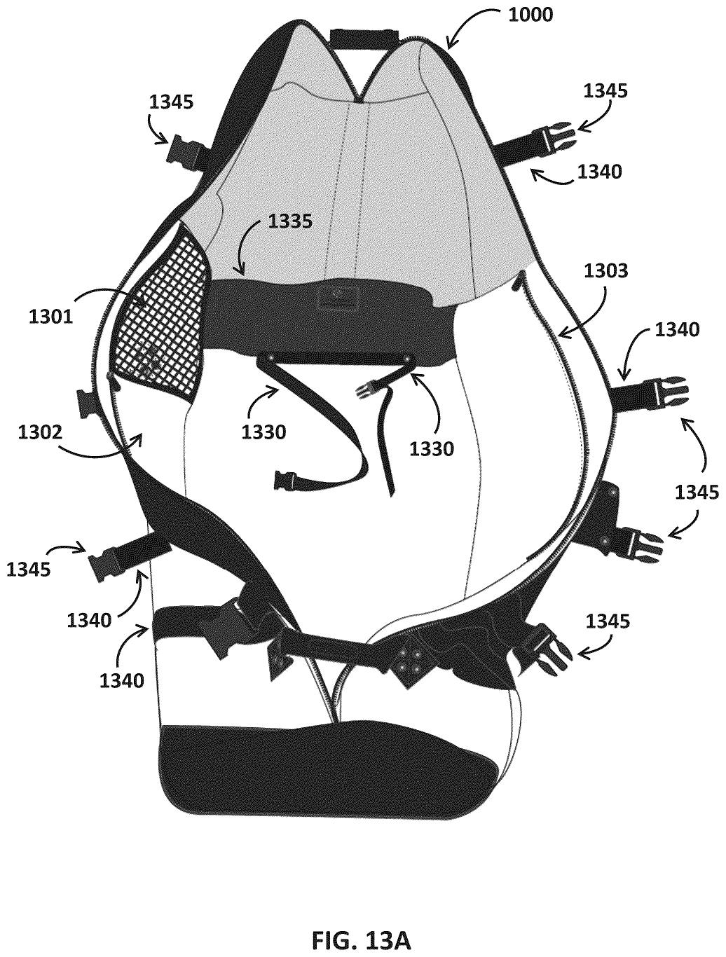

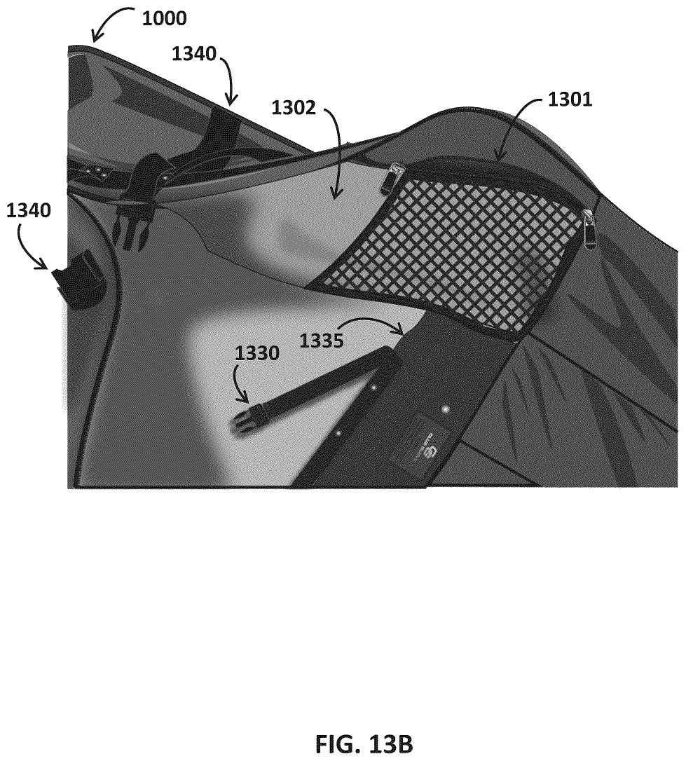

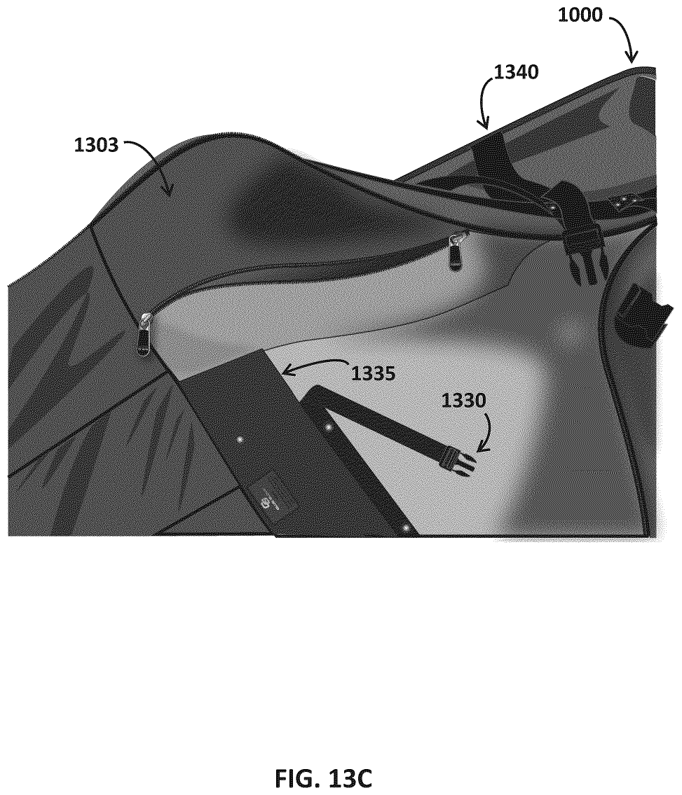

FIGS. 13A-13C schematically illustrate detailed views of the interior region of the bag 1000 shown in the preceding figures. In some embodiments, the interior region of the bag 1000 may include a first internal pocket 1301 and a second internal pocket 1302 disposed on a first side of the bag. In some embodiments, the interior region of the bag 1000 may further include a third internal pocket 1303 disposed on a second side of the bag. In some cases, the first internal pocket 1301, the second internal pocket 1302, and/or the third internal pocket 1303 may include a mesh pocket. In some cases, the mesh pocket may be an expandable mesh pocket. In some cases, the first internal pocket 1301, the second internal pocket 1302, and/or the third internal pocket 1303 may include a zippered pocket. In some cases, the zippered pocket may be a pack cloth pocket comprising a textile material. In some cases, the textile material may include a mesh material and/or a mesh layer. In other cases, the textile material may not or need not include a mesh material or layer.

### Bag Interior

In some embodiments, the interior of the bag may comprise a plurality of different materials that are selected to enhance the functionality and/or the user experience of the bag. In some cases, the interior of the bag may comprise a first interior portion comprising a first material. In some cases, the interior of the bag may further comprise a second interior portion comprising a second material.

In some cases, the bag may comprise a first interior portion positioned along or around an upper interior section of the bag. In some cases, when one or more golf clubs are placed within the bag, or when another bag containing the golf clubs is placed within the bag, the heads of the golf clubs may be positioned within the upper interior section of the bag, and the first interior portion of the bag may be configured to extend around the club heads. In some cases, the first interior portion of the bag may comprise a first material. In some cases, the first material may comprise a fabric or textile material. In some cases, the fabric or textile material may comprise a velour material. In some cases, the first interior portion of the bag may be configured as a soft and padded surface that is positioned around the club heads to provide additional padding and protection for the club heads. In some cases, the soft and padded surface may come into contact with the club heads without scratching or damaging the club heads.

In some cases, the bag may comprise a second interior portion positioned underneath or below the first interior portion of the bag. In some cases, the second interior portion may comprise a second material that is different than the first material. In some cases, the second material may comprise a fabric or textile material with high abrasion resistance. In some cases, the high abrasion resistance material may comprise a polyurethane (PU) material. In some cases, the second interior portion of the bag may be configured as a protective reinforcement panel or lining for the bag. In some cases, when another bag (e.g., a stand bag) is positioned within the bag, the protective reinforcement panel or lining may be configured to extend around the leg knuckles, the base, and/or any other potentially abrasive components of the stand bag to prevent these components from damaging, ripping, or tearing through the other layers of the bag.

### Internal Strap

In some embodiments, the bag 1000 may include an internal support 1330 configured to secure an article within the bag 1000. In some embodiments, the article may include, for example, a golf bag (e.g., a golf stand bag, a golf cart bag, a golf caddie bag, a tour bag, a hybrid bag, a golf carry bag, or any other type of bag that can carry at least one or more golf clubs). In other embodiments, the article may include golf equipment or other sports-related equipment. For example, in some non-limiting embodiments, the article may include equipment that can be used for skiing, boarding, or any other activities involving equipment with a high-aspect ratio form factor.

In some embodiments, the internal support 1330 may include an internal strap that is secured to an inner surface portion of the bag 1000. In some cases, the internal strap may be secured to a select portion 1335 of the bag 1000 that is formed using a material with high abrasion resistance. In some cases, the select portion 1335 of the bag may comprise an abrasion resistant textile material.

In some cases, the internal strap may be secured to the interior of the bag along a bottom or lower edge of the abrasion resistant textile material. In some cases, the internal strap may be secured to the bottom or lower edge of the abrasion resistant textile material using one or more fasteners. In some cases, the one or more fasteners may include one or more rivets. In some cases, the one or more rivets may be covered to prevent damage or wear to any articles or items placed within the bag 1000.

In some embodiments, the internal strap may include a set of complementary fasteners attached to a first end and a second end of the internal strap. In some cases, the complementary fasteners may be connected to form an adjustable loop that can be positioned around one or more articles or items placed within the bag. In some cases, the adjustable loop may be tightened around the one or more articles or items to fix a position and/or an orientation of the articles or items within the interior region of the bag. In some cases, the adjustable loop may be loosened to release the one or more articles or items so that the articles or items can be repositioned or removed from the interior region of the bag.

### External Straps

In some embodiments, the bag 1000 may include one or more external straps 1340 extending laterally or longitudinally across a height, a length, and/or a width of the bag 1000. In some cases, the one or more external straps 1340 may be affixed to the exterior surface of the bag 1000 to strengthen the bag. In some cases, the one or more external straps 1340 may be affixed to the exterior surface of the bag 1000 to distribute or redistribute forces or loads exerted on the bag.

In some cases, the one or more external straps 1340 may include one or more lateral straps configured to strengthen the bag against radial expansion so that the bag can resist tearing or bursting. In some cases, the lateral straps may be arranged about the circumference of the bag. In some cases, the lateral straps may extend circumferentially around the bag. In some cases, the lateral straps may include one or more complementary fasteners that can be joined together to form a closed loop configuration. In some cases, the closed loop configuration may be adjusted by tensioning or loosening the lateral straps or by manipulating the one or more fasteners to adjust a level of tension in the lateral straps.

In some cases, the one or more external straps 1340 may include one or more longitudinal straps configured to distribute or redistribute various forces or loads exerted on the bag. In some cases, the one or more longitudinal straps may be configured to transfer forces or loads exerted on a first portion or section of the bag to a second portion or section of the bag. In some cases, the first portion or section of the bag may include a portion or a section of the bag that is vulnerable to damage when forces or loads exceeding a predetermined threshold are applied to said first portion or section of the bag. In some cases, the second portion or section of the bag may include another portion or section of the bag that can withstand forces or loads exceeding the predetermined threshold when such forces or loads are applied to said second portion or section of the bag.

In some cases, the one or more external straps 1340 may be coupled or connected to a handle of bag. In some cases, the handle may be positioned on or along the top of the bag. In some cases, when a user or a subject pulls on the top handle of the bag, the one or more external straps 1340 may be configured to transmit the tensile forces exerted on the handle to another portion of the bag that the external straps are coupled or connected to. For example, in some cases, the one or more external straps 1340 may be configured to transmit the tensile forces to a base portion of the bag and/or to a cover piece that is attached to the bag. In some cases, the one or more external straps 1340 may be configured to transmit the tensile forces away from the main body of the bag and/or away from the zipper openings of the bag.

In some cases, one or more handle members may be attached or coupled to the one or more external straps 1340. In some cases, the one or more handle members may be positioned along a length or a width of the external straps. In some cases, when the handle members are brought or held together in order to pull, lift, carry, or support at least a portion of the weight of the bag, the external straps may be configured to transfer the forces exerted on the handle members along the length of the bag so that the weight of the bag can be redistributed along the external straps but not on the main body of the bag or the zipper opening of the bag.

In some cases, two or more external straps may be affixed to a surface of the bag and arranged so that the ends of the straps are joined together to form a loop. In some cases, the loop may be configured as a handle for pulling, lifting, carrying, or supporting a weight of the bag. In some cases, the loop may be joined to a handle of the bag so that when the loop and the handle are grabbed together, strong pulling forces can be transmitted along the external straps to alleviate or redistribute stresses or strains exerted on the portions of the bag that are directly connected to the handle or the loop.

In some cases, the one or more external straps 1340 may be configured to cooperate not only with the body of the bag, but also the base of the bag and the cover assembly that is attached the bag. In some cases, at least a portion of the external straps may be attached or connected to a part of the bag that typically experiences stresses or strains (e.g., the handle portions of the bag), and at least another portion of the external straps may be connected to the base of the bag or the cover assembly of the bag (e.g., by using rivets or other mechanical fasteners). In some cases, the mechanical coupling of the external straps to (i) the handle portions of the bag and/or (ii) the base or the cover assembly of the bag may allow the external straps to transmit or redistribute the tensile forces exerted on the bag handles to the bag base or the cover assembly, which may be stronger or more durable than the handle portions of the bag or the other surrounding parts of the bag that the handles of the bag are attached to.

In some cases, the one or more external straps 1340 may be configured to cooperate with one or more internal or external pockets of the bag. For example, in some cases, the edges of the pockets may be sewn to an internal or external surface of the body section of the bag, and the external straps may be arranged to cover or overlie the pockets and/or the sides or edges of the pockets. In such cases, the external straps may be configured to protect the sides or edges of the pockets, and may provide an additional layer of support for the pockets so that the pockets can be filled to capacity without compromising the structural integrity of the pocket.

### Fasteners

In some embodiments, one or more fasteners 1345 may be attached or coupled to the one or more external straps 1340. In some cases, the one or more fasteners 1345 may include a plurality of mating fasteners (e.g., complementary male and female fasteners) that can be used to secure the one or more external straps 1340 around the body of the bag 1000.

### Connector Assembly

In some embodiments, the bag may comprise a connector assembly comprising a fastener 1350. In some embodiments, the fastener 1350 may be provided along a back surface of the bag. In some embodiments, the fastener 1350 may be attached to one or more external straps 1340 extending across the back surface of the bag.

In some cases, the fastener 1350 may be configured to engage one or more other fasteners associated with one or more other bags or one or more straps attached to and extending from the one or more other bags, in order to detachably couple the travel bag to the one or more other bags.

In some cases, the fastener 1350 may be configured to engage a complementary fastener provided along the back surface of the bag, e.g., when the fastener 1350 is decoupled from the one or more other fasteners associated with the one or more other bags or the one or more straps attached to or extending from the one or more other bags.

In other cases, a complementary fastener may not or need not be provided, so that the fastener 1350 is always accessible and ready to engage with one or more other fasteners associated with one or more other bags or one or more straps attached to or extending from the one or more other bags.

### Bag Coupling System

In another aspect, the present disclosure provides various systems for detachably coupling a plurality of bags so that the plurality of bags can be moved together easily and conveniently. In some cases, the bags disclosed herein may be detachably coupled to at least one other bag to form a self-stabilizing or a self-stabilized bag assembly as described in further detail below.

### Self-Stabilizing

In some embodiments, the bags may be connected or linked to form a bag assembly that is self-stabilizing or self-stabilized so that the bag assembly can be easily displaced or maneuvered around together with minimal effort. As used herein, the term “self-stabilizing” or “self-stabilized” may refer to a configuration in which the bags in the bag assembly are arranged such that the bags and/or the bag assembly exhibit one or more of pitch, roll, and/or yaw stability. In some cases, the pitch, roll, and/or yaw stability of the bags and/or the bag assembly may enhance the stability and the maneuverability of the bags and/or the bag assembly when the bags are connected or linked together to form the bag assembly.

In some cases, the self-stabilizing bag assembly may exhibit good internal and external pitch stability. Internal pitch stability may refer to the tendency of the bags in the bag assembly to retain the same angle of inclination about a reference lateral axis, when the bags are linked or connected together to form the bag assembly. External pitch stability may refer to the tendency of the bags in the bag assembly to resist pitching forward or backwards so that one or more wheels of the bag assembly remain planted on the ground.

In some cases, the self-stabilizing bag assembly may exhibit good internal and external roll stability. Internal roll stability may refer to the tendency of the bags in the bag assembly to retain the same angular orientation about a reference longitudinal axis. External roll stability may refer to the tendency of the bag assembly to resist rotation about the reference longitudinal axis so that one or more wheels of the bag assembly remain planted on the ground.

In some cases, the self-stabilizing bag assembly may exhibit good internal and external yaw stability. Internal yaw stability may refer to the tendency of the bags in the bag assembly to keep the same angular orientation or relative alignment along their respective vertical axes. External yaw stability may refer to the tendency for the bag assembly to resist rotation about the vertical axis so that the bag assembly tracks straight when the bag assembly is rolled along or across the ground.

In some cases, when the bags in the bag assembly are linked together and arranged in a self-stabilizing configuration, the weight of the bags may be distributed in a way that allows the bags in the bag assembly to remain in a fixed position and/or a fixed orientation relative to each other. In some cases, the self-stabilizing configuration may distribute the weight of the bags across the wheels or rollers of the linked bags, so that the bags in the self-stabilized bag assembly remain in a state of mechanical equilibrium without the need for any other external support or input. In some cases, the bags in the self-stabilizing bag assembly may be arranged in a state of mechanical equilibrium so that the bags in the bag assembly do not move or shift around to upset the balance or overall stability of the bag assembly. Once the bags are linked together to form the self-stabilizing bag assembly, a subject may easily move the bag assembly with a single hand without expending any additional effort to keep the assembly together and properly positioned. Furthermore, whether stationary or in motion, and whether tilted or not, the bag assembly may be completely self-stabilized so that the bag assembly can be maneuvered around or along an established path without any external support or input. In some cases, the bag assembly may remain self-stabilized when the bag assembly is in motion and/or when the bag assembly is stationary. In some cases, the bag assembly may remain self-stabilized regardless of whether the bags in the bag assembly are positioned upright or tilted relative to each other or the underlying ground surface.

Luggage Bag+Luggage Bag(s)

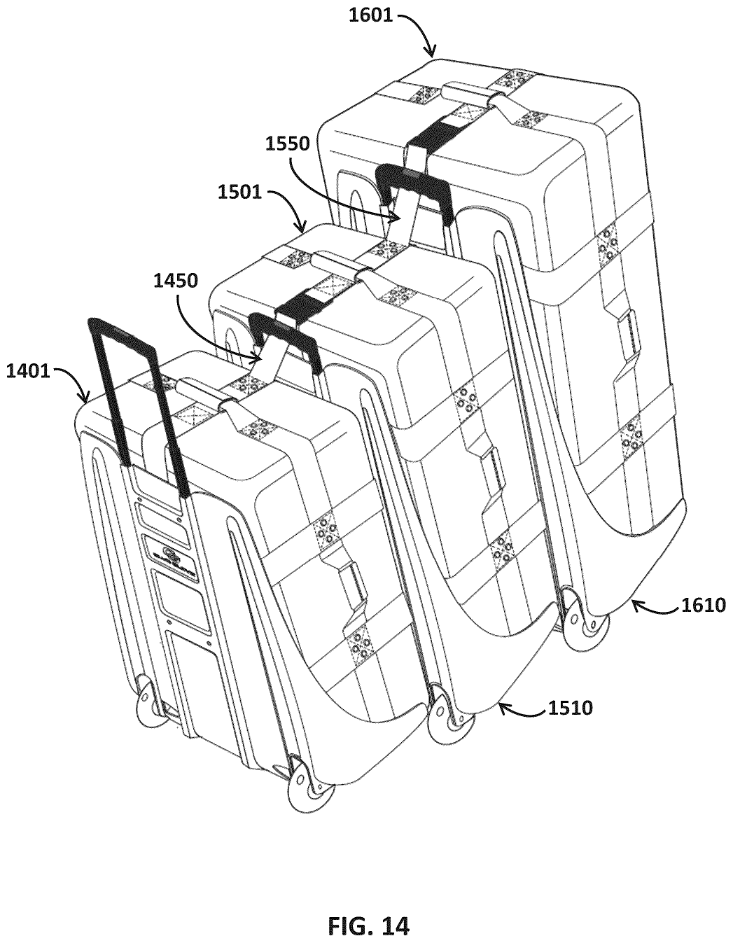

FIG. 14 schematically illustrates an example of a system for coupling multiple bags together so that the bags can be moved together in tandem. In some cases, the multiple bags may include a bag that can be checked in (e.g., as shown in at least FIGS. 1A-1B, 2A-2C, 3A-3B, 4A-4B, and 5A-5B). In some cases, the multiple bags may include a bag that can be carried on a vehicle (e.g., as shown in at least FIGS. 6A-6B, 7A-7B, 8A-8B, and 9A-9B). In some cases, the multiple bags may include a bag that can be used to carry or transport one or more items or objects with an elongated form factor (e.g., as shown in at least FIGS. 10A-10B, 11A-11B, 12A-12B, and 13A-13C).

### First and Second Bag

In some embodiments, the traction reaction system may be configured to couple a first bag 1401 to a second bag 1501. In some embodiments, the traction reaction system may be configured to couple the second bag 1501 to a third bag 1601. In some cases, at least two of the first bag 1401, the second bag 1501, and the third bag 1601 may have a same size or shape. In some cases, at least two of the first bag 1401, the second bag 1501, and the third bag 1601 may have a different size or shape. In some cases, the second bag and/or the third bag may have a greater length, height, and/or width than the first bag or a larger storage volume than the first bag. In some cases, the third bag may have a greater length, height, and/or width than the first bag or the second bag or a larger storage volume than the first or second bag.

In some cases, the traction reaction system may comprise a first strap 1450 extending between and connecting the first bag 1401 and the second bag 1501. In some cases, the first strap 1450 may have a first end connected to the first bag 1401 and a second end that can be detachably coupled to (i) the first bag 1401 and/or (ii) the second bag 1501. In some cases, when a subject intends to transport the first bag 1401 by itself, the second end of the first strap 1450 may be detachably coupled to the front side of the first bag 1401. In some cases, when a subject wishes to connect the first bag 1401 to the second bag 1501, the second end of the first strap 1450 may be detached from the front side of the first bag 1401 and re-attached to a top side of the second bag 1501.

In some cases, the second end of the first strap 1450 may include a fastener for releasably coupling the second end of the first strap 1450 to (i) the first bag 1401 and/or (ii) the second bag 1501. In some cases, the fastener disposed on the second end of the first strap 1450 may be configured to engage another fastener disposed on (i) the front side of the first bag 1401 and/or (ii) the top side of the second bag 1501. In some cases, the fastener disposed on the front side of the first bag 1401 may be attached to the fastener disposed on the second end of the first strap 1450 when the first bag 1401 is in a standalone configuration (i.e., when the first bag 1401 is not connected to any other bag). In some cases, the fastener disposed on the front side of the first bag 1401 may remain disconnected or unconnected to any other fasteners when the first strap 1450 is used to connect the first bag 1401 and the second bag 1501. In some cases, the fastener disposed on the top side of the second bag 1501 may be attached to the fastener disposed on the second end of the first strap 1450 when the first bag 1401 and the second bag 1501 are connected together using the first strap 1450. In some cases, the fastener disposed on the top side of the second bag 1501 may not or need not be connected to any complementary fastener when the second bag 1501 is in a standalone configuration (i.e., when the second bag 1501 is not connected to any other bag).

In some cases, the second end of the first strap 1450 may be routed under a retractable handle associated with the second bag 1501 when connecting the first bag 1401 and the second bag 1501. In some cases, the first strap may be routed between a plurality of support members attached to the retractable handle in order to connect the fastener disposed on the second end of the first strap to a fastener disposed on the top side of the second bag 1501. In some cases, when the first strap 1450 is routed under the retractable handle and through the plurality of support members attached to the retractable handle of the second bag 1501, the retractable handle of the second bag 1501 may still be accessible and/or deployable as needed even after the first bag 1401 and the second bag 1501 are attached together using the first strap 1450. In some cases, the retractable handle may be configured to (i) keep the strap in one or more predetermined positions and/or (ii) control or modulate the routing of the strap between the first and second bag so that the first and second bag can be easily maneuvered or transported around when attached together.

In some cases, the second end of the first strap 1450 may be routed over the handle of the second bag 1501 when connecting the first bag 1401 and the second bag 1501. In some cases, when the first strap 1450 is routed over the handle of the second bag 1501, the first strap may be configured to keep the handle of the second bag 1501 in a retracted position so that the handle of the second bag does not extend outwards or upwards when the first bag 1401 and the second bag 1501 are attached together using the first strap 1450.

### Alignment

As described above, in some embodiments, the first bag 1401 and the second bag 1501 may be attached or joined together using a strap. In some cases, the first bag 1401 and the second bag 1501 may also be aligned relative to each other in order to keep the first and second bags in a stable nested configuration that allows the first and second bags to be maneuvered and/or transported around together as a single unit.

In some cases, the front side of the first bag 1401 may have a first contour or profile that corresponds to a second contour or profile of the cover assembly 1510 of the second bag 1501. In some cases, the front side of the first bag 1401 may be shaped to engage with the protrusions or recesses of the cover assembly 1510 of the second bag 1501 so that the first bag 1401 and the second bag 1501 can be nested together in a stable configuration that restricts or limits a movement of the first bag relative to the second bag or vice versa.

### Strap Length

In some embodiments, the length of the strap connecting the first bag and the second bag may vary depending on the size of the first and/or second bag and the relative sizing of the first and second bags, to allow the first and second bags to be arranged in a self-stabilizing configuration when the first and second bags are connected using the strap. For example, in some preferred embodiments, the second bag may have a greater length, height, and/or width than the first bag, or the second bag may have a greater storage volume than the first bag. In such cases, the strap extending from the first bag to the second bag may be a first length such that the first bag and the second bag can be arranged to form a self-stabilizing bag assembly when the first and second bags are connected using the strap. In other embodiments, the second bag may have a same length, height, and/or width as the first bag, or the second bag may have a same storage volume as the first bag. In such cases, the strap extending from the first bag to the second bag may be a second length that is greater than the first length so that the first and second bags can be arranged and oriented to form a self-stabilizing bag assembly when the first and second bags are connected using the strap.

In some embodiments, the length of the strap connecting the first bag and the second bag may be fixed. In other embodiments, the length of the strap connecting the first bag and the second bag may be adjustable based on the size of the first or second bag and/or the relative sizing of the first and second bags, to ensure that the first and second bags can be arranged in a self-stabilizing configuration when connected together using the strap. In some cases, the length of the strap may be manually adjusted using one or more length adjustment mechanisms. The length adjustment mechanism may include, for example, a strap adjuster comprising a clip, a slide, a ring, a hook, a buckle, a latch, or one or more fasteners (e.g., buttons or hook and loop fasteners such as Velcro®). In other cases, the strap may comprise an elastic portion or section that can stretch to allow the length of the strap to be adjusted based on the amount of tension or tensile force exerted on the strap. In some alternative embodiments, the strap may be coupled to a spring-loaded reel mechanism that allows the length of the strap to be adjusted by either pulling the strap to a desired length or by releasing the strap so that the spring-loaded reel mechanism can draw the strap back to its initial or original length.

In some embodiments, the bag may comprise a separate extender strap that can be used to connect two or more bags that are of a same size, shape, or storage volume. In some cases, the separate extender strap may comprise a plurality of fasteners (e.g., a male fastener and a female fastener) configured to engage with (i) a connecting fastener associated with a first bag and (ii) another connecting fastener associated with a second bag. In some cases, the plurality of fasteners may comprise a first fastener configured to engage with a first connecting fastener associated with a first bag and a second connecting fastener associated with a second bag. In some cases, the first connecting fastener may correspond to a connecting fastener disposed on an end of a strap that is attached or coupled to the first bag. In some cases, the second connecting fastener may correspond to a connecting fastener disposed on an upper surface of the second bag. In some cases, the first connecting fastener associated with the first bag may be coupled to a first end of the separate extender strap, and the second end of the separate extender strap may be coupled to the second connecting fastener associated with the second bag, in order to extend the length of the mechanical connection between the first bag and the second bag. In some cases, the extension of the mechanical connection between the first bag and the second bag may facilitate the arrangement of the first and second bags in a self-stabilizing configuration, particularly in cases where the first bag and the second bag are of a same size, shape, or storage volume.

### Second and Third Bag

In some embodiments, the traction reaction system may be configured to couple the second bag 1501 to a third bag 1601. In some cases, the third bag 1601 may comprise a same type of bag as the first bag and/or the second bag. In other cases, the third bag 1601 may be a different type of bag than the first bag and/or the second bag.

In some cases, the traction reaction system may comprise a second strap 1550 extending between and connecting the second bag 1501 and the third bag 1601. In some cases, the second strap 1550 may have a first end connected to the second bag 1501 and a second end that can be detachably coupled to (i) the second bag 1501 and/or (ii) the third bag 1601. In some cases, when a subject intends to transport the second bag 1501 by itself, the second end of the second strap 1550 may be detachably coupled to the front side of the second bag 1501. In some cases, when a subject wishes to connect the second bag 1501 to the third bag 1601, the second end of the second strap 1550 may be detached from the front side of the second bag 1501 and re-attached to a top side of the third bag 1601.

In some cases, the second end of the second strap 1550 may include a fastener for releasably coupling the second end of the second strap 1550 to (i) the second bag 1501 and/or (ii) the third bag 1601. In some cases, the fastener disposed on the second end of the second strap 1550 may be configured to engage another fastener disposed on (i) the front side of the second bag 1501 and/or (ii) the top side of the third bag 1601. In some cases, the fastener disposed on the front side of the second bag 1501 may be attached to the fastener disposed on the second end of the second strap 1550 when the second bag 1501 is in a standalone configuration (i.e., when the second bag 1501 is not connected to any other bag). In some cases, the fastener disposed on the front side of the second bag 1501 may remain disconnected or unconnected to any other fasteners when the second strap 1550 is used to connect the second bag 1501 and the third bag 1601. In some cases, the fastener disposed on the top side of the third bag 1601 may be attached to the fastener disposed on the second end of the second strap 1550 when the second bag 1501 and the third bag 1601 are connected together using the second strap 1550. In some cases, the fastener disposed on the top side of the third bag 1601 may not or need not be connected to any other complementary fasteners when the third bag 1601 is in a standalone configuration (i.e., when the third bag 1601 is not connected to any other bag).

In some cases, the second strap 1550 may be routed under a retractable handle associated with the third bag 1601 in order to connect the second bag 1501 and the third bag 1601 together. In some cases, the second strap may be routed between a plurality of support members attached to the retractable handle in order to connect the fastener disposed on the second end of the second strap to a fastener disposed on the top side of the third bag 1601. In some cases, when the second strap 1550 is routed under the retractable handle and through the plurality of support members attached to the retractable handle of the third bag 1601, the retractable handle of the third bag 1601 may still be accessible and/or deployable as needed even after the second bag 1501 and the third bag 1601 are attached together using the second strap 1550. In some cases, the retractable handle may be configured to (i) keep the strap in one or more predetermined positions and/or (ii) control or modulate the routing of the strap between the second and third bag so that the second and third bag can be easily maneuvered or transported around when attached together.

In some cases, the second end of the second strap 1550 may be routed over the handle of the third bag 1601 when connecting the second bag 1501 and the third bag 1601. In some cases, when the second strap 1550 is routed over the handle of the third bag 1601, the second strap may be configured to keep the handle of the third bag 1601 in a retracted position so that the handle of the third bag does not extend outwards or upwards when the second bag 1501 and the third bag 1601 are attached together using the second strap 1550.

### Alignment

As described above, in some embodiments, the second bag 1501 and the third bag 1601 may be attached or joined together using a strap. In some cases, the second bag 1501 and the third bag 1601 may also be aligned relative to each other in order to keep the second and third bags in a stable nested configuration that allows the second and third bags to be maneuvered and/or transported around together as a single unit.

In some cases, the front side of the second bag 1501 may have a contour or profile that corresponds to a contour or profile of the cover assembly 1610 of the third bag 1601. In some cases, the front side of the second bag 1501 may be shaped to engage with the protrusions or recesses of the cover assembly 1610 of the third bag 1601 so that the second bag 1501 and the third bag 1601 can be nested together in a stable configuration that restricts or limits a movement of the second bag relative to the third bag or vice versa.

### Strap Length

In some embodiments, the length of the strap connecting the second bag and the third bag may vary depending on the size of the second or third bag and/or the relative sizing of the second and third bags, to allow the second and third bags to be arranged in a self-stabilizing configuration when the second and third bags are connected using the strap. For example, in some preferred embodiments, the third bag may have a greater length, height, and/or width than the second bag, or the third bag may have a greater storage volume than the second bag. In such cases, the strap extending from the second bag to the third bag may be a first length such that the second bag and the third bag can be arranged to form a self-stabilizing bag assembly when the second and third bags are connected using the strap. In other embodiments, the third bag may have a same length, height, and/or width as the second bag, or the third bag may have a same storage volume as the second bag. In such cases, the strap extending from the second bag to the third bag may be a second length that is greater than the first length so that the second and third bags can be arranged and oriented to form a self-stabilizing bag assembly when the second and third bags are connected using the strap.

In some embodiments, the length of the strap connecting the second bag and the third bag may be fixed. In other embodiments, the length of the strap connecting the second bag and the third bag may be adjustable based on the size of the second or third bag and/or the relative sizing of the second and third bags, to ensure that the second and third bags can be arranged in a self-stabilizing configuration when connected together using the strap. In some cases, the length of the strap may be manually adjusted using one or more length adjustment mechanisms. The length adjustment mechanism may include, for example, a strap adjuster comprising a clip, a slide, a ring, a hook, a buckle, a latch, or one or more fasteners (e.g., buttons or hook and loop fasteners such as Velcro®). In other cases, the strap may comprise an elastic portion or section that can stretch to allow the length of the strap to be adjusted based on the amount of tension or tensile force exerted on the strap. In some alternative embodiments, the strap may be coupled to a spring-loaded reel mechanism that allows the length of the strap to be adjusted by either pulling the strap to a desired length or by releasing the strap so that the spring-loaded reel mechanism can draw the strap back to its initial or original length.

In some embodiments, the bag may comprise a separate extender strap that can be used to connect two or more bags that are of a same size, shape, or storage volume. In some cases, the separate extender strap may comprise a plurality of fasteners (e.g., a male fastener and a female fastener) configured to engage with (i) a connecting fastener associated with the second bag and (ii) another connecting fastener associated with the third bag. In some cases, the plurality of fasteners may comprise a first fastener configured to engage with a connecting fastener associated with the second bag and another connecting fastener associated with the third bag. In some cases, the connecting fastener associated with the second bag may correspond to a connecting fastener disposed on an end of a strap that is attached or coupled to the second bag. In some cases, the connecting fastener associated with the third bag may correspond to a connecting fastener disposed on an upper surface of the third bag. In some cases, the connecting fastener associated with the second bag may be coupled to a first end of the separate extender strap, and the second end of the separate extender strap may be coupled to another connecting fastener associated with the third bag, in order to extend the length of the mechanical connection between the second bag and the third bag. In some cases, the extension of the mechanical connection between the second bag and the third bag may facilitate the arrangement of the second and third bags in a self-stabilizing configuration, particularly in cases where the second bag and the third bag are of a same size, shape, or storage volume.

### Luggage Bag+Travel Bag

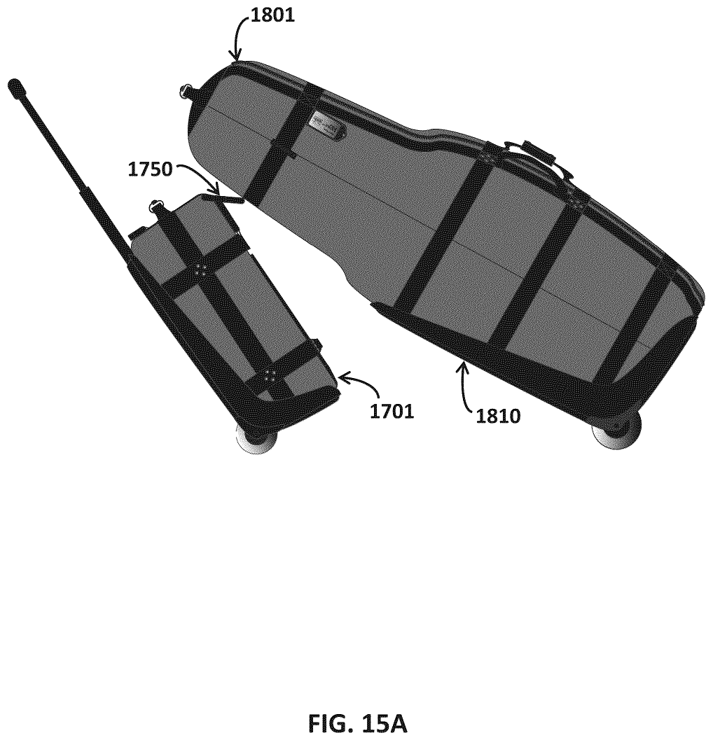

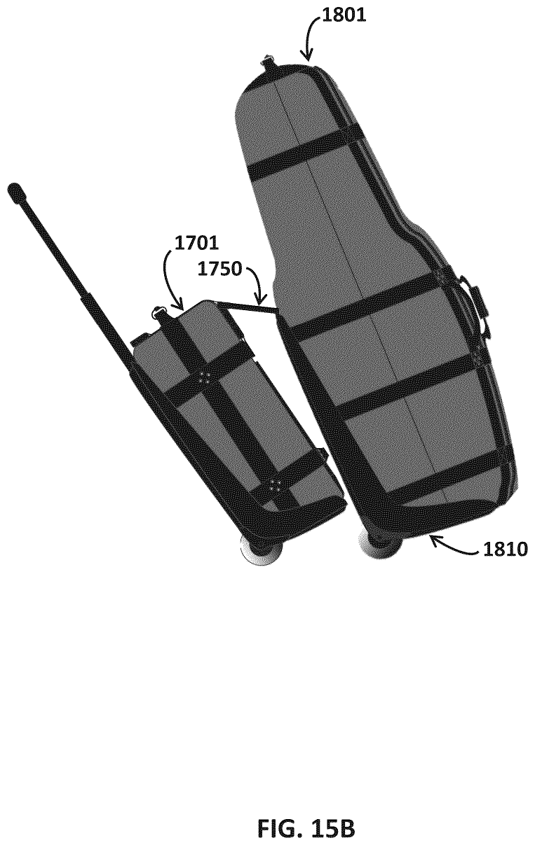

FIGS. 15A and 15B schematically illustrate other non-limiting examples of a system for coupling multiple bags together so that the bags can be moved together in tandem. In some cases, the multiple bags may include a bag that can be checked in (e.g., as shown in at least FIGS. 1A-1B, 2A-2C, 3A-3B, 4A-4B, and 5A-5B). In some cases, the multiple bags may include a bag that can be carried on a vehicle (e.g., as shown in at least FIGS. 6A-6B, 7A-7B, 8A-8B, and 9A-9B). In some cases, the multiple bags may include a bag that can be used to carry or transport one or more items or objects with an elongated form factor (e.g., as shown in at least FIGS. 10A-10B, 11A-11B, 12A-12B, and 13A-13C).

In some embodiments, the traction reaction system may be configured to couple a first bag 1701 to a second bag 1801. In some cases, the first bag may comprise a carry on luggage bag or a check-in luggage bag. In some cases, the second bag may comprise an elongated travel bag having a different size and/or a different shape than the first bag.

In some cases, the traction reaction system may comprise a first strap 1750 extending between and connecting the first bag 1701 and the second bag 1801. In some cases, the first strap 1750 may have a first end connected to the first bag 1701 and a second end that can be detachably coupled to (i) the first bag 1701 and/or (ii) the second bag 1801. In some cases, when a subject intends to transport the first bag 1701 by itself, the second end of the first strap 1750 may be detachably coupled to the front side of the first bag 1701. In some cases, when a subject wishes to connect the first bag 1701 to the second bag 1801, the second end of the first strap 1750 may be detached from the front side of the first bag 1701 and re-attached to the second bag 1801.

In some cases, the second end of the first strap 1750 may include a fastener for releasably coupling the second end of the first strap 1750 to (i) the first bag 1701 and/or (ii) the second bag 1801. In some cases, the fastener disposed on the second end of the first strap 1750 may be configured to engage a complementary fastener disposed on the front side of the first bag 1701. In some cases, the fastener disposed on the second end of the first strap 1750 may be configured to engage another fastener provided on the second bag 1801.

In some cases, the fastener provided on the second bag 1801 may be positioned along a back side of the second bag 1801 (i.e., a side of the second bag 1801 facing the first bag 1701). In some cases, the fastener provided on the second bag 1801 may be positioned along an external strap extending across or around the second bag 1801. In some cases, the fastener provided on the second bag 1801 may be positioned directly above and/or in close proximity to an upper edge of a cover piece 1810 of the second bag 1801. In some cases, the fastener provided on the second bag 1801 may be positioned within a predetermined distance of the upper edge of the cover piece 1810 of the second bag 1801. In some cases, the predetermined distance may be at most about 200 millimeters (mm), 190 mm, 180 mm, 170 mm, 160 mm, 150 mm, 140 mm, 130 mm, 120 mm, 110 mm, 100 mm, 90 mm, 80 mm, 70 mm, 60 mm, 50 mm, 40 mm, 30 mm, 20 mm, 10 mm, or less.

In some cases, the complementary fastener disposed on the front side of the first bag 1701 may be attached to the fastener disposed on the second end of the first strap 1750 when the first bag 1701 is in a standalone configuration (i.e., when the first bag 1701 is not connected to any other bag). In some cases, the complementary fastener disposed on the front side of the first bag 1701 may remain disconnected or unconnected to any other fasteners when the first strap 1750 is used to connect the first bag 1701 and the second bag 1801.

In some cases, the fastener disposed on the second bag 1801 may be attached to the fastener disposed on the second end of the first strap 1750 when the first bag 1701 and the second bag 1801 are connected together using the first strap 1750. In some cases, the fastener disposed on the second bag 1801 may be detached or decoupled from the fastener disposed on the second end of the first strap 1750 when a subject wants to transport or maneuver the second bag 1801 in a standalone configuration (i.e., when the second bag 1801 is not connected to any other bag).

In some cases, the fastener disposed on the second bag 1801 may be connected to a complementary fastener provided along the back side of the second bag when the second bag 1801 is in a standalone configuration.

In other cases, the fastener disposed on the second bag 1801 may not or need not be connected to any other complementary fastener when the second bag 1801 is in a standalone configuration.

### Alignment

In some embodiments, the first bag 1701 and the second bag 1801 may be attached or joined together using a strap. In some cases, when the first bag 1701 and the second bag 1801 are attached together, the first and second bags may be configured to naturally align relative to each other in order to keep the first and second bags in a stable nested configuration that allows the first and second bags to be maneuvered and/or transported around together as a single unit.

In some cases, the front side of the first bag 1701 may have a first contour or profile that corresponds to a second contour or profile of the cover piece 1810 of the second bag 1801. In some cases, the front side of the first bag 1701 may be shaped to engage with the protrusions or recesses of the cover piece 1810 of the second bag 1801 so that the first bag 1701 and the second bag 1801 are nested together in a stable configuration that restricts or limits a movement of the first bag relative to the second bag and vice versa.

### Bag Assembly Movement

In some embodiments, a plurality of bags may be linked or connected together to form a self-stabilizing bag assembly. The plurality of bags may include any of the bags described herein.

In some cases, when multiple bags are linked or connected together to form a self-stabilizing bag assembly, a portion of the weight of the bag assembly may rest on the wheels of the first bag (i.e., the lead bag positioned at the front of the bag assembly closest to the subject). In some cases, the remaining weight of the bag assembly may rest on the wheels of the other bags in the bag assembly (e.g., the bags positioned behind or trailing the first bag).

In some cases, when a subject wishes to move the bag assembly, the subject may tilt one or more bags in the bag assembly forward. In some cases, the bags trailing behind the first bag may lean forward towards the first bag as the first bag is tilted. In some cases, when the bags trailing behind the first bag are leaned forward towards the first bag, at least some of the weight of the trailing bags may shift forward (e.g., over and/or in front of the wheels of the first bag) so that the bag assembly can be balanced on one or more wheels of the first bag. In some cases, when the bags trailing behind the first bag are leaned forward towards the first bag, the back side of the first trailing bag may be pressed against the front side of the first lead bag so that the bag assembly can maintain a self-stabilized configuration that enhances the stability and maneuverability of the bag assembly. In some cases, when the first bag is tilted forward and the trailing bags lean forward towards the first bag, one or more wheels of the trailing bags may still remain in contact with the underlying ground surface so that at least some of the weight of the bag assembly can rest on the wheels of the trailing bags. In some cases, when the first bag is tilted forward and the trailing bags lean forward towards the first bag, one or more wheels of the trailing bags may be lifted from the ground so that the weight of the bag assembly shifts primarily to the wheels of the first lead bag.

In some cases, once the self-stabilized bag assembly is repositioned or relocated to a target location, the bag assembly may be moved or tilted back towards a neutral or upright position. In some cases, when the self-stabilized bag assembly is returned to the neutral or upright position, the center of gravity of the bag assembly may be shifted backwards, and the weight of the bag assembly may be redistributed across the wheels of the bags in the bag assembly so that the self-stabilized bag assembly can remain upright and stationary without any external support or input.

### Examples

In some embodiments, the bags disclosed herein may be connected together to form a bag assembly. In some embodiments, the bag assembly may comprise a first bag and a second bag.

### First Bag

In some embodiments, the first bag may comprise a top surface, a bottom surface, a front surface, a back surface, and a plurality of side surfaces arranged to form an enclosed interior region for storing items or equipment within the first bag. In some cases, the first bag may comprise a first protective cover extending along the back surface of the first bag. In some cases, the first bag may comprise a first handle assembly comprising a first handle and a first plurality of support members attached to the first handle. In some cases, the first handle assembly may be positioned (i) external to the enclosed interior region of the first bag and (ii) between the first protective cover and the back surface of the first bag so that the first handle assembly can be retracted into a partially enclosed region provided between the first protective cover and the back surface of the first bag.

In some cases, the first bag may comprise a first connector assembly comprising a first external strap with a single connecting fastener attached to the first external strap. In some cases, the single connecting fastener may be the only connector provided on the first bag to facilitate a mechanical coupling or connection between the first bag and one or more other bags. In some cases, the connecting fastener may be configured to connect the first bag to a second bag positioned behind the first bag. In some cases, the first connector assembly may not or need not include any other fasteners for coupling the first bag to another bag (e.g., a third bag positioned in front of the first bag). In other cases, the first connector assembly may include another fastener for coupling the first bag to another bag (e.g., an additional bag positioned in front of the first bag).

In some cases, the connecting fastener may be positionable or securable along the front surface of the first bag. In some cases, the first connector assembly may comprise a first complementary fastener provided along the front surface of the first bag. In some cases, the first complementary fastener may be configured to engage the connecting fastener to keep the connecting fastener secured along the front surface of the first bag. In some cases, the connecting fastener may be positionable along the front surface of the first bag to facilitate a coupling between the connecting fastener and the first complementary fastener.

In some cases, the connecting fastener may be extendable towards a top surface of the second bag to facilitate a coupling between the connecting fastener and another fastener provided along the top surface of the second bag. In some cases, the connecting fastener may be extendable towards a back surface of the second bag to facilitate a coupling between the connecting fastener and another fastener provided along the back surface of the second bag.

### Second Bag−Luggage Bag

In some embodiments, the second bag may comprise a top surface, a bottom surface, a front surface, a back surface, and a plurality of side surfaces arranged to form an enclosed interior region for storing items or equipment within the second bag. In some cases, the second bag may comprise a second protective cover extending along the back surface of the second bag. In some cases, the second bag may comprise a second handle assembly comprising a second handle and a second plurality of support members attached to the second handle. In some cases, the second handle assembly may be positioned (i) external to the enclosed interior region of the second bag and (ii) between the second protective cover and the back surface of the second bag so that the handle assembly can be retracted into a partially enclosed region formed between the second protective cover and the back surface of the second bag.

In some cases, the second bag may comprise a second connector assembly comprising a second external strap with a first fastener and a second fastener attached to the second external strap. In some cases, the first fastener may be provided along the top surface of the second bag and the second fastener may be provided along the front surface of the second bag. In some cases, the first fastener may be configured to engage the connecting fastener attached to the first external strap of the first bag. In some cases, the first external strap of the first bag may be configured to extend under the second handle and between the second plurality of support members attached to the second handle to facilitate a coupling between the connecting fastener of the first bag and the first fastener of the second bag.

In some cases, the second connector assembly may comprise a second complementary fastener provided along the front surface of the second bag. In some cases, the second complementary fastener may be configured to engage the second fastener to keep the second fastener secured along the front surface of the second bag. In some cases, the second fastener may be positionable along the front surface of the second bag to facilitate a coupling between the second fastener and the second complementary fastener.

In some cases, the second fastener may be extendable towards another bag (e.g., a third bag) to facilitate a coupling between the second fastener and another fastener provided on the third bag. In some cases, the second external strap of the second bag may be configured to extend under a handle of a third bag (e.g., a luggage bag) and between a plurality of support members attached to the handle of the third bag to facilitate a coupling between the second fastener and a third fastener provided along a top surface of the third bag. In some cases, the second external strap of the second bag may be configured to extend towards a top surface of a third bag (e.g., a luggage bag) to facilitate a coupling between the second fastener and another fastener provided along the top surface of the third bag. In some cases, the second external strap of the second bag may be configured to extend towards a back surface of a third bag (e.g., a travel bag) to facilitate a coupling between the second fastener and another fastener provided along the back surface of the third bag.

### Orientation of Fasteners

In some embodiments, the first fastener of the second bag may be oriented towards the front surface of the first bag and/or towards the back surface of the second bag when the first fastener is secured to the connecting fastener of the first bag. In some embodiments, the first fastener of the second bag may be oriented towards the front surface of the first bag and/or towards the back surface of the second bag when the first fastener and the connecting fastener of the first bag are decoupled. In some embodiments, the second fastener of the second bag may be oriented towards the bottom surface of the second bag when the second fastener is secured to the second complementary fastener. In some embodiments, the first fastener may be oriented in a first direction when the first fastener of the second bag is secured to the connecting fastener of the first bag. In some embodiments, the second fastener of the second bag may be oriented in a second direction that is perpendicular or orthogonal to the first direction when the second fastener is secured to the second complementary fastener.

### Second Bag−Travel Bag

In some embodiments, the second bag may comprise a travel bag with a top surface, a bottom surface, a front surface, a back surface, and a plurality of side surfaces arranged to form an enclosed interior region for storing items or equipment within the second bag. In some cases, the second bag may comprise a second protective cover extending along the back surface of the second bag. In some cases, the second protective cover of the second bag may have a surface contour or profile corresponding to a front surface or a front side of the first bag.

In some cases, the second bag may comprise a second connector assembly comprising a second external strap with a fastener attached to the second external strap. In some cases, the fastener may be provided along a back surface of the second bag. In some cases, the fastener may be positioned directly above or in close proximity to an upper edge of the second protective cover of the second bag. In some cases, the fastener may be configured to engage the connecting fastener attached to the first external strap of the first bag. In some cases, the first external strap of the first bag may be extendable towards the back surface of the second bag to facilitate a coupling between the connecting fastener of the first bag and the fastener provided along the back surface of the second bag.

### Third Bag−Luggage Bag

In some embodiments, the bag assembly may comprise a third bag. In some cases, the third bag may comprise a same type of bag as the first bag and/or the second bag. In some cases, the third bag may be a luggage bag.

In some cases, the third bag may comprise a third handle assembly comprising a third handle and a third plurality of support members attached to the third handle. In some cases, the third bag may comprise a protective cover as described elsewhere herein. In some cases, the third handle may be retractable into a partially enclosed region provided between the protective cover and the exterior surface of the third bag.

In some cases, the third bag may comprise a third connector assembly comprising a third external strap with a third fastener and/or a fourth fastener attached to the third external strap. In some cases, the third fastener may be provided along a top surface of the third bag. In some cases, the fourth fastener may be positionable or securable along a front surface of the third bag.

In some cases, the third fastener may be configured to engage a connecting fastener attached to an external strap of the second bag. In some cases, an external strap of the second bag may be configured to extend under the third handle and between the third plurality of support members attached to the third handle to facilitate a coupling between a connecting fastener of the second bag and the third fastener of the third bag. In some cases, the second external strap of the second bag may be configured to extend under the third handle and between the third plurality of support members to facilitate a coupling between the second fastener of the second connector assembly and the third fastener of the third connector assembly.

In some cases, the third connector assembly may comprise a complementary fastener provided along the front surface of the third bag. In some cases, the complementary fastener may be configured to engage the fourth fastener to keep the fourth fastener secured along the front surface of the third bag. In some cases, the fourth fastener may be positionable along the front surface of the third bag to facilitate a coupling between the fourth fastener and the complementary fastener.

In some cases, the fourth fastener may be extendable towards another bag (e.g., a fourth bag) to facilitate a coupling between the fourth fastener and another fastener provided on the fourth bag. In some cases, the third external strap of the third bag may be configured to extend under a handle of a fourth bag (e.g., a luggage bag) and between a plurality of support members attached to the handle of the fourth bag to facilitate a coupling between the fourth fastener and another fastener provided along a top surface of the fourth bag. In some cases, the third external strap of the third bag may be extended towards a top surface of a fourth bag (e.g., a luggage bag) to facilitate a coupling between the fourth fastener and another fastener provided along the top surface of the fourth bag. In some cases, the third external strap of the third bag may be configured to extend towards a back surface of a fourth bag (e.g., a travel bag) to facilitate a coupling between the fourth fastener and another fastener provided along the back surface of the fourth bag.

### Orientation of Fasteners

In some embodiments, the third fastener of the third bag may be oriented towards the front surface of the second bag and/or towards the back surface of the third bag when the third fastener is secured to a connecting fastener of the second bag. In some embodiments, the third fastener of the third bag may be oriented towards the front surface of the second bag and/or towards the back surface of the third bag when the third fastener and the connecting fastener of the second bag are decoupled. In some embodiments, the fourth fastener of the third bag may be oriented towards the bottom surface of the third bag when the fourth fastener is secured to the complementary fastener provided along the front surface of the third bag. In some embodiments, the third fastener may be oriented in a first direction when the third fastener is secured to a connecting fastener provided on an external strap of the second bag. In some embodiments, the fourth fastener may be oriented in a second direction that is perpendicular or orthogonal to the first direction when the fourth fastener is secured to the complementary fastener provided along the front surface of the third bag.

### Third Bag−Travel Bag

In some embodiments, the bag assembly may comprise a third bag. In some cases, the third bag may comprise an elongated travel bag. In some cases, the elongated travel bag may have a different size and/or a different shape than the first bag. In some cases, the elongated travel bag may have a different size and/or a different shape than the second bag.

In some cases, the elongated travel bag may have a top surface, a bottom surface, a front surface, a back surface, and a plurality of side surfaces arranged to form an enclosed interior region for storing items or equipment. In some cases, the elongated travel bag may comprise a protective cover extending along the back surface of the elongated travel bag. In some cases, the protective cover of the elongated travel bag may have a surface contour or profile corresponding to a front surface or a front side of another bag positioned in front of the elongated travel bag.

In some embodiments, the third bag may comprise a third connector assembly comprising a third fastener. In some cases, the third fastener may be provided along a back surface of the third bag. In some cases, the third fastener may be attached or coupled to an external strap extending along or across the back surface of the third bag. In some cases, the third fastener may be positioned directly above an upper edge of a protective cover that is attached to the third bag.

In some cases, the third fastener may be configured to engage the second fastener of the second bag to detachably couple the third bag to the second bag. In some cases, the second external strap of the second bag may be extendable towards the back surface of the third bag to facilitate a coupling between the second fastener of the second bag and the third fastener provided along the back surface of the third bag.

### Connector Assembly Variations

In some embodiments, the first connector assembly of the first bag may have a different configuration or arrangement of connectors than the second connector assembly of the second bag. In some embodiments, the first connector assembly of the first bag may have a different configuration or arrangement of connectors than the third connector assembly of the third bag.

In some embodiments, the first connector assembly of the first bag may have a same configuration or arrangement of connectors as the second connector assembly of the second bag. In some embodiments, the first connector assembly of the first bag may have a same configuration or arrangement of connectors as the third connector assembly of the third bag.

In some embodiments, the second connector assembly of the second bag may have a different configuration or arrangement of connectors than the first connector assembly of the first bag. In some embodiments, the second connector assembly of the second bag may have a different configuration or arrangement of connectors than the third connector assembly of the third bag.

In some embodiments, the second connector assembly of the second bag may have a same configuration or arrangement of connectors as the first connector assembly of the first bag. In some embodiments, the second connector assembly of the second bag may have a same configuration or arrangement of connectors as the third connector assembly of the third bag.

In some embodiments, the third connector assembly of the third bag may have a different configuration or arrangement of connectors than the first connector assembly of the first bag. In some embodiments, the third connector assembly of the third bag may have a different configuration or arrangement of connectors than the second connector assembly of the second bag.

In some embodiments, the third connector assembly of the third bag may have a same configuration or arrangement of connectors as the first connector assembly of the first bag. In some embodiments, the third connector assembly of the third bag may have a same configuration or arrangement of connectors as the second connector assembly of the second bag.

In some embodiments, the first connector assembly of the first bag may be configured differently than at least one of the second connector assembly of the second bag and/or the third connector assembly of the third bag. For example, in some cases, the first connector assembly may include a different number of connectors or different types of connectors than the second connector assembly and/or the third connector assembly. Alternatively, or additionally, in some cases, the first connector assembly may include one or more connectors with a different spatial arrangement than the connectors in the second connector assembly and/or the third connector assembly. For example, the connectors in the first connector assembly may be arranged on a different part of the bag or in a different orientation along the bag than the connectors in the second connector assembly and/or the connectors in the third connector assembly.

In some embodiments, the second connector assembly of the second bag may be configured differently than the third connector assembly of the third bag. For example, in some cases, the second connector assembly may include a different number of connectors or different types of connectors than the third connector assembly. Alternatively, or additionally, in some cases, the second connector assembly may include one or more connectors with a different spatial arrangement than the connectors in the third connector assembly. For example, the connectors in the second connector assembly may be arranged on a different part of the bag or in a different orientation along the bag than the connectors in the third connector assembly.

In some optional embodiments, the first connector assembly, the second connector assembly, and/or the third connector assembly may be configured to have the same number of connectors or the same types of connectors. In some embodiments, the first connector assembly, the second connector assembly, and/or the third connector assembly may be configured to have one or more connectors arranged in a same spatial arrangement. For example, the connectors in the various different connector assemblies may be arranged on a same part of the bag or in a same orientation along the bag as the connectors in the other connector assemblies.

### Cover Assembly Variations

In some embodiments, the bags in the bag assembly may comprise a plurality of bags each having a protective cover attached thereto. In some cases, the plurality of bags may comprise a plurality of protective covers attached to the plurality of bags. In some cases, the plurality of protective covers may have a same or similar size and/or shape. In other cases, the plurality of protective covers may have different sizes and/or different shapes.

In some cases, the protective covers may include a first protective cover associated with a first bag in the bag assembly. In some cases, the first bag may comprise a luggage bag as described elsewhere herein. In some cases, the first protective cover may be configured to cover a first percentage of the back surface area of the first bag. In some cases, the first percentage may range from at least about 80% to 100% of the total back surface area of the first bag. In some cases, the first protective cover may have a height that is a first percentage of the total height of the first bag. In some cases, the first percentage may range from at least about 80% to 100% of the total height of the first bag.

In some cases, the protective covers may include a second protective cover associated with a second bag in the bag assembly. In some cases, the second bag may comprise a travel bag or an elongated travel bag as described elsewhere herein. In some cases, the second protective cover may be configured to cover a second percentage of the back surface area of the second bag. In some cases, the second percentage may range from about 40% to at most about 80% of the total back surface area of the second bag. In some cases, the second protective cover may have a height that is a second percentage of the total height of the second bag. In some cases, the second percentage may range from about 40% to at most about 80% of the total height of the second bag.

In some cases, the protective covers may be configured to cover a different percentage or range of percentages of the total back surface area of the bags, depending on the type of bag. For example, in some cases, the protective covers may cover at least about 80% to 100% of the back surface area of the bag if the bag is configured as a luggage bag. In another example, in some cases, the protective covers may cover between about 40% to about 80% of the total back surface area of the bag if the bag is configured as a travel bag or an elongated travel bag as described elsewhere herein.

In some cases, the height of the protective covers may be a different percentage or range of percentages of the total height of the bags, depending on the type of bag. For example, in some cases, the height of the protective covers may be at least about 80% to 100% of the height of the bag if the bag is configured as a luggage bag. In another example, in some cases, the height of the protective covers may range from about 40% to about 80% of the total height of the bag if the bag is configured as a travel bag or an elongated travel bag as described elsewhere herein.

### Cover Alignment

In some embodiments, the bags in the bag assembly may be configured to nest with each other to maintain a fixed spatial relationship between the bags when the bags are connected together. In some embodiments, the bags may comprise one or more protective covers with one or more surface features defining a surface contour that corresponds to a surface contour of one or more surfaces of another bag in the bag assembly. In some embodiments, the corresponding surface contours of the protective covers and the front surfaces of the bags may be configured to fix a position and/or an orientation of the bags relative to each other when the bags are connected or linked together.

### Surface Feature Arrangement

In some embodiments, the surface features may comprise a plurality of protrusions and/or a plurality of depressions that are arranged across the back surface of the protective covers. In some cases, the plurality of protrusions and/or the plurality of depressions may include a first protrusion/depression or a first set of protrusions/depressions spaced apart from a first side or edge of the protective cover by a first distance or a first set of distances. In some cases, the plurality of protrusions and/or depressions may include a second protrusion/depression or a second set of protrusions/depressions spaced apart from a second side or edge of the protective cover by a second distance or a second set of distances. In some cases, the first protrusion/depression or the first set of protrusions/depressions may be spaced apart from the second protrusion/depression or the second set of protrusions/depressions by a third distance or a third set of distances.

In some cases, the first distance or the first set of distances may be less than or equal to the second distance or the second set of distances. In some cases, the first distance or the first set of distances may be less than or equal to the third distance or the third set of distances. In some cases, the first distance or the first set of distances may be greater than or equal to the second distance or the second set of distances. In some cases, the first distance or the first set of distances may be greater than or equal to the third distance or the third set of distances.

In some cases, the second distance or the second set of distances may be less than or equal to the first distance or the first set of distances. In some cases, the second distance or the second set of distances may be less than or equal to the third distance or the third set of distances. In some cases, the second distance or the second set of distances may be greater than or equal to the first distance or the first set of distances. In some cases, the second distance or the second set of distances may be greater than or equal to the third distance or the third set of distances.

In some cases, the third distance or the third set of distances may be less than or equal to the first distance or the first set of distances. In some cases, the third distance or the third set of distances may be less than or equal to the second distance or the second set of distances. In some cases, the third distance or the third set of distances may be greater than or equal to the first distance or the first set of distances. In some cases, the third distance or the third set of distances may be greater than or equal to the second distance or the second set of distances.

In some cases, the first distance or the first set of distances may be constant or uniform across a portion or a section of the protective cover. In some cases, the first distance or the first set of distances may change or vary (e.g., increase or decrease) across a portion or a section of the protective cover. In some cases, the second distance or the second set of distances may be constant or uniform across a portion or a section of the protective cover. In some cases, the second distance or the second set of distances may change or vary (e.g., increase or decrease) across a portion or a section of the protective cover. In some cases, the third distance or the third set of distances may be constant or uniform across a portion or a section of the protective cover. In some cases, the third distance or the third set of distances may change or vary (e.g., increase or decrease) across a portion or a section of the protective cover.

### Surface Feature Geometry

In some cases, the first protrusion/depression or the first set of protrusions/depressions may have a first height/depth or a first set of heights/depths. In some cases, the second protrusion/depression or the second set of protrusions/depressions may have a second height/depth or a second set of heights/depths. In some cases, the third protrusion/depression or the third set of protrusions/depressions may have a third height/depth or a third set of heights/depths.

In some cases, the first height/depth or the first set of heights/depths may be less than or equal to the second height/depth or the second set of heights/depths. In some cases, the first height/depth or the first set of heights/depths may be less than or equal to the third height/depth or the third set of heights/depths. In some cases, the first height/depth or the first set of heights/depths may be greater than or equal to the second height/depth or the second set of heights/depths. In some cases, the first height/depth or the first set of heights/depths may be greater than or equal to the third height/depth or the third set of heights/depths.

In some cases, the second height/depth or the second set of heights/depths may be less than or equal to the first height/depth or the first set of heights/depths. In some cases, the second height/depth or the second set of heights/depths may be less than or equal to the third height/depth or the third set of heights/depths. In some cases, the second height/depth or the second set of heights/depths may be greater than or equal to the first height/depth or the first set of heights/depths. In some cases, the second height/depth or the second set of heights/depths may be greater than or equal to the third height/depth or the third set of heights/depths.

In some cases, the third height/depth or the third set of heights/depths may be less than or equal to the first height/depth or the first set of heights/depths. In some cases, the third height/depth or the third set of heights/depths may be less than or equal to the second height/depth or the second set of heights/depths. In some cases, the third height/depth or the third set of heights/depths may be greater than or equal to the first height/depth or the first set of heights/depths. In some cases, the third height/depth or the third set of heights/depths may be greater than or equal to the second height/depth or the second set of heights/depths.

In some cases, the first height/depth or the first set of heights/depths may be constant or uniform across a portion or a section of the protective cover. In some cases, the first height/depth or the first set of heights/depths may change or vary (e.g., increase or decrease) across a portion or a section of the protective cover. In some cases, the second height/depth or the second set of heights/depths may be constant or uniform across a portion or a section of the protective cover. In some cases, the second height/depth or the second set of heights/depths may change or vary (e.g., increase or decrease) across a portion or a section of the protective cover. In some cases, the third height/depth or the third set of heights/depths may be constant or uniform across a portion or a section of the protective cover. In some cases, the third height/depth or the third set of heights/depths may change or vary (e.g., increase or decrease) across a portion or a section of the protective cover.

### Common Surface Features

In some embodiments, the bags described herein may be connected to form a bag assembly. In some cases, the bag assembly may comprise a first bag with a first protective cover and a second bag with a second protective cover. In some cases, the first bag may be the same type of bag as the second bag. In other cases, the first bag may be a different type of bag than the second bag. In some cases, the first bag may be a same size and/or a same shape as the second bag. In other cases, the first bag and the second bag may be sized and/or shaped differently. In some cases, the first protective cover and the second protective cover may have one or more common surface features allowing the first and second bags to interchangeably nest with any of the other bags described elsewhere herein, in any order and regardless of whether the other bags are sized or shaped differently than the first bag and/or the second bag. Furthermore, the first bag and the second bag may be nested in any order, regardless of whether the first bag and the second bag are a same type of bag or different types of bags.

In some embodiments, the bags described herein may be connected to form a bag assembly comprising a first bag, a second bag, and a third bag. In some cases, at least two of the first bag, the second bag, and/or the third bag may be a same type of bag. In some cases, two or more of the first bag, the second bag, and/or the third bag may be different types of bags. In some cases, the first bag, the second bag, and/or the third bag may have a same size and/or a same shape. In other cases, the first bag, the second bag, and/or the third bag may be sized and/or shaped differently. In some cases, the first protective cover, the second protective cover, and the third protective may have one or more common surface features allowing the first and second bags to nest with any of the other bags described elsewhere herein, in any order and regardless of whether the other bags are sized or shaped differently than the first bag, the second bag, and/or the third bag. Furthermore, the first bag, the second bag, and/or the third bag may be nested in any order, regardless of whether the first bag, the second bag, and/or the third bag are a same type of bag or different types of bags.

In some cases, the one or more common surface features may include one or more surface features that are common to a plurality of different protective covers associated with multiple different bags. In some cases, the one or more common surface features may be configured to facilitate the nesting of multiple bags in the bag assembly in any order regardless of the size and/or the shape of the bags in the bag assembly. In some cases, the one or more common surface features may be configured to facilitate the nesting of multiple bags in the bag assembly in any order regardless of any variations in or differences between the structures of the bags or the connector configurations of the bags in the bag assembly.

In some cases, the one or more common surface features may comprise a first set of surface features provided on or arranged across the protective cover of a first bag. In some cases, the one or more common surface features may comprise a second set of surface features provided on or arranged across the protective cover of a second bag. In some cases, the one or more common surface features may comprise a third set of surface features provided on or arranged across the protective cover of a third bag. In some cases, the first set of surface features, the second set of surface features, and the third set of surface features may comprise the same surface feature(s) or the same set of surface features. In some cases, the same surface feature(s) or the same set of surface features may have a same size and/or a same shape on each of the protective covers. In some cases, the same surface feature(s) or the same set of surface features may be arranged in the same position and/or in the same orientation across each of the protective covers.

In other cases, the protective covers of the bags in the bag assembly may have different sets of surface features that are configured to facilitate the coupling or the nesting of the bags in a particular pre-determined order. For example, in some cases, a first bag in the bag assembly may have a first cover with a first set of surface features that define a surface contour corresponding to a surface contour of a front surface of a second bag so that the first bag can be nested specifically along the front surface of the second bag. Further, in some cases, the second bag may have a second cover with a second set of surface features that define a surface contour corresponding to a surface contour of a front surface of a third bag so that the second bag can be nested specifically along the front surface of the third bag. Additionally, in some cases, the third bag may have a third cover with a third set of surface features that define a surface contour corresponding to a surface contour of a front surface of a fourth bag so that the third bag can be nested specifically along the front surface of the fourth bag, and so on. In some cases, the first set of surface features, the second set of surface features, and the third set of surface features may have different or distinct geometries or structures.

### Auxiliary Alignment

In some embodiments, the bags disclosed herein may comprise one or more auxiliary alignment features. In some cases, the one or more auxiliary alignment features may comprise one or more straps, handles, or hooks configured to secure one or more sides or surfaces of a first bag to one or more sides or surfaces of a second bag. In some cases, the one or more auxiliary alignment features may comprise one or more magnetic fasteners disposed on a surface of the bags and one or more complementary magnetic fasteners integrated with one or more covers attached to the bags. In some cases, the one or more magnetic fasteners may be configured to detachably engage the complementary magnetic fasteners in order to align adjacent bags within the bag assembly so that the bags can be secured and/or nested together as described elsewhere herein.

### Bag Types

In some embodiments, a plurality of bags may be joined or connected together to form a bag assembly as described elsewhere herein. In some cases, the plurality of bags may comprise a luggage bag (e.g., a carry on luggage bag or a check in luggage bag). In some cases, the plurality of bags may comprise a travel bag for carrying items or equipment with an elongated form factor. In some cases, the plurality of bags may comprise a backpack, a duffel bag, a rolling duffel bag, a weekender bag, a Boston bag, a tote bag, or any other type of bag that can be configured or adapted to include a connector assembly that can be used to connect the bag to one or more other bags in the bag assembly.

Travel Bag with Landing Gear

In another aspect, the present disclosure provides various examples of a bag configured to (i) receive or hold one or more items or objects and (ii) protect the items or objects received or held within the bag as the bag and the one or more items or objects are being transported. In some cases, the one or more items or objects may have an elongated form factor. In some cases, the one or more items or objects may include a piece of equipment (e.g., sporting equipment). In some cases, the equipment may include, for example, a golf bag, one or more golf clubs, one or more golf balls, one or more golf shoes, golf apparel, golf gear, and/or one or more golf-related accessories. In some cases, the equipment may include one or more skis or boards, ski or snowboarding apparel, ski or snowboarding gear, and/or one or more ski or snowboarding-related accessories.

In some cases, the bag may be configured to transition between a plurality of different modes. In some cases, the plurality of different modes may include (1) a first mode in which a leg assembly of the bag is stored or nested within a protective cover of the bag. In some cases, the plurality of different modes may include (2) a second mode in which a leg assembly of the bag is deployed outwards to support the weight of the bag so that a subject can transport the bag in a tilted configuration. In some cases, the plurality of different modes may optionally include (3) a third mode in which a leg assembly of the bag is pivoted outwards and positioned along an upper portion of the bag to form an extended spine structure that is configured to strengthen and/or stiffen the upper portion of the bag.

### Examples

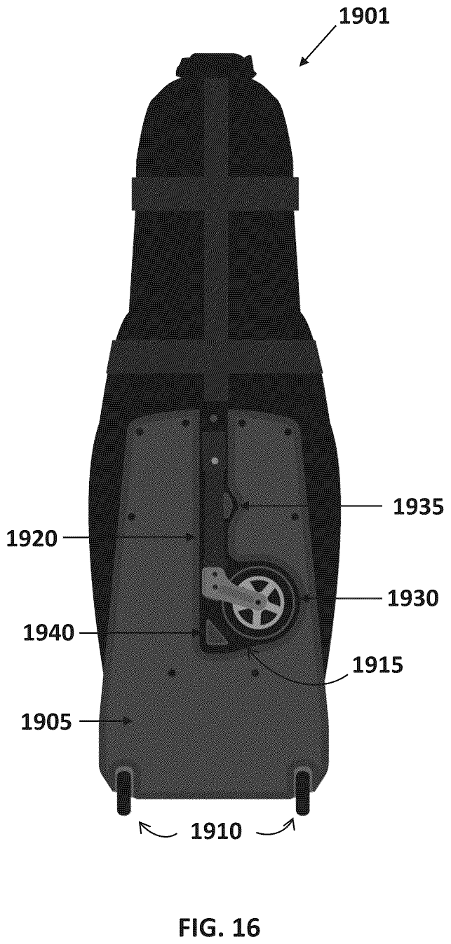

FIG. 16 schematically illustrates an example of a bag 1901 that can be used to hold and/or transport golf equipment. In some cases, the bag 1901 may comprise an elongated travel bag that can be used to transport one or more items or objects with an elongated form factor.

### Protective Cover

In some cases, the bag 1901 may comprise a protective cover 1905. In some cases, the protective cover 1905 may be configured as a shell that can protect one or more surfaces or edges of the bag from damage or wear.

In some cases, the protective cover 1905 may be configured to extend along a back side of the bag 1901. In some cases, the protective cover 1905 may be configured to extend across a portion or a section of the back surface area of the bag.

In some cases, the protective cover 1905 may be configured to extend downwards from an upper edge of the protective cover and curve around a rear bottom edge of the bag. In some cases, the protective cover 1905 may include a base section configured to extend forward from the rear bottom edge of the bag towards a front end of the bag. In some cases, the front end of the protective cover 1905 may be positioned adjacent to, alongside, or under the front bottom edge of the bag.

### Wheels/Rollers

In some cases, the bag 1901 may comprise one or more wheels or rollers 1910 integrated with the protective cover 1905 to enhance the transportability of the bag. In some cases, the one or more wheels or rollers 1910 may include a set of wheels or rollers disposed on or attached to the base section of the protective cover 1905. In some cases, the set of wheels or rollers may be used to roll the bag in a desired direction when the bag is in an upright configuration and/or when the bag is in a tilted configuration. In some cases, the set of wheels or rollers may be positioned along a bottom corner or edge of the base section of the protective cover so that the bag can be rolled in a desired direction when the bag is in either an upright configuration or a tilted configuration.

In some cases, the one or more wheels or rollers 1910 may have a fixed position and/or a fixed orientation relative to the base section of the protective cover. In other cases, the one or more wheels or rollers 1910 may be configured to swivel, pivot, and/or rotate to adjust a direction in which the bag can be rolled.

### Recessed Portion

In some cases, the protective cover may comprise a recessed portion 1915 formed along a back side of the protective cover. In some cases, the recessed portion 1915 may be configured to extend into the back side of the protective cover towards the back side of the bag.

In some cases, the recessed portion 1915 may be sized and shaped to receive and/or accommodate one or more other components or sub-assemblies of the bag. In some cases, the recessed portion 1915 may be configured to receive and/or accommodate a leg assembly of the bag.

### Leg Assembly

In some cases, the bag may comprise a leg assembly 1920. In some cases, the leg assembly 1920 may be deployed (e.g., using a spring-based deployment mechanism) and pivoted outwards to support the bag in a tilted configuration so that the bag can be transported in the tilted configuration. In some cases, the leg assembly 1920 may be retracted and positioned within the recessed portion 1915 of the protective cover 1905 so that the leg assembly can be stowed away when not in use.

### Leg Member

In some cases, the leg assembly 1920 may comprise a leg member. In some cases, the leg member may have a proximal end and a distal end opposite the proximal end. In some cases, the leg member may further comprise a body portion extending between the proximal end of the leg member and the distal end of the leg member.

### Degrees of Freedom (DOF)

In some cases, the leg assembly 1920 may have one or more degrees of freedom to enhance the mobility, flexibility, and overall utility of the leg assembly. In some cases, the leg assembly 1920 may have multiple degrees of freedom to further enhance the mobility, flexibility, and overall utility of the leg assembly. In some cases, the leg assembly 1920 may have at least two degrees of freedom. In some cases, the leg assembly may have three or more degrees of freedom.

First DOF—hinged connection

In some cases, the leg assembly 1920 may have a first degree of freedom. In some cases, the first degree of freedom may allow the leg assembly to pivot relative to the protective cover.

In some cases, the leg assembly 1920 may comprise a hinged connection coupling the proximal end of the leg member to the protective cover. In some cases, the hinged connection may be disposed within the recessed portion of the protective cover. In some cases, the hinged connection may be configured to provide the leg assembly 1920 with a first degree of freedom.

In some cases, the leg member may be configured to pivot about the hinged connection. In some cases, the hinged connection may allow the leg member to pivot between a plurality of different locked positions. In some cases, the plurality of different locked positions may include a first locked position in which the leg member is oriented at a first angle relative to the protective cover. In some cases, the plurality of different locked positions may include a second locked position in which the leg member is oriented at a second angle relative to the protective cover. In some cases, the first angle and the second angle may be different.

In some cases, the hinged connection may be configured to hold the leg member in a first locked position. In some cases, when the leg member is in the first locked position, the leg member may be angled outwards and away from the protective cover so that the leg member can support the bag when the bag is in a tilted configuration. In some cases, the leg member may be oriented at a first predetermined angle relative to the protective cover when the leg member is in the first locked position. In some cases, the first predetermined angle may range between about 30 degrees and about 120 degrees. In some cases, the first predetermined angle may be less than or equal to about 30 degrees. In some cases, the first predetermined angle may be greater than or equal to about 120 degrees.

In some cases, the hinged connection may be configured to hold the leg member in a second locked position that is different than the first locked position. In some cases, when the leg member is in the second locked position, the leg member may be positioned at least partially within the recessed region of the protective cover so that the leg member can be stowed away when not in use. In some cases, when the leg member is in the second locked position, the leg member may be positioned entirely within the recessed region of the protective cover. In some cases, when the leg member is in the second locked position, the leg member may be configured to lie flush with the back side of the protective cover.

### Second DOF—Rotational Coupling

In some cases, the leg assembly 1920 may have a second degree of freedom. In some cases, the second degree of freedom may allow the body portion of the leg member to rotate or swivel relative to the proximal end of the leg member.

In some cases, the body portion of the leg member may be configured to rotate or swivel relative to the proximal end of the leg member. In some cases, the body portion of the leg member may rotate or swivel relative to the proximal end of the leg member to change the position and/or the orientation of the body portion of the leg member and/or the distal end of the leg member relative to the proximal end of the leg member.

### Third DOF—Rotational Coupling

In some cases, the leg assembly 1920 may have a third degree of freedom. In some cases, the third degree of freedom may allow the distal end of the leg member to rotate and/or swivel relative to the body portion and/or the proximal end of the leg member.

In some cases, the distal end of the leg member may be rotatable relative to the body portion and/or the proximal end of the leg member. In some cases, the distal end of the leg member may be configured to rotate or swivel relative to the body portion and/or the proximal end of the leg member to change the orientation of the distal end of the leg member relative to the body portion and/or the proximal end of the leg member.

### Swivel Wheel

In some cases, the leg assembly may comprise an additional wheel 1930 provided on the distal end of the leg member. In some cases, the additional wheel 1930 may be rotatably coupled to the distal end of the leg member. In some cases, the additional wheel 1930 may be configured to rotate and/or swivel about the distal end of the leg member.

In some cases, the additional wheel 1930 may be configured to swivel between a first configuration and a second configuration. In some cases, the orientation of the rotational axis of the additional wheel may change as the additional wheel is swiveled between the first and second configurations. In some cases, when the additional wheel is in the first configuration, the rotational axis of the additional wheel may be oriented in a first direction. In some cases, when the additional wheel is in the second configuration, the rotational axis of the additional wheel may be oriented in a second direction that is different than the first direction.

In some cases, the additional wheel 1930 may be configured to rotate about a first axis when the additional wheel is in the first configuration. In some cases, the first axis may be parallel to a rotational axis of the one or more wheels or rollers integrated with the protective cover. In some cases, when the leg assembly is deployed and the additional wheel is placed in the first configuration, the additional wheel may be used in combination with the wheels or rollers integrated with the protective cover to transport the bag in a tilted configuration.

In some cases, the additional wheel 1930 may be configured to rotate about a second axis when the additional wheel is in the second configuration. In some cases, the second axis may be skewed relative to a rotational axis of the one or more wheels or rollers integrated with the protective cover. In some cases, when the leg assembly is retracted and the additional wheel is placed in the second configuration, the leg assembly and the additional wheel may be positionable within the recessed portion of the protective cover.

### Leg Member Release Mechanism

In some cases, the leg assembly may comprise a leg member release mechanism 1935. In some cases, the leg member release mechanism 1935 may be actuated to release the leg member from a locked position so that the leg member can pivot about the hinged connection coupling the leg member to the protective cover 1905.

### Foot Pedal

In some cases, the leg member release mechanism 1935 may comprise a foot pedal. In some cases, the foot pedal may be actuated to release the leg member from a locked position.

In some cases, when the foot pedal is actuated, the leg member may be released from a locked position so that the leg member can pivot in one or more directions. In some cases, when the foot pedal is actuated, the leg member may be pivotable in a first direction towards the recessed portion of the protective cover. In some cases, when the foot pedal is actuated, the leg member may be pivotable in a second direction away from the recessed portion of the protective cover.

### Foot Pedal Placement and Orientation

In some cases, the foot pedal may be positioned along a portion of the leg member that is easily accessible by a subject. In some cases, the foot pedal may be positioned so that a subject can use his or her foot to actuate the foot pedal to release the leg member from a locked position.

In some cases, the foot pedal may be oriented towards a subject maneuvering the bag. In some cases, the foot pedal may be provided along a side or a surface of the leg member that is oriented to face the subject.

In some cases, the relative position and the angular orientation of the foot pedal and the side or surface of the leg member with the foot pedal may change or vary as the leg member is pivoted about the hinged connection. In some cases, the relative position and the angular orientation of the foot pedal may be temporarily fixed or set when the leg member is in a locked position. In some cases, when the foot pedal is actuated, the leg member may be released and repositioned as needed, which may change the position and angular orientation of the foot pedal.

In some cases, the leg member may be deployed to support and/or transport the bag in a tilted configuration. In some cases, when the leg member is deployed to support and/or transport the bag in a tilted configuration, the foot pedal and the side or surface of the leg member with the foot pedal may be oriented towards the subject's body. In some cases, when the leg member is in a deployed position, the foot pedal and the side or surface of the leg member with the foot pedal may be oriented at an angle relative to the back side of the bag or the protective cover of the bag. In some cases, when the leg member is in a deployed position, the foot pedal and the side or surface of the leg member with the foot pedal may be oriented in a direction that is parallel or substantially parallel to a back side of the bag or the protective cover of the bag.

In some cases, the leg member may be deployed to form a protective spine along the back side of the bag, as described in further detail below. In some cases, when the leg member is deployed to form the protective spine, the foot pedal and the side or surface of the leg member with the foot pedal may be oriented towards the back side of the bag. In some cases, when the leg member is deployed to form the protective spine, the foot pedal and the side or surface of the leg member with the foot pedal may be oriented in a direction that is perpendicular or substantially perpendicular to the back side of the bag.

In some cases, the leg member may be positioned at least partially within the recessed region of the protective cover and stowed away when the leg member is not in use. In some cases, when the leg member is stowed away, the foot pedal and the side or surface of the leg member with the foot pedal may be oriented towards (i) the subject's body and away from a back wall of the recessed region. In other cases, when the leg member is stowed away, the foot pedal and the side or surface of the leg member with the foot pedal may be oriented towards (ii) one or more sidewalls of the recessed region. Alternatively, when the leg member is stowed away, the foot pedal and the side or surface of the leg member with the foot pedal may be oriented towards (iii) the back wall of the recessed region.

### Foot-Activated Release Mechanism

In some cases, the leg assembly may comprise a foot-activated release mechanism 1940. In some cases, the foot-activated release mechanism 1940 may be manipulated to release the leg assembly from the recessed portion 1915 of the protective cover 1905. In some cases, the foot-activated release mechanism 1940 may be manipulated to release the leg assembly from the recessed portion 1915 of the protective cover 1905 so that the leg assembly can be deployed to enhance the transportability of the bag. In other cases, the foot-activated release mechanism 1940 may be manipulated to release the leg assembly from the recessed portion 1915 of the protective cover 1905 so that the leg assembly can be deployed to protect the upper portion of the bag.

In some cases, the foot-activated release mechanism 1940 may be positioned so that a subject can easily access the foot-activated release mechanism. In some cases, the foot-activated release mechanism 1940 may be positioned so that a subject can use his or her foot to actuate the foot-activated release mechanism in order to release the leg member from the recessed portion of the protective cover.

In some cases, the foot-activated release mechanism 1940 may be provided within the recessed portion 1915 of the protective cover 1905. In some cases, the foot-activated release mechanism 1940 may be provided along a back wall of the recessed portion 1915 of the protective cover 1905. In other cases, the foot-activated release mechanism 1940 may be provided along one or more sidewalls of the recessed portion 1915 of the protective cover 1905.

In some cases, the foot-activated release mechanism may be provided along a side or a surface of the leg member of the leg assembly. In some cases, the foot-activated release mechanism may be provided along a same side or surface of the leg member as the leg member release mechanism of the leg assembly. In other cases, the foot-activated release mechanism may be provided along a different side or surface of the leg member than the leg member release mechanism of the leg assembly.

### Cover

In some cases, the bag may comprise a cover that is attachable or securable along a back side or surface of the protective cover of the bag. In some cases, the cover may be positionable around, across, and/or over the recessed portion of the protective cover. In some cases, the cover may be used to cover (i) the recessed portion of the protective cover and/or (ii) any components, assemblies, or sub-assemblies that are positioned or located within the recessed portion of the protective cover.

In some cases, the cover may comprise a separate component from the protective cover of the bag. In some cases, the separate component may be fully separated from or fully separable from the protective cover of the bag so that a subject can access the recessed portion of the protective cover. In some cases, the separate component may be reattached to the protective cover and repositioned around, across, and/or over the recessed portion of the protective cover to cover the recessed portion of the protective cover and/or any other components, assemblies, or sub-assemblies positioned or located within the recessed portion of the protective cover.

In some cases, the cover may be integrated with or integrally formed with the protective cover of the bag. In such cases, at least a portion of the cover may be attached or coupled to the protective cover of the bag. In some cases, at least a portion of the cover may be undetachably coupled to the protective cover of the bag such that the cover may not or need not be fully separated or detached from the protective cover of the bag. In some cases, at least a portion of the cover may be undetachably coupled to the protective cover of the bag such that the cover may not or need not be fully separable or detachable from the protective cover of the bag.

In some cases, the cover may be attached or coupled to the protective cover of the bag. In some cases, a portion of the cover may be releasably attached or detachably coupled to the protective cover of the bag. In other cases, a portion of the cover may be undetachably fixed or permanently coupled to the protective cover of the bag.

In some cases, a portion of the cover may be undetachably fixed or coupled to the protective cover of the bag, even if another portion of the cover is detachable or separable from the protective cover to allow a subject to access the recessed portion of the protective cover. In some cases, a portion of the cover may be detachable or separable from the protective cover to allow a subject to access the recessed portion of the protective cover, even if another portion of the cover remains undetachably fixed or permanently coupled to the protective cover.

### Fasteners

In some cases, one or more fasteners may be used to attach the cover to the protective cover. In some cases, the one or more fasteners may include any of the fasteners disclosed herein, and/or any combinations or sub-combinations thereof.

In some cases, the one or more fasteners may include one or more coupling elements configured to provide one or more degrees of freedom between the cover and the protective cover. In some cases, the one or more degrees of freedom may allow a movement of the cover relative to the protective cover. In some cases, the movement may include one or more translational movements and/or one or more rotational movements.

In some cases, the cover may be attached or secured to the protective cover without using any fasteners. In some cases, the cover may be sized and shaped to engage one or more surface features of the protective cover. In some cases, the cover may be configured to snap fit into or onto the protective cover without requiring any other fastening or coupling elements.

### Cover Material

In some cases, the cover may comprise a panel or a layer of material. In some cases, the panel or layer of material may comprise a same material or a same type of material as the protective cover of the bag. In other cases, the panel or layer of material may comprise a different material or a different type of material than the protective cover of the bag.

In some cases, the panel or layer of material may comprise a hard, rigid, and/or semi-rigid material. In other cases, the panel or layer of material may comprise a soft or flexible material.

In some cases, the panel or layer of material may comprise a plastic material or a thermoplastic material. In some cases, the panel or layer of material may comprise a composite material. In some cases, the panel or layer of material may comprise a metallic or intermetallic material. In some cases, the panel or layer of material may comprise a fabric or textile material.

### Aperture/Window

In some cases, the cover may comprise one or more apertures or windows extending through the cover. In some cases, the one or more apertures or windows may be configured to provide an opening to the recessed portion of the protective cover when the cover is positioned around, across, and/or over the recessed portion of the protective cover. In some cases, the opening may be configured to provide access to a foot-activated release mechanism positioned or located within the recessed portion of the protective cover.

### Example #1

In some cases, the cover may be configured to cover the recessed portion of the protective cover after the leg assembly is retracted and positioned at least partially within the recessed portion of the protective cover. In some cases, the cover may be configured to hide or conceal the leg assembly when the leg assembly is not in use in order to preserve the aesthetic profile of the bag. In some cases, the cover may be configured to prevent debris, external objects, and/or moisture from entering into and collecting within the recessed portion of the protective cover. In some cases, the cover may be configured to prevent debris, external objects, and/or moisture from contacting or potentially damaging the leg assembly or the leg member release mechanism when the leg assembly is stored within the recessed portion of the protective cover. In some cases, the cover may be configured to prevent debris, external objects, and/or moisture from contacting or potentially damaging the foot-activated release mechanism.

In some cases, when the leg assembly is positioned within the recessed portion of the protective cover, the cover may be placed over the recessed portion of the protective cover to hide or conceal the leg assembly. In some cases, when the leg assembly is positioned within the recessed portion of the protective cover, the cover may be placed over the recessed portion of the protective cover to prevent debris, external objects, and/or moisture from entering into and collecting within the recessed portion of the protective cover. In some cases, when the leg assembly is positioned within the recessed portion of the protective cover, the cover may be placed over the recessed portion of the protective cover to prevent debris, external objects, and/or moisture from contacting or potentially damaging the leg assembly or the leg member release mechanism. In some cases, when the leg assembly is positioned within the recessed portion of the protective cover, the cover may be placed over the recessed portion of the protective cover to prevent debris, external objects, and/or moisture from contacting or potentially damaging the foot-activated release mechanism.

### Example #2

In some cases, the cover may be configured to cover the recessed portion of the protective cover after the leg assembly is removed from the recessed portion of the protective cover and deployed outwards. In some cases, the cover may be configured to prevent debris, external objects, and/or moisture from entering into and collecting within the recessed portion of the protective cover while the leg assembly is in use. In some cases, the cover may be configured to prevent debris, external objects, and/or moisture from contacting or potentially damaging the foot-activated release mechanism.

In some cases, when the leg assembly is deployed outwards from the recessed portion of the protective cover, the cover may be placed over the recessed portion of the protective cover to prevent debris, external objects, and/or moisture from entering into and collecting within the recessed portion of the protective cover. In some cases, when the leg assembly is deployed outwards from the recessed portion of the protective cover, the cover may be placed over the recessed portion of the protective cover to prevent debris, external objects, and/or moisture from contacting or potentially damaging the foot-activated release mechanism.

### Example #3

In some cases, at least a portion of the cover may be removed, detached, or separated from the protective cover so that the leg assembly can be accessed and deployed outwards from the recessed portion of the protective cover. In some cases, when the leg assembly is positioned within the recessed portion of the protective cover, the cover (or a portion thereof) may be removed, detached, or separated from the protective cover so that a subject can access the leg assembly and deploy the leg assembly outwards from the recessed portion of the protective cover.

### Example #4

In some cases, at least a portion of the cover may be removed, detached, or separated from the protective cover so that the leg assembly can be repositioned or stored within the recessed portion of the protective cover. In some cases, when the leg assembly is deployed outwards from the recessed portion of the protective cover, the cover (or a portion thereof) may be removed, detached, or separated from the protective cover so that a subject can access the recessed portion of the protective cover and retract the leg assembly back into the recessed portion of the protective cover to stow away the leg assembly.

### Reattachment and Storage of Cover

In some cases, after the cover is removed, detached, or separated from the protective cover, the cover may be reattached to the protective cover. In some cases, the cover may be reattached around, across, and/or over the recessed portion of the protective cover. In other cases, the cover may be reattached to another portion of the protective cover or attached to another part of the bag.

In some optional cases, after the cover is removed, detached, or separated from the protective cover, the cover may be stored within the recessed portion of the protective cover. In other cases, after the cover is removed, detached, or separated from the protective cover, the cover may be stored within another portion of the protective cover or another part of the bag.

### Manual Operation

In some cases, the cover may be manually deployed by the subject to cover the recessed portion of the protective cover and/or any components, assemblies, or sub-assemblies positioned or located within the recessed portion of the protective cover. In some cases, the cover may be manually detached from the protective cover so that the subject can access the recessed portion of the protective cover and/or any components, assemblies, or sub-assemblies positioned or located within the recessed portion of the protective cover.

### Automatic Operation

In some cases, the cover may be configured to automatically deploy to cover the recessed portion of the protective cover and/or any components, assemblies, or sub-assemblies positioned or located within the recessed portion of the protective cover. In some cases, the cover may be configured to automatically deploy as the leg assembly is being moved towards or into the recessed portion of the protective cover. In some cases, the cover may be configured to automatically deploy when the leg assembly is positioned at least partially within the recessed portion of the protective cover or within a predetermined angular range of the recessed portion of the protective cover. In some cases, the cover may be configured to automatically deploy as the leg assembly is being deployed outwards from the recessed portion of the protective cover. In some cases, the cover may be configured to automatically deploy after the leg assembly is deployed outwards from the recessed portion of the protective cover past a certain predetermined angular range.

In some cases, at least a portion of the cover may be configured to automatically detach or separate away from the recessed portion of the protective cover so that a subject can access the recessed portion of the protective cover and/or any components, assemblies, or sub-assemblies positioned or located within the recessed portion of the protective cover. In some cases, the cover may be configured to automatically detach or separate away from the recessed portion of the protective cover as the leg assembly is being moved towards the recessed portion of the protective cover. Alternatively or additionally, the cover may be configured to automatically detach or separate away from the recessed portion of the protective cover as the leg assembly is being deployed outwards from the recessed portion of the protective cover.

### Cover Movement

In some cases, the cover may be configured to undergo one or more movements relative to the protective cover. In some comes, the one or more movements may include one or more translational movements and/or one or more rotational movements.

In some cases, a first set of translational and/or rotational movements may be executed to position the cover around, across, and/or over the recessed portion of the protective cover. In some cases, a second set of translational and/or rotational movements may be executed to uncover the recessed portion of the protective cover so that a subject can access the recessed portion of the protective cover and/or any components, assemblies, or sub-assemblies positioned or located within the recessed portion of the protective cover.

In some cases, the first and second sets of translational and/or rotational movements may involve one or more same or similar types of movements. In other cases, the first and second sets of translational and/or rotational movements may involve two or more different types of movements.

### Tripod Configuration

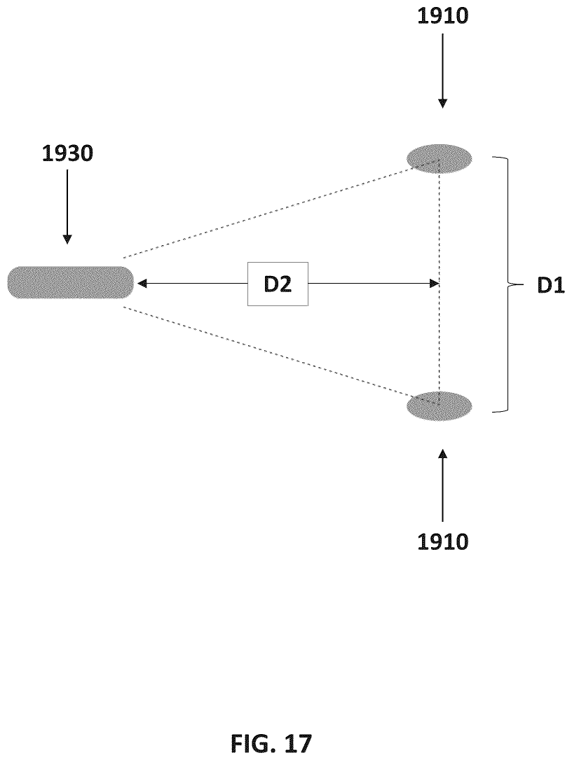

As shown in FIG. 17, in some cases, when the leg assembly is deployed, the additional wheel 1930 and the one or more wheels or rollers 1910 may form a tripod configuration. In some cases, the tripod configuration may be configured to stabilize the bag when the bag is tilted so that the bag can be easily transported around in a tilted configuration. In some cases, the additional wheel 1930 may be configured as a front wheel of the tripod configuration and the one or more wheels or roller 1910 may be configured as the rear wheels of the tripod configuration. In other cases, the additional wheel 1930 may be configured as the rear wheel of the tripod configuration and the one or more wheels or roller 1910 may be configured as the front wheels of the tripod configuration.

In some cases, the one or more wheels or rollers 1910 may include a set of wheels or rollers that are spaced apart by a first distance D1. In some cases, the first distance D1 may be fixed. In some cases, the additional wheel 1930 may be spaced apart from the one or more wheels or rollers 1910 by a second distance D2. In some cases, the second distance D2 may be adjustable by pivoting the leg assembly as described elsewhere herein.

### Leg Assembly Operation

In some cases, the leg assembly 1920 may be movable between (i) a retracted position in which at least a portion of the leg assembly 1920 is positioned within the recessed portion of the protective cover and (ii) one or more extended positions in which at least a portion of the leg assembly 1920 is positioned outside of the recessed portion of the protective cover. In some cases, when the leg assembly 1920 is in the retracted position (e.g., as shown in FIG. 16), a subject may actuate the foot-activated release mechanism 1940 using his or her foot to release the leg assembly 1920 from the recessed portion 1915 of the protective cover 1905.

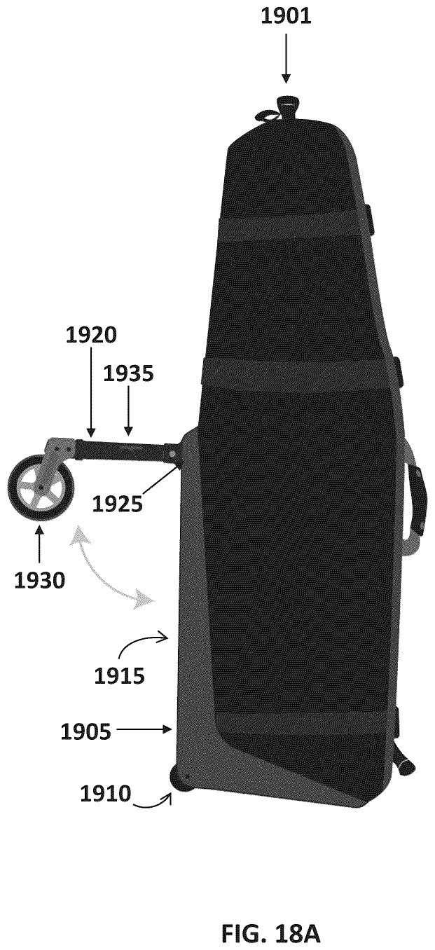

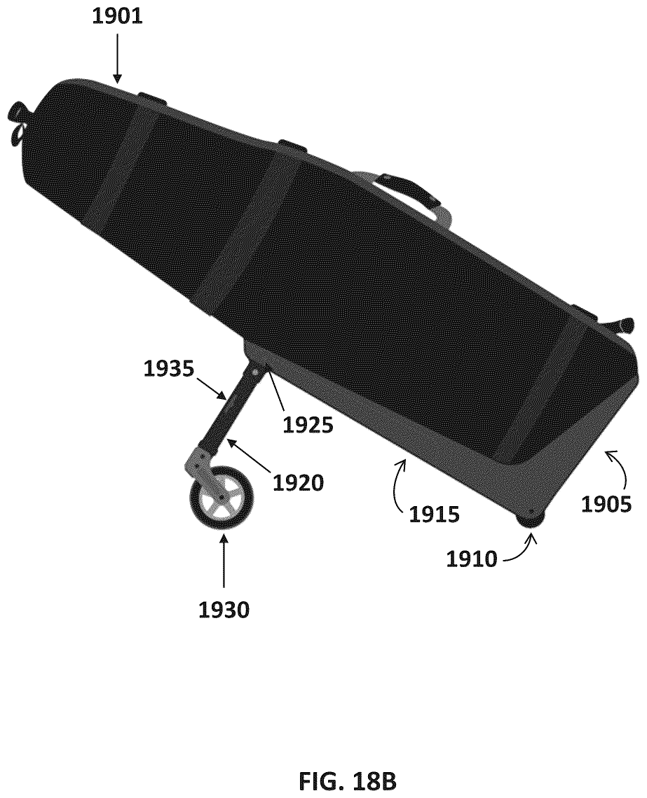

Referring now to FIG. 18A, once the leg assembly 1920 is released from the recessed portion 1915 of the protective cover 1905, the subject may pivot the leg member of the leg assembly 1920 about a hinged connection 1925 to a desired angular orientation. In some cases, when the leg member is pivoted out of the recessed portion 1915 of the protective cover 1905, the leg member may be in an extended position. In some cases, when the leg member is in an extended position, the leg member may be set at a desired angular orientation and the hinged connection 1925 may be locked in place to form the tripod configuration described herein.

In some cases, the extended leg member may be movable between multiple different locked positions each configured to set the leg member at a different angular orientation. In some cases, the one or more locked positions may be preset or user-determined. In some cases, moving the leg member between the different locked positions may change or vary the tilt angle of the bag when the bag is placed in the tripod configuration. In some cases, moving the leg member between the different locked positions may also change or vary the position and the orientation of the leg member release mechanism 1935 provided along a side or surface of the leg member.

As shown in FIG. 18B, once the leg member is pivoted to the desired angular orientation, the bag 1901 may be tilted so that the bag is supported by (i) the one or more wheels or rollers 1910 integrated with the protective cover 1905 and (ii) an additional wheel 1930 provided on the distal end of the leg member. In some cases, the bag 1901 may be in a tripod configuration when the bag is tilted and supported by (i) the one or more wheels or rollers 1910 integrated with the protective cover 1905 and (ii) the additional wheel 1930 provided on the distal end of the leg member. In some cases, the bag 1901 may be transported across a ground surface from a first location to a second location while the bag is in the tripod configuration.

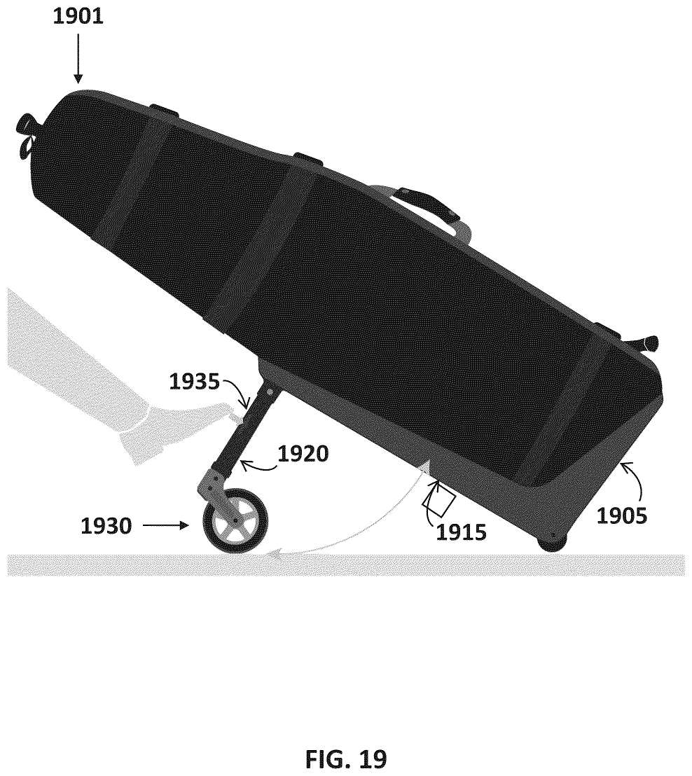

Referring now to FIG. 19, when a subject wishes to stow away the leg assembly 1920, the subject may actuate the leg member release mechanism 1935 with his or her foot to release the leg member from a locked position. Once the leg member is released from the locked position, the leg member may be pivoted back towards the recessed portion 1915 of the protective cover 1905 and positioned at least partially within the recessed portion 1915 of the protective cover 1905. In some cases, when the leg member is positioned at least partially within the recessed portion 1915 of the protective cover 1905, the leg member may be in the retracted position.

### Spine Extension

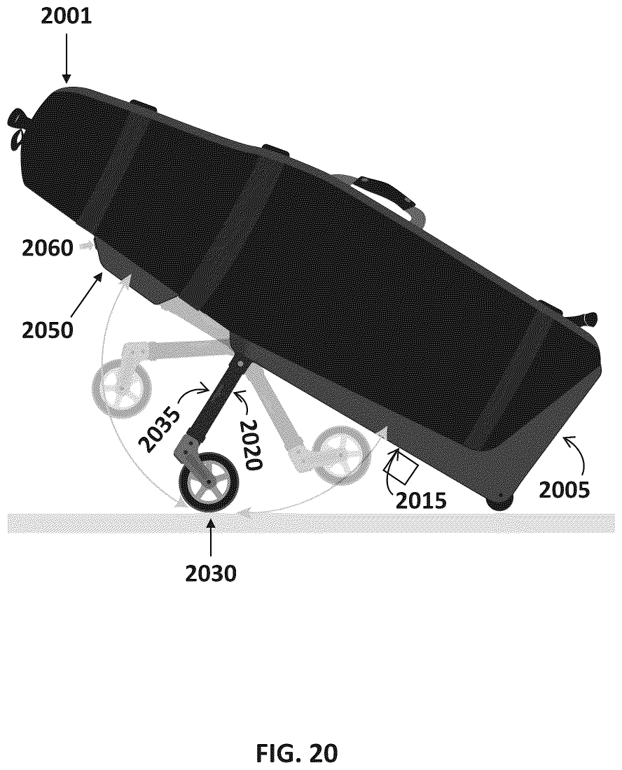

Referring now to FIG. 20, in some cases, the bags described herein may comprise a bag 2001 with a leg assembly 2020 having an extended range of motion. In some cases, the leg assembly 2020 with the extended range of motion may be configured to pivot beyond an upper edge of a protective cover 2005 of the bag 2001 by moving through a gap or a spacing provided along the upper edge of the protective cover 2005 of the bag 2001. In some cases, the leg assembly 2020 may be configured to pivot through the gap or spacing towards the upper portion(s) of the bag 2001.

In some cases, the leg assembly 2020 with the extended range of motion may be positionable along the upper portion of the bag 2001. In some cases, when the leg assembly 2020 is fully extended along the upper portion of the bag 2001, the leg assembly 2020 may be configured as a rigid support that can strengthen and/or stiffen the upper portion of the bag 2001. In some cases, when the leg assembly 2020 is fully extended along the upper portion of the bag 2001, the leg assembly 2020 may be configured to strengthen and/or stiffen the parts of the bag that are not directly supported by the protective cover 2005 of the bag.

### Leg Member Receiving Structure

In some cases, the bag may comprise a leg member receiving structure 2050 provided along an upper portion of the back side of the bag. In some cases, the leg member receiving structure 2050 may be configured to receive the leg member when the leg member is pivoted beyond the upper edge of the protective cover and positioned along the upper portion of the back side of the bag. In some cases, the leg member may be configured to lock into the leg member receiving structure 2050 to form a protective spine along the back side of the bag body.

In some cases, the leg member receiving structure 2050 may comprise a leg member release mechanism 2060 configured to release the leg member from the leg member receiving structure. In some cases, when the leg member release mechanism 2060 is actuated by the subject, the leg member may be released from the leg member receiving structure 2050 so that the leg member can be pivoted back downwards to (i) one or more other extended positions and/or (ii) a retracted position.

### Leg Assembly Operation—Extended Range of Motion

In some cases, the leg assembly 2020 may be movable between (i) a retracted position in which at least a portion of the leg assembly 2020 is positioned within the recessed portion 2015 of the protective cover 2005 and (ii) one or more extended positions in which at least a portion of the leg assembly 2020 is positioned outside of the recessed portion 2015 of the protective cover 2005. In some cases, when the leg assembly 2020 is in the retracted position, a subject may actuate a foot-activated release mechanism using his or her foot to release the leg member from the recessed portion 2015 of the protective cover 2005. Once the leg assembly 2020 is released from the recessed portion 2015 of the protective cover 2005, the subject may pivot the leg member to a desired angular orientation as described elsewhere herein.

In some cases, the extended leg member may be movable between multiple different locked positions each configured to set the leg member at a different angular orientation. In some cases, the one or more locked positions may be preset or user-determined. In some cases, moving the leg member between the different locked positions may change or vary the tilt angle of the bag. In some cases, moving the leg member between the different locked positions may also change or vary the position and the orientation of the leg member release mechanism 2035 provided along a side or surface of the leg member.

In some cases, when a subject wishes to fully extend the leg assembly 2020 towards the top of the bag, the subject may pivot the leg member of the leg assembly past the upper edge of the protective cover 2005. In some cases, after the subject pivots the leg member past the upper edge of the protective cover 2005, the leg member may be positionable along the back side of the bag. In some cases, a leg member receiving structure 2050 may be provided along the back side of the bag. In some cases, the leg member receiving structure 2050 may be configured to (i) receive the leg member and/or an additional wheel 2030 provided on the distal end of the leg member and (ii) lock the leg member and/or the additional wheel 2030 in place so that the leg assembly 2020 forms a rigid support that can strengthen and/or stiffen the back side of the bag.

In some cases, when a subject wishes to stow away the leg assembly 2020, the subject may actuate a leg member release mechanism 2060 to release the leg member from the leg member receiving structure 2050. Once the leg member is released from the leg member receiving structure 2050, the leg member may be pivoted back towards the recessed portion 2015 of the protective cover 2005 and positioned at least partially within the recessed portion 2015 of the protective cover 2005. In some cases, when the leg member is positioned at least partially within the recessed portion 2015 of the protective cover 2005, the leg member may be in the retracted position.

### System

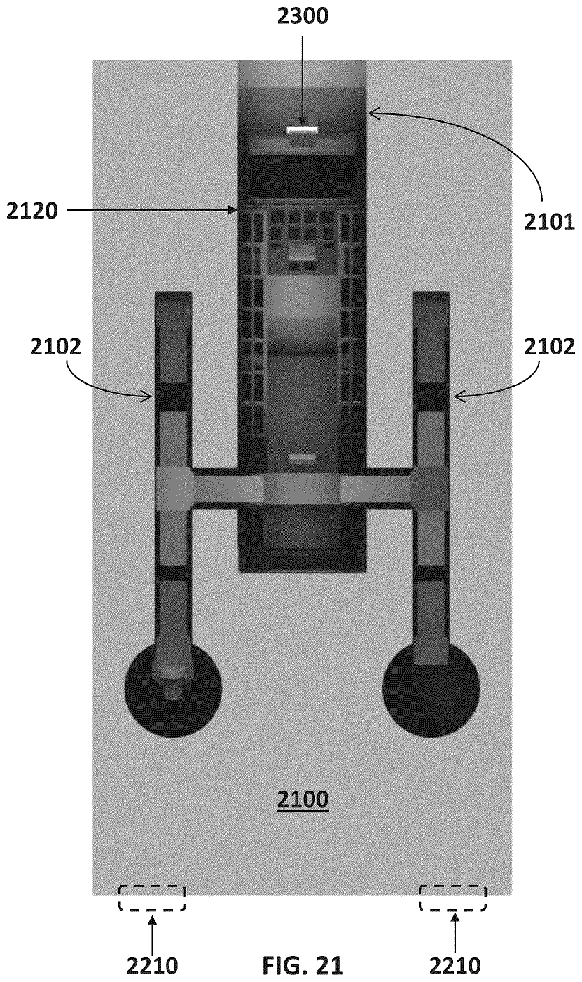

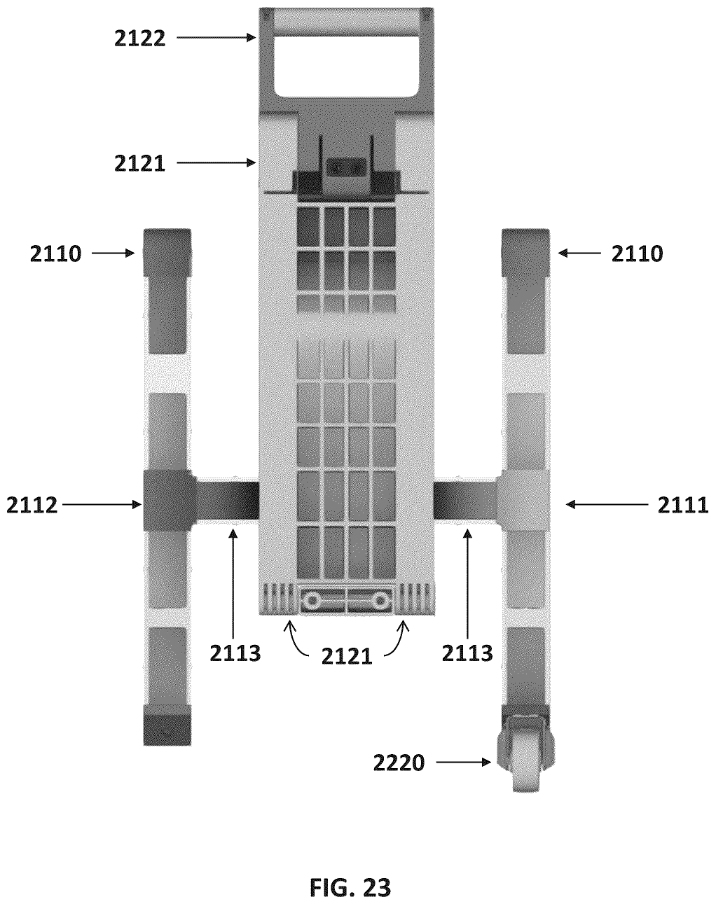

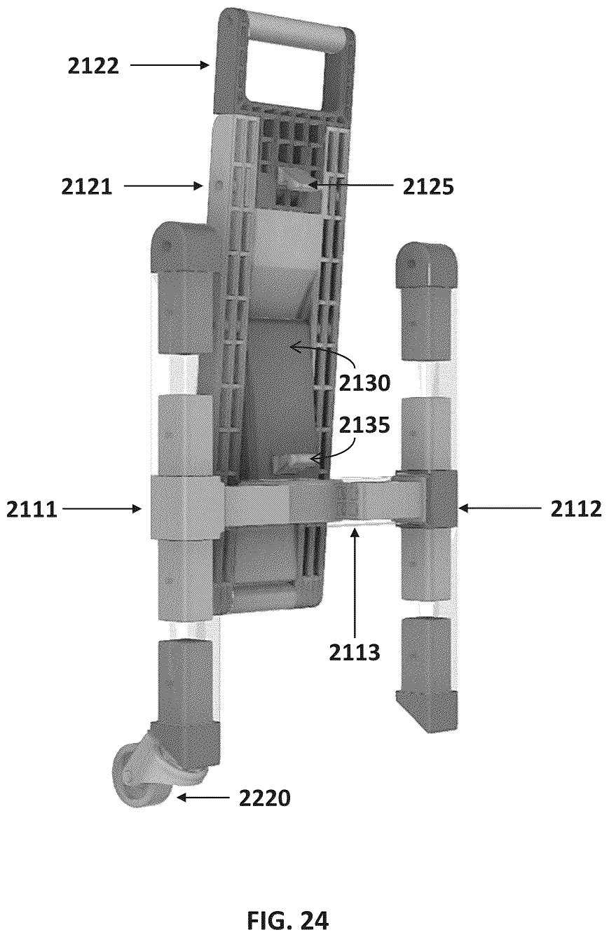

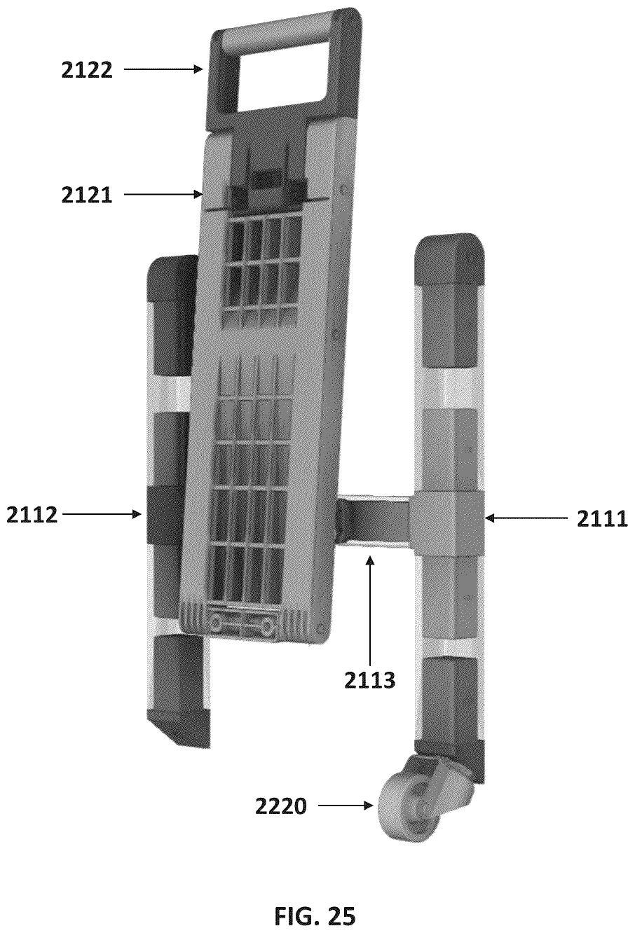

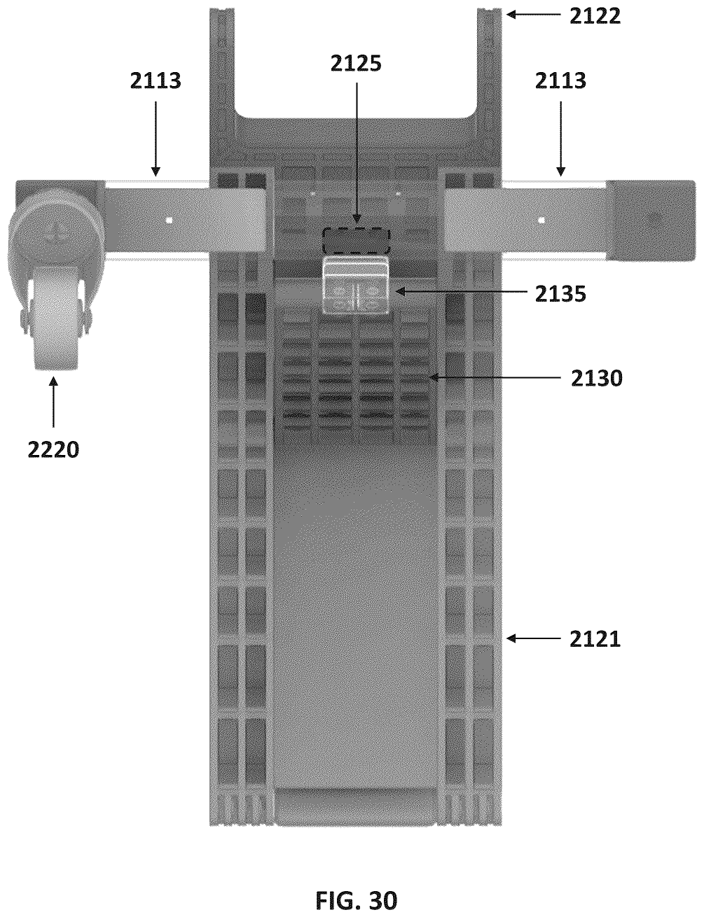

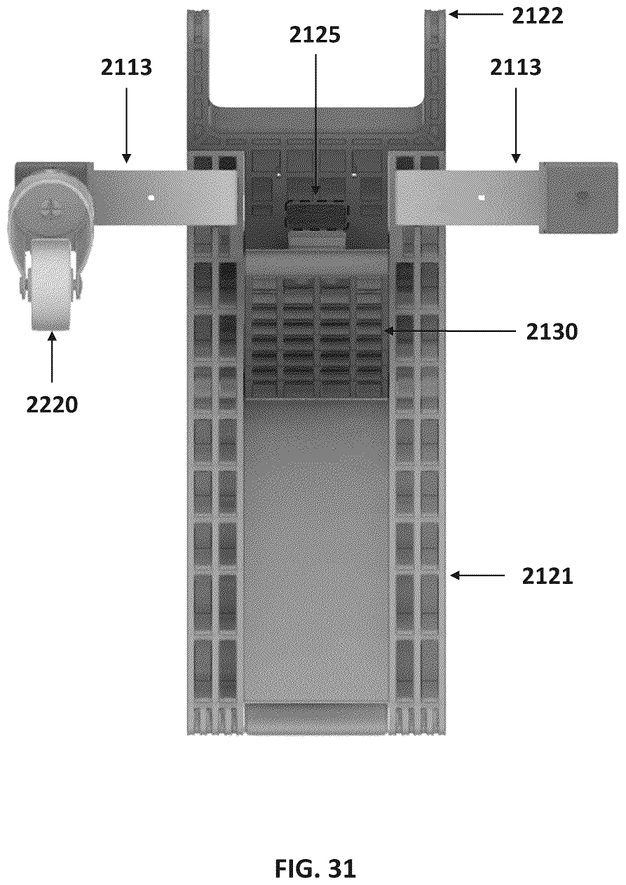

FIGS. 21-36 schematically illustrate a system that can be used to facilitate the handling, maneuvering, movement, and/or transportation of any of the bags disclosed herein. In some cases, the system may be used to adjust the positioning and/or the orientation of any bag relative to the ground surface so that the bag can be placed in different configurations as needed, including e.g., an upright configuration or a tilted configuration as described elsewhere herein. In some cases, the system may be used to reconfigure any bag for different applications, use cases, or scenarios. In some cases, the system may be used to reconfigure the bag for different modes of transport and/or different forms of transport.

In some cases, the system may be configured to reorient the bag from an upright configuration to a tilted configuration so that the bag can be kept, stored, moved, or transported in the tilted configuration. In some cases, the system may be configured to reorient the bag from the tilted configuration to the upright configuration so that the bag can be kept, stored, moved, or transported in the upright configuration. In some cases, the system may be configured to reorient the bag from a first tilted configuration to a second tilted configuration in order to adjust the height of the bag and/or the angular orientation of the bag relative to the ground surface.

### Shell

Referring to FIG. 21, in some cases, the system may be attached to or integrated with a shell 2100. In some cases, the shell 2100 may comprise a cover that can be attached or coupled to any of the bags disclosed herein to protect one or more sides, surfaces, and/or edges of the bags from damage or wear. The shell 2100 may comprise any of the shells or protective covers described elsewhere herein.

In some cases, the shell 2100 may comprise a first side and a second side opposite the first side. In some cases, the first side of the shell 2100 may be configured to face a back side or surface of the body of the bag. In some cases, the second side of the shell 2100 may be configured to face the system. In some cases, the first and second sides of the shell 2100 may be disposed between the system and the back side or surface of the body of the bag.

In some cases, the shell 2100 may extend along a back side or surface of the bag. In some cases, the shell 2100 may extend along a portion of the left side and/or the right side of the bag. In some cases, the shell 2100 may extend downwards from an upper edge of the shell and wrap around a rear bottom edge of the bag. In some cases, the shell 2100 may extend around a back left side edge and/or a back right side edge of the bag.

In some cases, the shell 2100 may include a base section that extends from the rear bottom edge of the bag towards a front end of the bag. In some cases, the base section of the shell 2100 may be configured to extend under a bottom of the bag.

### Wheels/Rollers

In some cases, the bags disclosed herein may comprise one or more wheels or rollers. In some cases, the one or more wheels or rollers may comprise a first set of wheels or rollers 2210. The first set of wheels or rollers 2210 may comprise any of the wheels or rollers described elsewhere herein.

In some cases, the first set of wheels or rollers 2210 may be attached or coupled to the base section of the shell. In some cases, the first set of wheels or rollers 2210 may be disposed along a rear bottom edge of the bag or the shell.

### Recessed Regions

In some cases, the shell 2100 may comprise one or more recessed regions. In some cases, the one or more recessed regions may be configured to receive the system or any components or sub-assemblies thereof.

In some cases, the one or more recessed regions may comprise a central recessed region 2101. In some cases, the central recessed region 2101 may be configured to receive a handle mechanism of the system.

In some cases, the one or more recessed regions may comprise a plurality of recessed regions 2102. In some cases, the plurality of recessed regions 2102 may be disposed alongside or adjacent to the central recessed region. In some cases, the plurality of recessed regions 2102 may be disposed on different sides of the central recessed region 2101. In some cases, the plurality of recessed regions 2102 may be configured to receive one or more legs associated with a leg mechanism of the system.

In some cases, the one or more recessed regions may comprise at least one recessed region. In some cases, the at least one recessed region may be configured to extend laterally between the plurality of recessed regions. In some cases, the at least one recessed region may be configured to extend laterally between the central recessed region and one or more of the plurality of recessed regions. In some cases, the at least one recessed region may be configured to receive a cross member of the leg mechanism.

### Recess Sizing

In some cases, the central recessed region, the plurality of recessed regions, and the at least one recessed region may have different lengths, widths, and/or depths. In some cases, the central recessed region may have a greater length, width, and/or depth than the plurality of recessed regions and/or the at least one recessed region. In some cases, the plurality of recessed regions may have a greater length, width, and/or depth than the central recessed region and/or the at least one recessed region. In some cases, the at least one recessed region may have a greater length, width, and/or depth than the central recessed region and/or the plurality of recessed regions.

### Recess Placement

In some cases, an upper edge of the central recessed region may be disposed along an upper edge of the shell. In some cases, an upper edge of the plurality of recessed regions may be spaced apart from the upper edge of the shell. In some cases, an upper edge of the at least one recessed region may be spaced apart from the upper edge of the shell.

In some cases, the upper edge of the central recessed region may be a first distance from the upper edge of the shell. In some cases, the upper edge of the plurality of recessed regions may be a second distance from the upper edge of the shell. In some cases, the upper edge of the at least one recessed region may be a third distance from the upper edge of the shell.

In some cases, a left/right side edge of the central recessed region may be a first distance from a medial side edge or a lateral side edge of the shell. In some cases, a left/right side edge of the plurality of recessed regions may be a second distance from the medial side edge or the lateral side edge of the shell. In some cases, a left/right side edge of the at least one recessed region may be a third distance from the medial side edge or the lateral side edge of the shell.

In some cases, a bottom or lower edge of the central recessed region may be a first distance from the bottom or lower edge of the shell. In some cases, a bottom or lower edge of the plurality of recessed regions may be a second distance from the bottom or lower edge of the shell. In some cases, a bottom or lower edge of the at least one recessed region may be a third distance from the bottom or lower edge of the shell.

In some cases, the first distance may be equal to the second distance and/or the third distance. In some cases, the second distance may be equal to the first distance and/or the third distance. In some cases, the third distance may be equal to the first distance and/or the second distance.

In some cases, the first distance may be different than the second distance and/or the third distance. In some cases, the second distance may be different than the first distance and/or the third distance. In some cases, the third distance may be different than the first distance and/or the second distance. In some cases, the first distance may be greater than the second distance and/or the third distance. In other cases, the first distance may be less than the second distance and/or the third distance. In some cases, the second distance may be greater than the first distance and/or the third distance. In other cases, the second distance may be less than the first distance and/or the third distance. In some cases, the third distance may be greater than the first distance and/or the second distance. In other cases, the third distance may be less than the first distance and/or the second distance.

### Leg Mechanism

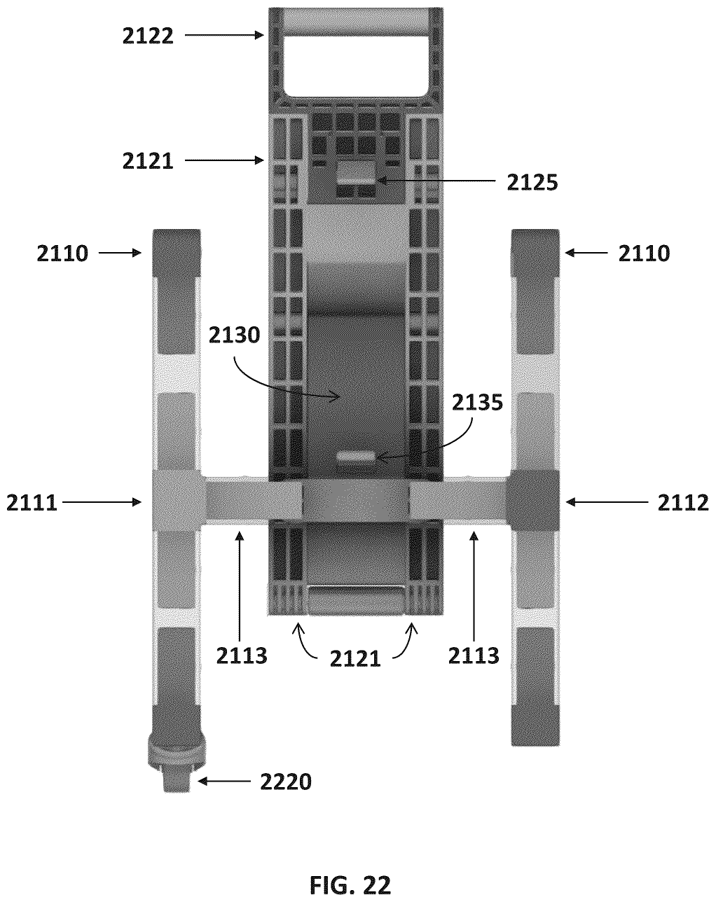

Referring to FIGS. 22-25, in some cases, the system may comprise a leg assembly. In some cases, the leg assembly may comprise a leg mechanism 2110. In some cases, the leg mechanism 2110 may comprise a plurality of legs. In some cases, the plurality of legs may comprise a first leg 2111 and a second leg 2112.

In some cases, the first leg 2111 may be pivotably coupled to a first portion of the shell 2100, and the second leg 2112 may be pivotably coupled to a second portion of the shell 2100. In some cases, the first portion of the shell and the second portion of the shell may be spaced apart by a separation distance. In some cases, the first portion of the shell and the second portion of the shell may be spaced apart from a lateral or medial side of the shell by a first offset distance.

In some cases, the plurality of legs may be pivotable between two or more different positions. In some cases, the plurality of legs may be pivotable between (i) a retracted position in which the legs are positioned entirely within the plurality of recessed regions and (ii) an extended position in which one or more end portions of the plurality of legs are positioned outside of the plurality of recessed regions. In some cases, the plurality of legs may be pivotable between (i) a first extended position in which the legs are extended outwards from the plurality of recessed regions at a first angular orientation relative to the shell and (ii) a second extended position in which the legs are extended outwards from the plurality of recessed regions at a second angular orientation relative to the shell.

### Second Set of Wheels/Rollers

In some cases, the leg mechanism may further comprise one or more wheels or rollers disposed on one or more end portions of the first leg 2111 and/or the second leg 2112. In some cases, the one or more wheels or rollers may include a second set of wheels or rollers 2220 that can help to support the weight of the bag when the bag is in a tilted configuration. In some cases, the first set of wheels or rollers and the second set of wheels or rollers may be used to move or transport the bag while the bag is in the tilted configuration.

### Cross Member

In some cases, the leg mechanism may comprise a cross member 2113. In some cases, the cross member 2113 may be configured to extend laterally between the first leg 2111 and the second leg 2112. In some cases, the cross member 2113 may have a first end attached or coupled to the first leg 2111 and a second end attached or coupled to the second leg 2112.

In some cases, the cross member 2113 may be directly attached or coupled to a handle mechanism. In some cases, the cross member 2113 may be indirectly attached or coupled to the handle mechanism. In some cases, the cross member 2113 may be pivotably coupled to the handle mechanism.

In some cases, a connector piece may be used to couple the cross member 2113 to a portion of the handle mechanism. In some cases, the connector piece may be configured to provide or establish a rotational coupling between the cross member 2113 and a portion of the handle mechanism so that the cross member 2113 can pivot relative to the handle mechanism (or vice versa).

In some cases, the cross member 2113 may be configured to support one or more other components of the system. For example, in some cases, when the handle mechanism of the system is pulled downwards to deploy the leg mechanism outwards, the handle mechanism may be fully extended so that the first handle portion 2121 of the handle mechanism is positioned over the cross member 2113. In such cases, the cross member 2113 may be configured to support the handle mechanism while the handle mechanism is fully extended.

In some cases, the cross member 2113 may also be configured to prevent the over-rotation of the handle mechanism or the over-extension of the leg mechanism. For example, in some cases, when the handle mechanism of the system is pulled downwards to deploy the leg mechanism outwards, the cross member 2113 may be positioned to limit the angular range of motion of the handle mechanism so that the handle mechanism can only pivot to a certain threshold/maximum angle of rotation. In such cases, the extension of the leg mechanism may also be limited to a corresponding threshold/maximum angle of rotation so that the leg mechanism can only extend and pivot outwards to a certain point.

### Handle Mechanism

In some cases, the system may comprise a handle mechanism 2120. In some cases, the handle mechanism 2120 may comprise a first handle portion 2121 with a first end pivotably coupled to the shell 2100. In some cases, the handle mechanism 2120 may comprise a second handle portion 2122 pivotably coupled to a second end of the first handle portion 2121.

In some cases, the handle mechanism may comprise a spring element. In some cases, the spring element may be connected to the first handle portion 2121 and the second handle portion 2122 to form a spring-loaded pivot joint between the first and second handle portions. In some cases, the first handle portion 2121 and the second handle portion 2122 may be configured to pivot about the spring-loaded pivot joint.

In some cases, the spring-loaded pivot joint may be configured to provide a controlled amount of resistance against a pivoting action of the second handle portion when the second handle portion is pivoted upwards and/or downwards relative to the first handle portion. In some cases, the spring-loaded pivot joint may be configured to bias the first and second handle portions back to one or more pre-determined states after the first or second handle portion is pivoted about the spring-loaded pivot joint. In some cases, the spring-loaded pivot joint may be configured to bias the first and second handle portions back to a state in which the first and second handle portions are parallel to and aligned with each other in series. In some cases, the spring-loaded pivot joint may be configured to bias the first and second handle portions back to a state in which the upper and/or lower surfaces of the first and second handle portions are coplanar or substantially coplanar.

In some cases, the first handle portion may have a first width. In some cases, the second handle portion may have a second width. In some cases, the first width may be equal to the second width. In some cases, the first width and the second width may be different. In some cases, the first width may be greater than the second width. In other cases, the second width may be greater than the first width.

In some cases, the first width and/or the second width may be less than the separation distance between the first portion of the shell and the second portion of the shell. In some cases, the first and second portions of the shell may be spaced apart by a distance that is greater than the first width and/or the second width.

In some cases, the first end of the first handle portion 2121 may be pivotably coupled to a third portion of the shell 2100. In some cases, the third portion of the shell 2100 may be disposed within the central recessed region of the shell. In some cases, the third portion of the shell 2100 may include one or more sides or surfaces of the central recessed region of the shell. In some cases, the third portion of the shell 2100 may be spaced apart from the lateral and medial sides of the shell by a second offset distance that is greater than the first offset distance between the first and second portions of the shell and the lateral or medial sides of the shell.

### Pivoting Action

In some cases, the handle mechanism 2120 may be configured to pivot between a plurality of different positions to deploy and/or retract the legs of the leg mechanism. In some cases, the handle mechanism 2120 may be configured to pivot between (i) a first position in which the first handle portion 2121 and the second handle portion 2122 are disposed entirely within the central recessed region 2101 and (ii) a second position in which the second handle portion 2122 and at least the second end of the first handle portion 2121 are positioned outside of the central recessed region 2101 of the shell 2100.

In some cases, when the handle mechanism is in the first position, the handle mechanism may be disposed entirely within the central recessed region, and the leg mechanism may be disposed entirely within the plurality of recessed regions. In some cases, the handle mechanism may be retracted further into the shell than the leg mechanism when the handle mechanism is in the first position.

In some cases, the second end of the first handle portion may be disposed above the first portion of the shell and the second portion of the shell when the handle mechanism is in the first position. In some cases, the second handle portion may be disposed above the first and second portions of the shell when the handle mechanism is in the first position.

### Latch Mechanism

In some cases, the system may comprise a latch mechanism 2300 configured to secure the handle mechanism within the central recessed region after the handle mechanism is pulled back up to retract the leg mechanism. In some cases, the latch mechanism 2300 may comprise a deflectable member with a first end secured to a bottom surface or a sidewall of the central recessed region and a second end comprising a notched region configured to engage a distal end of the second handle portion when the handle mechanism is placed in the first position.

In some cases, the latch mechanism 2300 may comprise a cantilevered member extending through the central recessed region. In some cases, the cantilevered member may be disposed entirely within the central recessed region. In some cases, the cantilevered member may not or need not extend or protrude out of the central recessed region.

### First Engagement Feature

In some cases, the second handle portion 2122 of the handle mechanism may comprise a first engagement feature 2125. In some cases, the first engagement feature 2125 may be attached to or integrated with the second handle portion 2122. In some cases, the first engagement feature 2125 may have a fixed position and/or a fixed orientation relative to the second handle portion 2122. In some cases, the second handle portion 2122 may be pivoted relative to the first handle portion 2121 to reposition and/or reorient the first engagement feature 2125 relative to a second engagement feature (described in further detail below).

In some cases, the first engagement feature 2125 may comprise a protrusion, a hook, a latch, or a male connector. In other cases, the first engagement feature 2125 may comprise a slot, an opening, an aperture, a notch, a recess, a depression, an indentation, a receptacle, or a female connector.

In some cases, the first engagement feature 2125 may have a first side/surface and a second side/surface opposite the first side/surface. In some cases, the first side/surface of the first engagement feature 2125 may be oriented towards the proximal end of the first handle portion 2121. In some cases, the second side/surface of the first engagement feature 2125 may be oriented towards the distal end of the second handle portion 2122. In some cases, the first side/surface of the first engagement feature may be configured to engage the second engagement feature or a portion thereof. In other cases, the second side/surface of the first engagement feature may be configured to engage the second engagement feature or a portion thereof.

### Linking Member

In some cases, the system may comprise a linking member 2130. In some cases, the linking member 2130 may be configured to connect the first handle portion 2121 of the handle mechanism to the cross member 2113 of the leg mechanism. In some cases, the linking member may comprise a first end that is pivotably coupled to the first handle portion. In some cases, the linking member 2130 may comprise a second end that is pivotably coupled to the cross member.

In some cases, the linking member 2130 may be disposed entirely within the central recessed region when the plurality of legs are in the retracted position. In some cases, when the handle mechanism is pulled out of the central recessed region, the linking member 2130 may be configured to pivot out of the central recessed region to facilitate the deployment of the leg mechanism. In some cases, the second end of the linking member 2130 may be configured to extend away from the central recessed region as the leg mechanism is being deployed outwards.

### Second Engagement Feature

In some cases, the linking member 2130 may comprise a second engagement feature 2135. In some cases, the second engagement feature 2135 may be configured to engage the first engagement feature 2125 in order to lock the plurality of legs in an extended position.

In some cases, the second engagement feature 2135 may comprise a protrusion, a hook, a latch, or a male connector. In other cases, the second engagement feature 2135 may comprise a slot, an opening, an aperture, a notch, a recess, a depression, an indentation, a receptacle, or a female connector.

In some cases, the second engagement feature 2135 may have a first side/surface and a second side/surface opposite the first side/surface. In some cases, the first side/surface of the second engagement feature 2135 may be oriented towards the distal end of the linking member 2130 (i.e., the end of the linking member that is directly or indirectly coupled to the cross member of the leg mechanism). In some cases, the second side/surface of the second engagement feature 2135 may be oriented towards the proximal end of the linking member 2130 (i.e., the end of the linking member that is pivotably coupled to the first handle portion 2121). In some cases, the first side/surface of the second engagement feature may be configured to engage the first side/surface of the first engagement feature. In other cases, the second side/surface of the second engagement feature may be configured to engage the second side/surface of the first engagement feature.

### Pivot Points

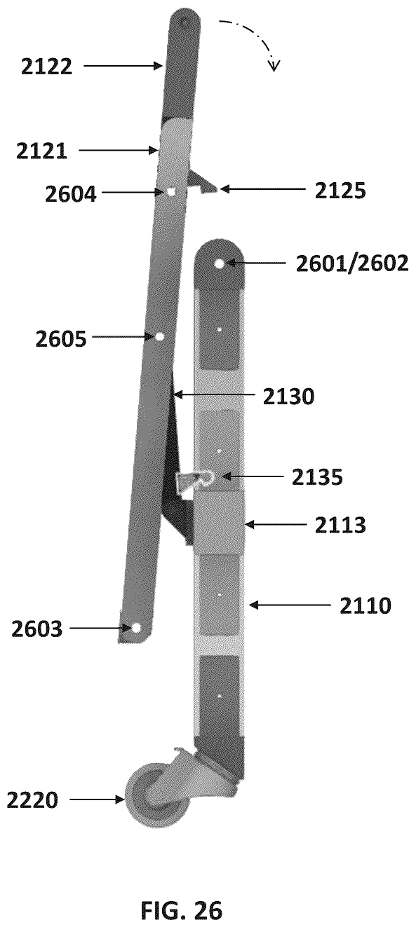

FIG. 26 schematically illustrates a side view of the system. In some cases, the first leg 2111 of the leg mechanism may be pivotably coupled to a first portion of the shell about a first pivot point 2601. In some cases, the second leg 2112 of the leg mechanism may be pivotably coupled to a second portion of the shell about a second pivot point 2602.

In some cases, the system may comprise a handle mechanism. In some cases, the handle mechanism may comprise a first handle portion 2121 with a first end pivotably coupled to a third portion of the shell 2100 about a third pivot point 2603. In some cases, the handle mechanism may comprise a second handle portion 2122 pivotably coupled to a second end of the first handle portion 2121 about a fourth pivot point 2604.

In some cases, the system may comprise a linking member 2130 with a second engagement feature 2135. In some cases, a first end of the linking member 2130 may be pivotably coupled to the first handle portion 2121 about a fifth pivot point 2605 that is disposed between the third pivot point 2603 and the fourth pivot point 2604. In some cases, a second end of the linking member 2130 may be pivotably coupled to the cross member 2113. In some cases, a connector piece may be used to indirectly couple the second end of the linking member 2130 to the cross member 2113.

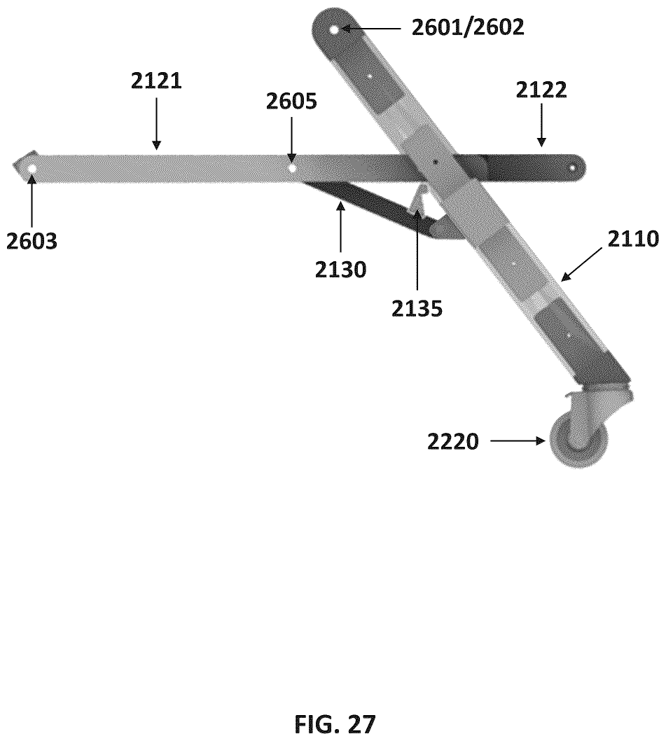

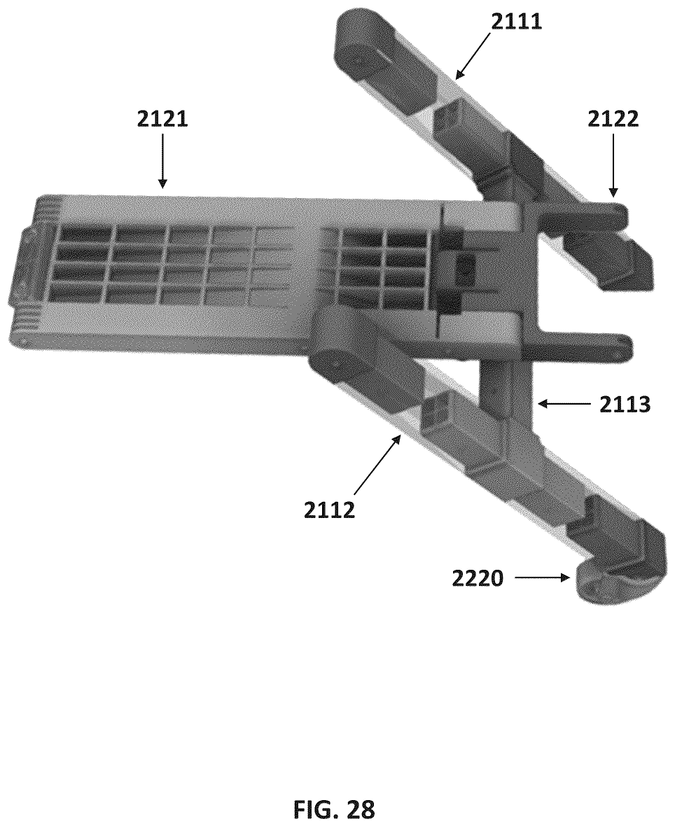

Referring to FIGS. 27 and 28, in some cases, the second handle portion 2122 of the handle mechanism may be pulled downwards to deploy the leg mechanism 2110 outwards. When the second handle portion 2122 of the handle mechanism is pulled downwards, the first handle portion 2121 may be configured to pivot about the third pivot point 2603 to an extended position in which the first handle portion 2121 is positioned over and supported by the cross member 2113 of the leg mechanism. In some cases, the handle mechanism may be oriented horizontally and substantially parallel to the ground surface when the first handle portion is pivoted about the third pivot point 2603 to the extended position.

In some cases, when the second handle portion 2122 of the handle mechanism is pulled downwards, the first leg 2111 and the second leg 2112 may be configured to pivot about the first pivot point 2601 and the second pivot point 2602 to extended positions so that the first and second legs can support the bag when the bag is tilted. In some cases, when the second handle portion 2122 of the handle mechanism 2120 is pulled downwards, the linking member 2130 may be activated to facilitate the outward extension of the first leg 2111 and the second leg 2112.

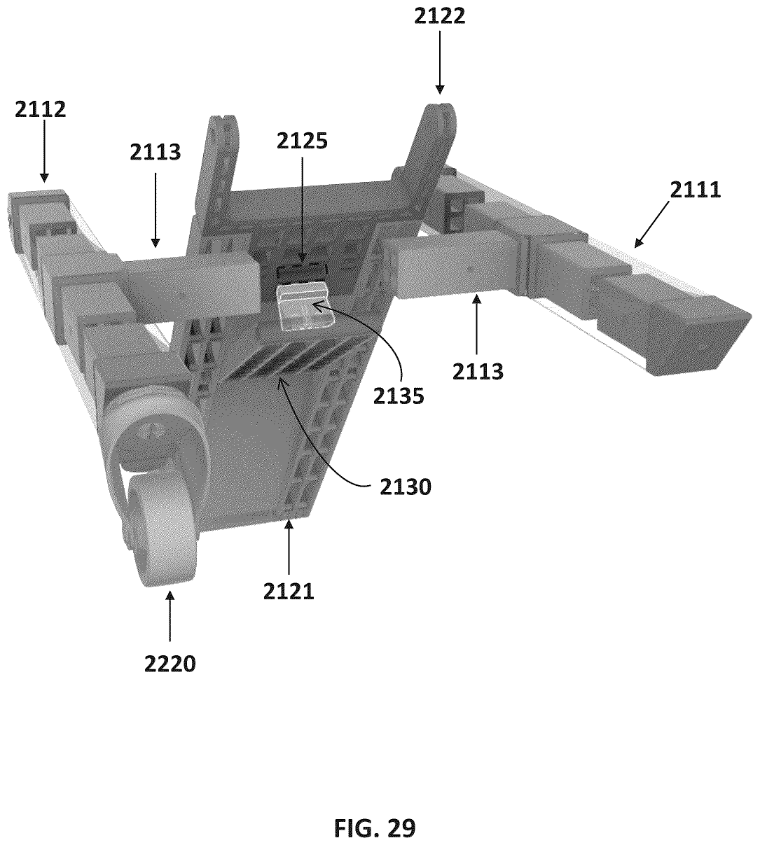

In some cases, when the second handle portion 2122 of the handle mechanism 2120 is pulled downwards, the first handle portion 2121 of the handle mechanism 2120 may be pivoted about the third pivot point 2603 to an extended position in which at least a portion of the handle mechanism is positioned over and supported by the cross member 2113 of the leg mechanism. In such cases, the first engagement feature 2125 associated with the second handle portion 2122 of the handle mechanism may be placed in close proximity to the second engagement feature 2135 associated with the linking member 2130 (e.g., as shown in FIGS. 29-31). In some cases, when the first and second engagement features are positioned close enough to each other, the first engagement feature 2125 may be configured to automatically engage the second engagement feature 2135 to lock the first leg 2111 and the second leg 2112 in an extended position.

In some cases, when the handle mechanism is pulled downwards and pivoted to an extended position, the first engagement feature 2125 associated with the second handle portion of the handle mechanism may be positioned in front of the second engagement feature 2135 associated with the linking member. In such cases, the first side/surface of the first engagement feature 2125 may be configured to engage the first side/surface of the second engagement feature 2135 to lock the leg mechanism in an extended position.

In other cases, when the handle mechanism is pulled downwards and pivoted to an extended position, the first engagement feature 2125 associated with the second handle portion of the handle mechanism may be positioned behind the second engagement feature 2135 associated with the linking member. In such cases, the second side/surface of the first engagement feature 2125 may be configured to engage the second side/surface of the second engagement feature 2135 to lock the leg mechanism in an extended position.

### Leg Deployment

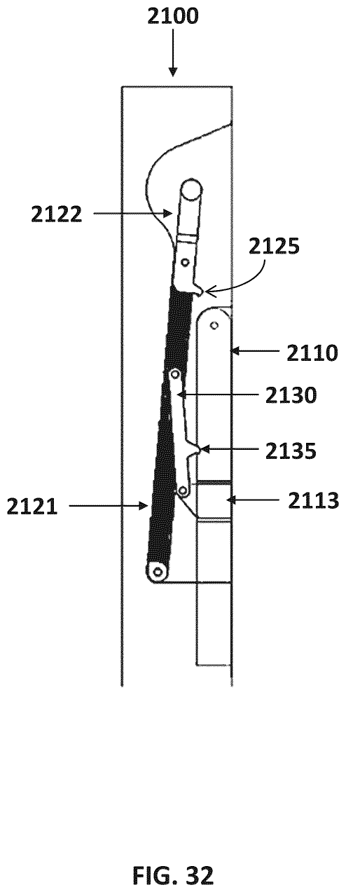

FIGS. 32-36 schematically illustrate the operation of the system(s) disclosed herein. In some cases, the system(s) may comprise a handle mechanism comprising a first handle portion 2121 and a second handle portion 2122 pivotably coupled to the first handle portion. In some cases, the second handle portion 2122 may comprise a first engagement feature 2125 as described elsewhere herein. In some cases, the system may comprise a leg mechanism 2110 comprising a plurality of legs and a cross member 2113 extending between the plurality of legs. In some cases, the system may comprise a linking member 2130 with a first end pivotably coupled to the first handle portion 2121 and a second end pivotably coupled to the cross member 2113. In some cases, the linking member 2130 may comprise a second engagement feature 2135 disposed between the first end of the linking member and the second end of the linking member.

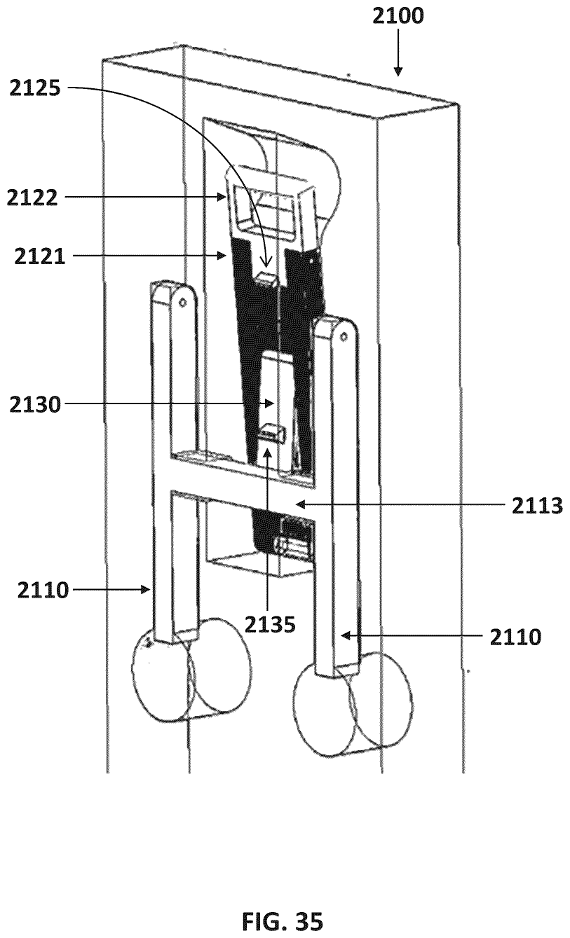

FIGS. 32 and 35 schematically illustrate a system that is retracted into a shell 2100. In some cases, when the system is retracted into the shell, the first handle portion 2121 and the second handle portion 2122 of the handle mechanism may be disposed entirely within the central recessed region of the shell. In some cases, when the system is retracted into the shell, the linking member 2130 may be disposed entirely within the central recessed region of the shell. In some cases, when the system is retracted into the shell, the plurality of legs and the cross member 2113 of the leg mechanism 2110 may be disposed entirely within one or more other recessed regions of the shell.

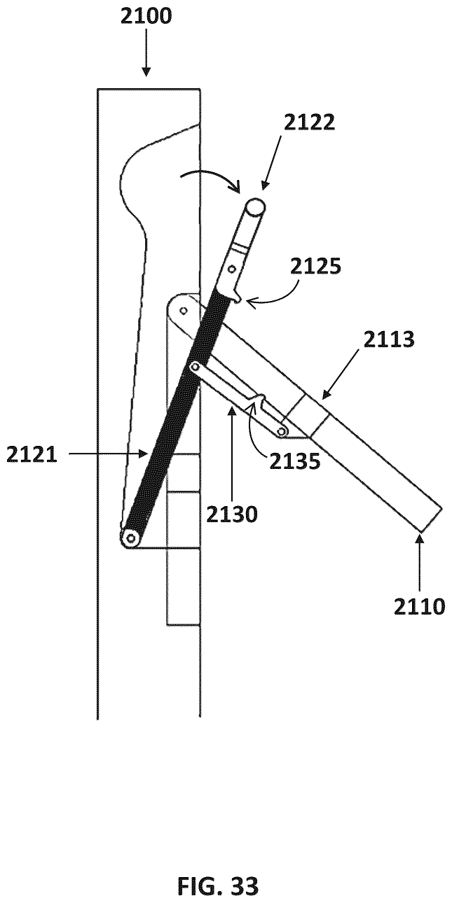

When a subject wishes to deploy the first leg and/or the second leg of the leg mechanism, the subject may pull the second handle portion 2122 of the handle mechanism 2120 downwards to initiate the deployment of the leg mechanism 2110 (e.g., as shown in FIG. 33). When the second handle portion 2122 is pulled downwards, the handle mechanism may be configured to pivot outwards to an extended position. The downward movement of the second handle portion 2122 may also activate the linking member 2130 to facilitate the outward extension of the first leg 2111 and the second leg 2112 so that the first and second legs can support the bag when the bag is tilted.

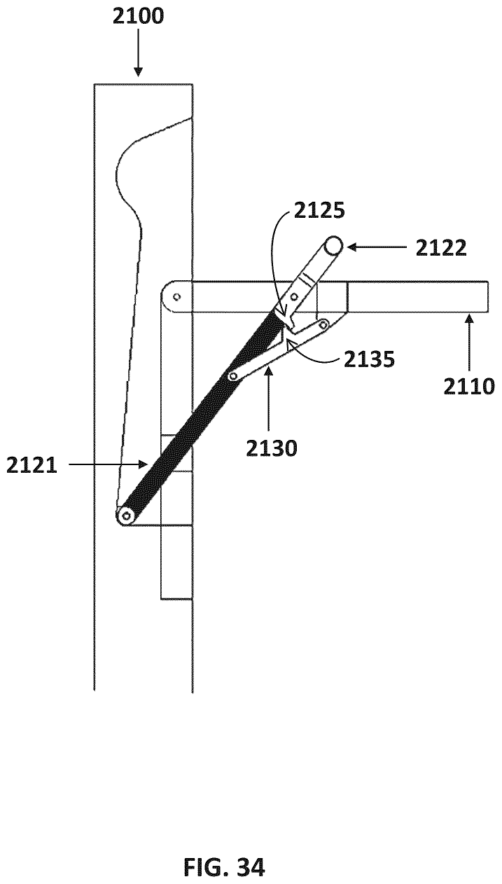

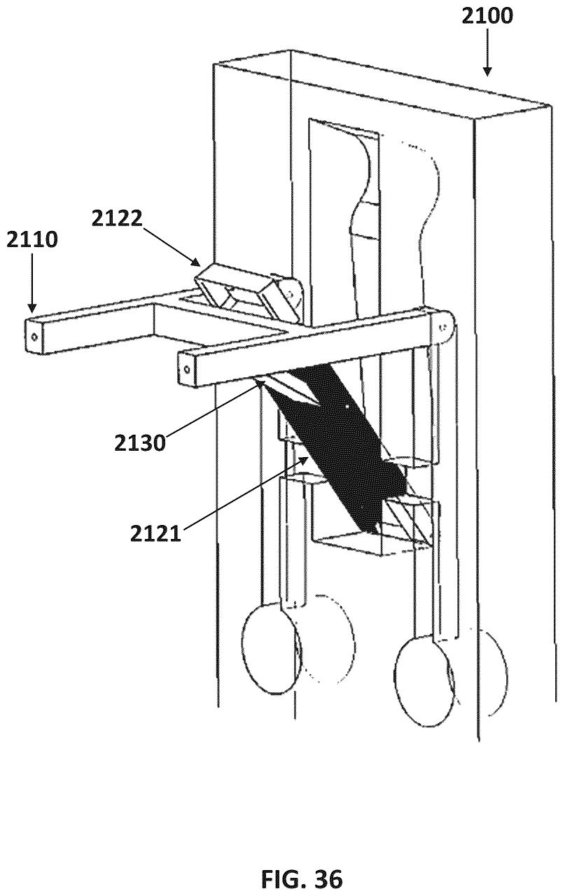

As shown in FIGS. 34 and 36, once the second handle portion 2122 of the handle mechanism 2120 is pulled all the way down, both the handle mechanism and the leg mechanism may be fully extended. In some cases, when the handle mechanism and the leg mechanism are fully extended, the first handle portion 2121 of the handle mechanism may be positioned over and supported by the cross member 2113 of the leg mechanism. In some cases, the handle mechanism may be substantially parallel to the ground surface when the handle mechanism and the leg mechanism are fully extended.

When the handle mechanism and the leg mechanism are fully extended, the first engagement feature 2125 associated with the second handle portion 2122 of the handle mechanism may be placed in close proximity to the second engagement feature 2135 associated with the linking member 2130. In some cases, when the first engagement feature and the second engagement feature are positioned close enough to each other, the first engagement feature 2125 may be configured to automatically engage the second engagement feature 2135 to lock the first leg 2111 and the second leg 2112 in extended positions.

In some cases, when the handle mechanism is pulled downwards and pivoted to an extended position, the first engagement feature 2125 associated with the second handle portion of the handle mechanism may be positioned in front of the second engagement feature 2135 associated with the linking member. In such cases, the first side/surface of the first engagement feature 2125 may be configured to engage the first side/surface of the second engagement feature 2135 to lock the leg mechanism in an extended position.

In other cases, when the handle mechanism is pulled downwards and pivoted to an extended position, the first engagement feature 2125 associated with the second handle portion of the handle mechanism may be positioned behind the second engagement feature 2135 associated with the linking member. In such cases, the second side/surface of the first engagement feature 2125 may be configured to engage the second side/surface of the second engagement feature 2135 to lock the leg mechanism in an extended position.

### Leg Retraction

When a subject wishes to retract the first leg and/or the second leg of the leg mechanism, the subject may pull the second handle portion 2122 of the handle mechanism 2120 back upwards to initiate the retraction of the leg mechanism 2110 back into the recessed regions of the shell. In some cases, the second handle portion 2122 of the handle mechanism 2120 may be pivoted upwards to release the engagement between the first engagement feature 2125 and the second engagement feature 2135. When the engagement between the first engagement feature 2125 and the second engagement feature 2135 is released, the second handle portion 2122 may be pulled back up, and the handle mechanism may be configured to pivot back towards the central recessed region of the shell. Once the engagement between the first engagement feature 2125 and the second engagement feature 2135 is released, the linking member may also pivot back towards the central recessed region of the shell, and the legs may be configured to pivot back towards the recessed regions of the shell. When the second handle portion 2122 of the handle mechanism 2120 is repositioned back within the central recessed region of the shell, the rest of the handle mechanism may also be repositioned back within the central recessed region of the shell. When the second handle portion 2122 of the handle mechanism 2120 is repositioned back within the central recessed region of the shell, the entire leg assembly (including the plurality of legs and the cross member) may also be repositioned back within the plurality of recessed regions of the shell.

### Landing Gear

In some cases, the system may comprise a leg assembly. The leg assembly may comprise any of the leg mechanisms described elsewhere herein. In some cases, the system may comprise a handle assembly. The handle assembly may comprise any of the handle mechanisms described elsewhere herein.

In some cases, the leg assembly may be movable between (i) a retracted position in which at least a portion of the leg assembly is positioned within a recessed region of the shell and (ii) one or more extended positions in which at least a portion of the leg assembly is positioned outside of the recessed region of the shell. In some cases, the handle mechanism of the system may be used to manipulate and move the leg assembly between the retracted position and the one or more extended positions.

In some cases, when the leg assembly is in the retracted position, a subject may actuate a release mechanism (e.g., using his or her foot) to release the leg assembly from the recessed region of the shell. Once the leg assembly is released from the recessed region of the shell, the subject may pivot one or more legs of the leg assembly to one or more extended positions and lock the legs at a desired angular orientation as described elsewhere herein.

In some cases, the leg assembly may be pivoted past the upper edge of the shell and positioned along the back side of the bag. In some cases, a receiving structure may be provided along the back side of the bag. In some cases, the receiving structure may be configured to receive the leg assembly and lock the leg assembly in place so that the leg assembly forms a rigid support that can strengthen and/or stiffen the back side of the bag.

In some cases, when a subject wishes to retract or stow away the leg assembly, the subject may actuate a release mechanism to release the leg assembly from a locked position. Once the leg assembly is released, the leg assembly may be pivoted back towards the recessed region of the shell and positioned within the recessed region of the shell.

### Bag Assembly

In some cases, any of the bags disclosed herein may be joined or connected to one or more other bags to form a self-stabilizing or self-stabilized bag assembly as described elsewhere herein. In some cases, the bag assembly may comprise one or more carry-on or check-in luggage bags and/or one or more travel bags for carrying equipment with an elongated form factor.

In some cases, one or more bags of the bag assembly may comprise a system that can be used to facilitate the handling, maneuvering, movement, and/or transportation of the bag assembly. In some cases, the system may be integrated with a shell that can be attached or coupled to one or more bags of the bag assembly.

In some cases, the system may be attached to or integrated with a lead bag of the bag assembly. In some cases, the system may be deployed so that the lead bag can be placed in a tilted configuration and handled, maneuvered, moved, or transported while in the tilted configuration. In some cases, the other bag(s) in the bag assembly may be configured to follow the lead bag as the lead bag is being handled, maneuvered, moved, or transported while in the tilted configuration. In some cases, the system may not or need not be deployed so that the lead bag can be handled, maneuvered, moved, or transported while in an upright configuration. In some cases, the other bag(s) in the bag assembly may be configured to follow the lead bag as the lead bag is being handled, maneuvered, moved, or transported while in the upright configuration. In some cases, the other bag(s) in the bag assembly may be configured to lean against the lead bag or against one or more other bags in the bag assembly while the lead bag is in the upright configuration.

In some cases, the system may be attached to or integrated with a trailing bag of the bag assembly or a middle bag that is disposed between the lead bag of the bag assembly and the trailing bag of the bag assembly. In some cases, the system may be retracted so that the trailing bag or the middle bag can lean against another bag leading the trailing bag or the middle bag. In some cases, the system may be retracted so that the system does not interfere with the handling, maneuvering, movement, or transportation of the bag assembly or the other bag(s) in the bag assembly that are connected to the trailing bag or the middle bag. In some cases, the system may not or need not be deployed until after the middle bag or the trailing bag is disconnected from the other bag(s) in the bag assembly. In other cases, the system may be deployed to facilitate the handling, maneuvering, movement, or transportation of the bag assembly while the middle or trailing bag is still connected to one or more other bag(s) in the bag assembly, without interfering with or compromising the self-stabilizing arrangement of the bags in the bag assembly.

### System

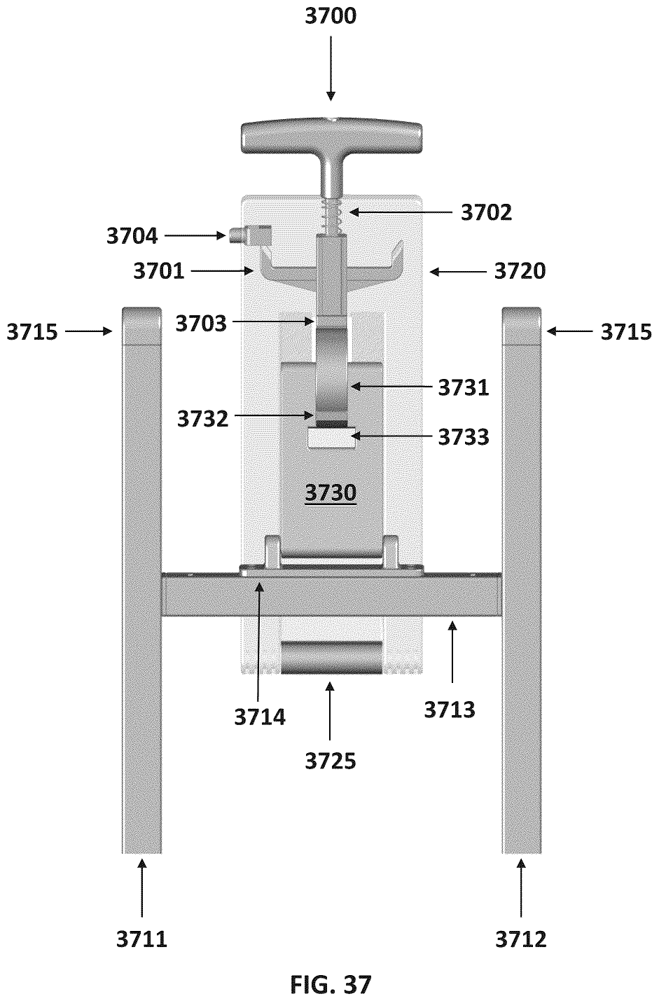

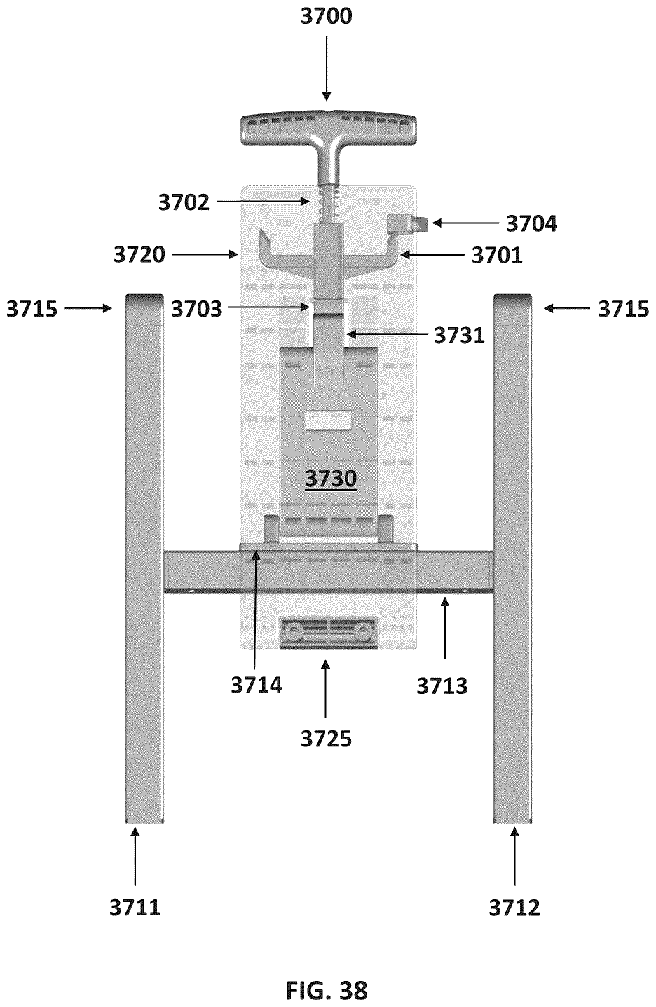

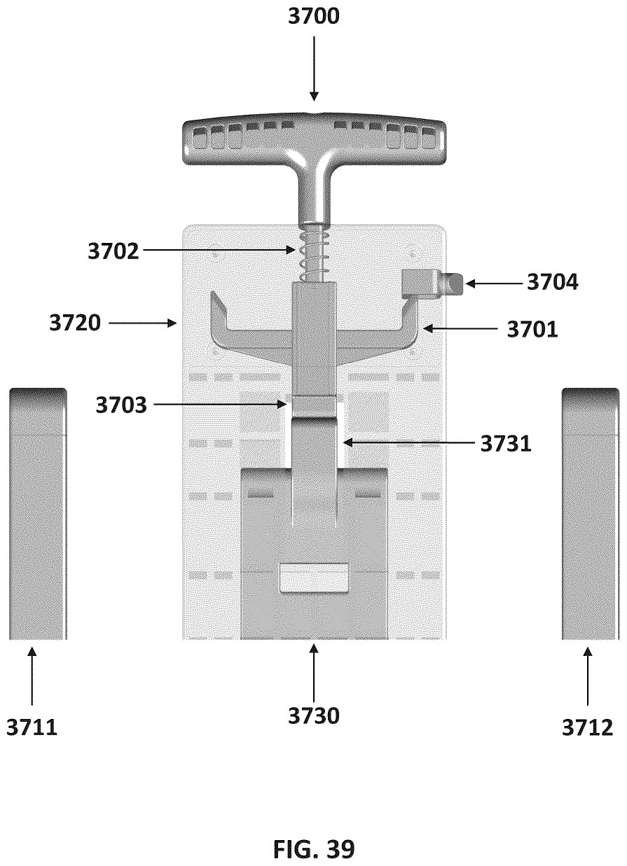

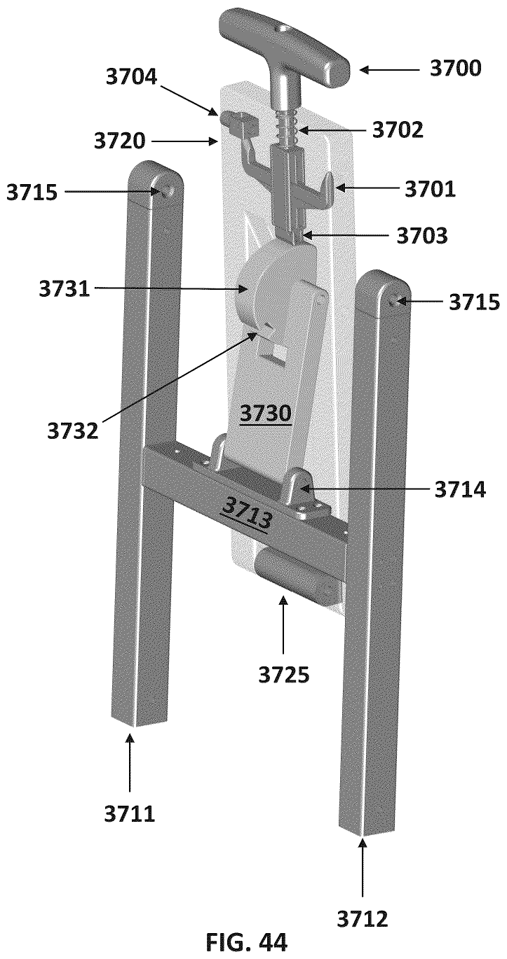

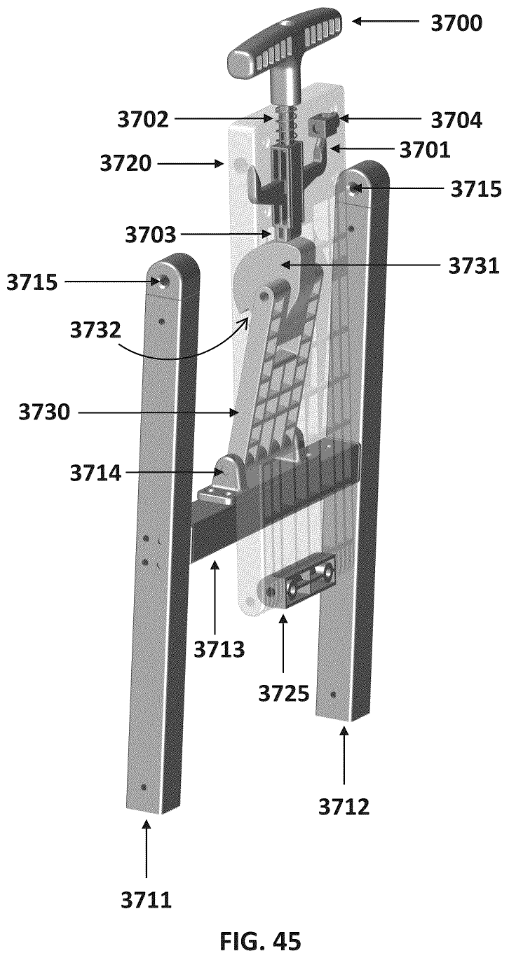

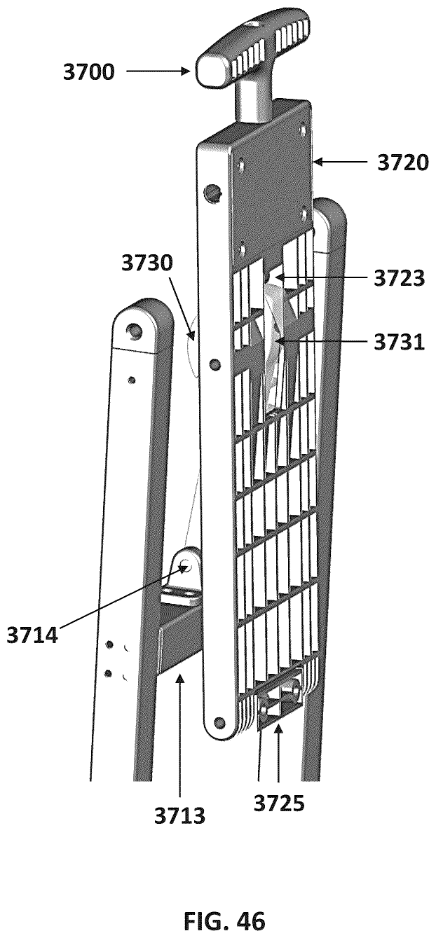

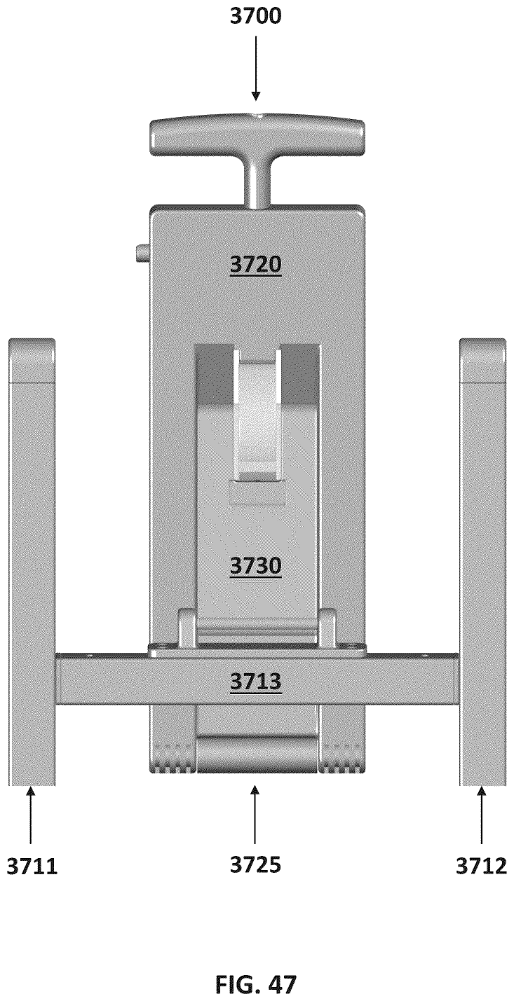

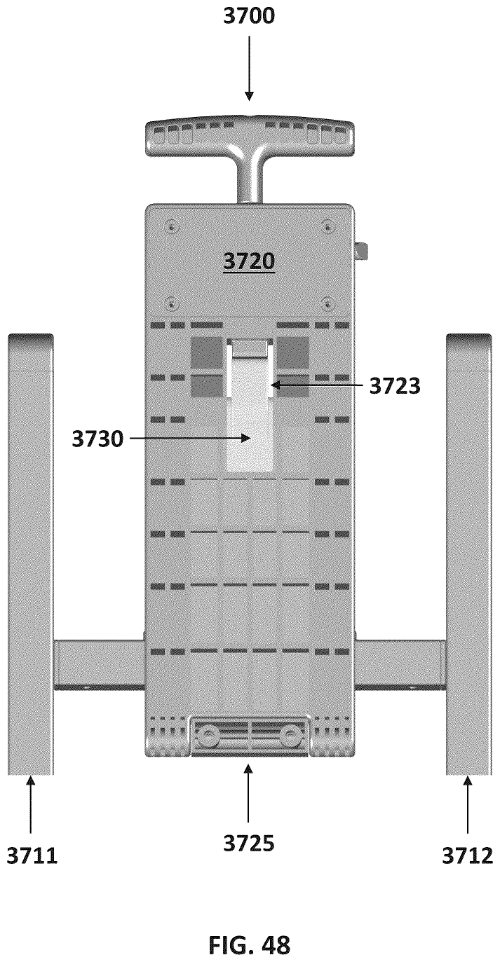

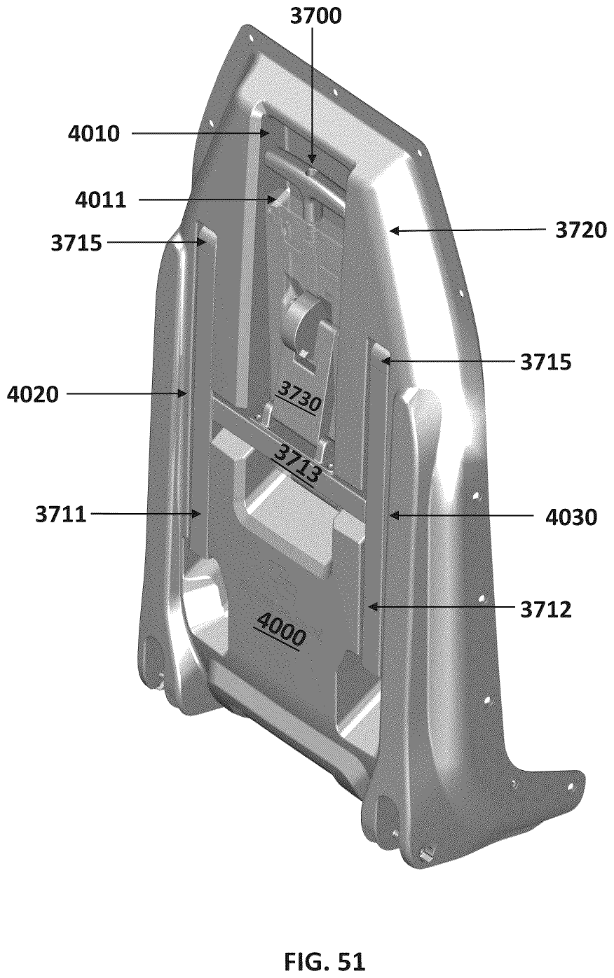

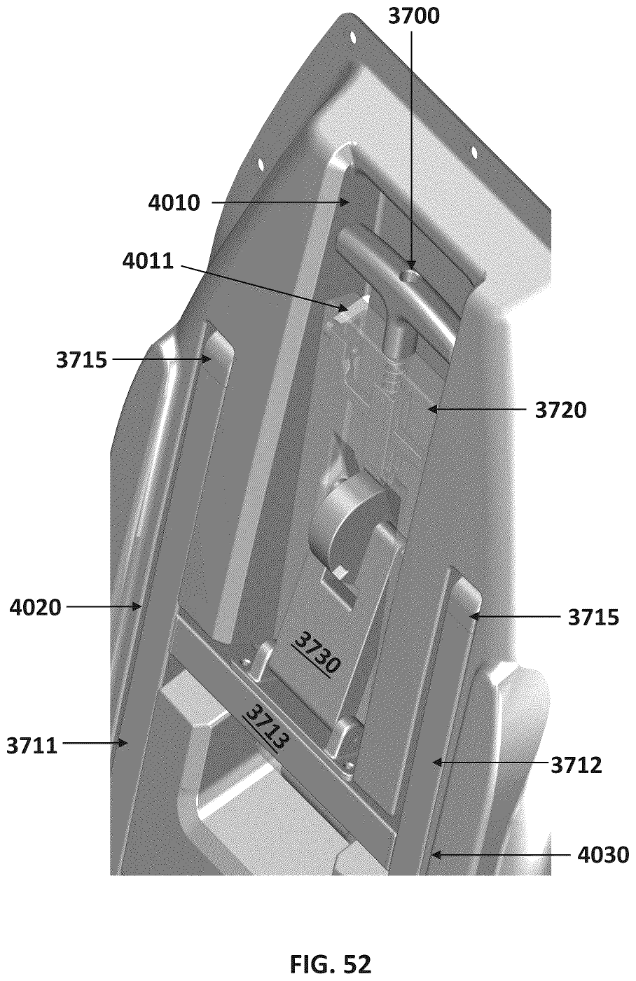

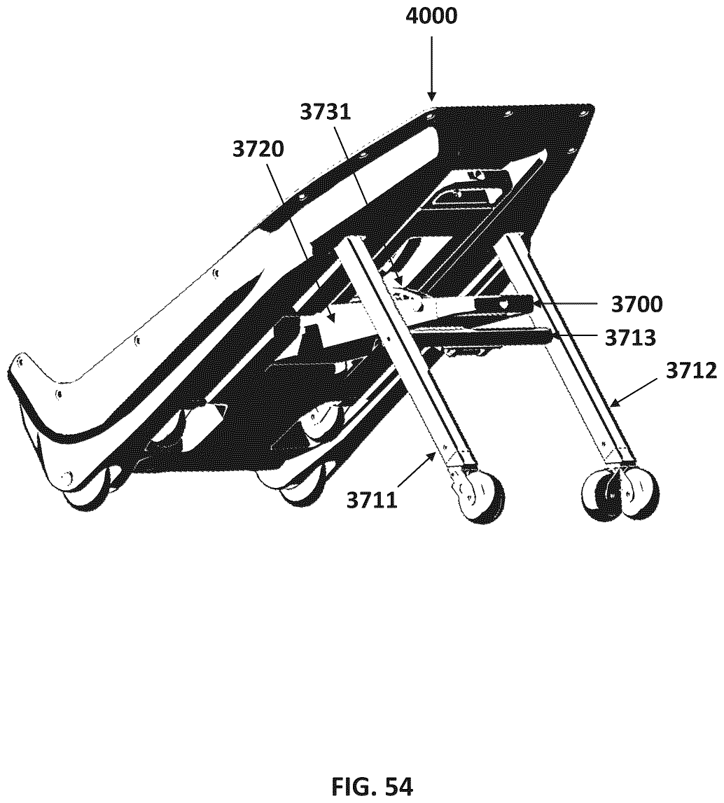

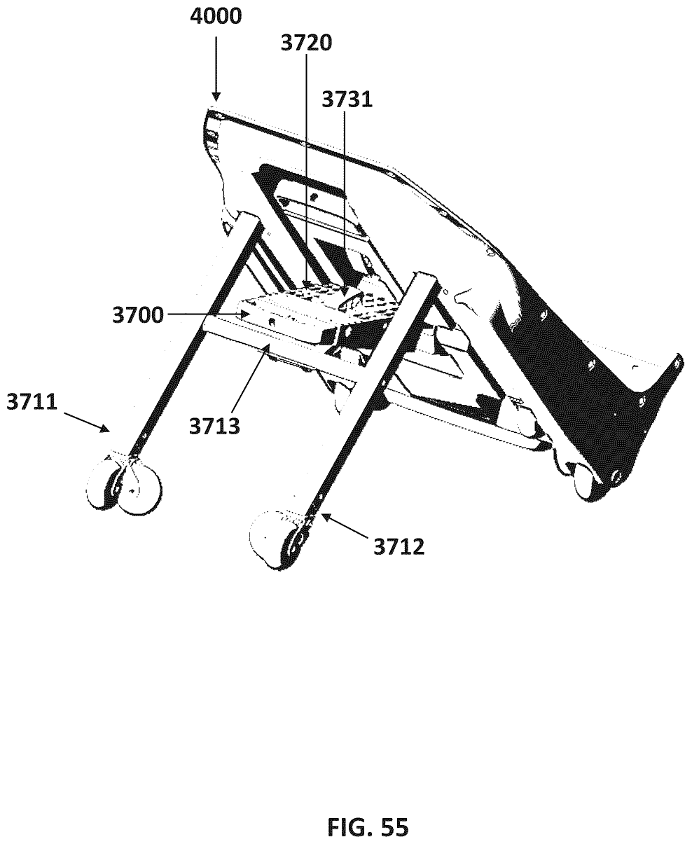

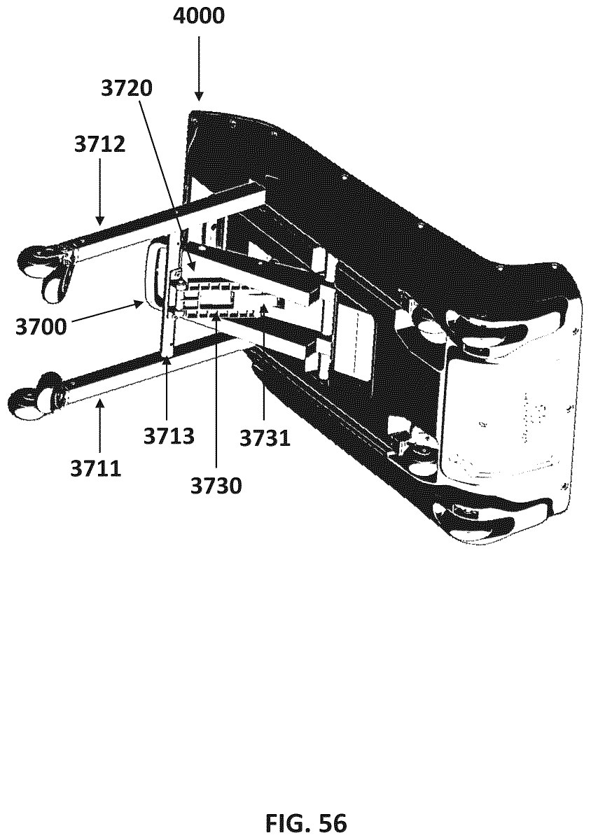

Referring now to FIGS. 37-56, in some cases, the bags disclosed herein may comprise a system that can be used to facilitate the handling, maneuvering, movement, and/or transportation of any of the bags disclosed herein. In some cases, the system may be used to adjust the positioning and/or the orientation of any bag relative to the ground surface so that the bag can be placed in different configurations as needed, including e.g., an upright configuration or a tilted configuration as described elsewhere herein. In some cases, the system may be used to reconfigure any bag for different applications, use cases, or scenarios. In some cases, the system may be used to reconfigure any bag for different modes of transport and/or different forms of transport.

In some cases, the system may be configured to reorient the bag from an upright configuration to a tilted configuration so that the bag can be kept, stored, moved, or transported in the tilted configuration. In some cases, the system may be configured to reorient the bag from the tilted configuration to the upright configuration so that the bag can be kept, stored, moved, or transported in the upright configuration. In some cases, the system may be configured to reorient the bag from a first tilted configuration to a second tilted configuration in order to adjust the height of the bag and/or the angular orientation of the bag relative to the ground surface.

### Handle Assembly

In some cases, the system may comprise a handle assembly. FIGS. 37-39 schematically illustrate an exemplary handle assembly that can be used with any of the leg assemblies or mechanisms described elsewhere herein. In some cases, the handle assembly may comprise a handle 3700 and a latch mechanism 3701 operatively coupled to the handle 3700. In some cases, the handle assembly may further comprise a spring element 3702 operatively coupling the handle 3700 and the latch mechanism 3701.

In some cases, the latch mechanism 3701 may comprise a first end and a second end opposite the first end. In some cases, the first end may comprise an extended portion that the spring element can be positioned around. In some cases, the second end may comprise a protrusion 3703 that is sized and shaped to engage one or more slots (e.g., as described elsewhere herein).

In some cases, the latch mechanism 3701 may comprise one or more arms extending outwards from the main body of the latch mechanism. In some cases, the one or more arms may comprise a first arm extending from a left side of the main body of the latch mechanism and a second arm extending from a right side of the main body of the latch mechanism. In some cases, the first arm and/or the second arm may comprise a distal end that is angled upwards. In some cases, the distal end may comprise a pointed edge that is tapered to form a sloped surface that can engage one or more locking pins 3704.

In some cases, the one or more locking pins 3704 may have a bottom opening that is configured to receive the distal end(s) of the first arm and/or the second arm. In some cases, the inner surfaces of the one or more locking pins 3704 may be sloped so that when the handle is pulled and the distal end(s) of the first and/or second arm(s) are drawn upwards through the bottom opening to engage the inner surfaces of the one or more locking pins, the locking pins 3704 are drawn inwards to release the handle assembly from a locked position. In some cases, when the handle is released, the distal end(s) of the first and/or second arm(s) may move back downwards and separate away from the locking pins to release the locking pins so that the locking pins can extend back outwards to lock the handle assembly in place.

### First Member

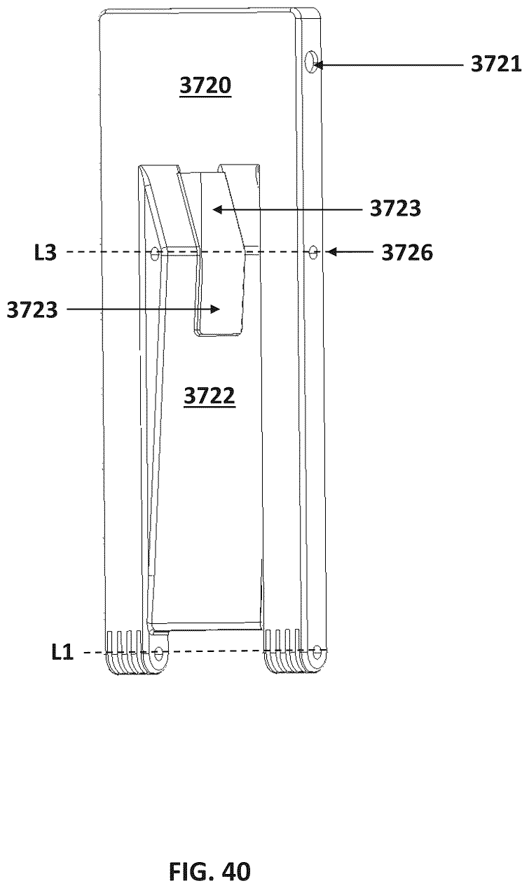

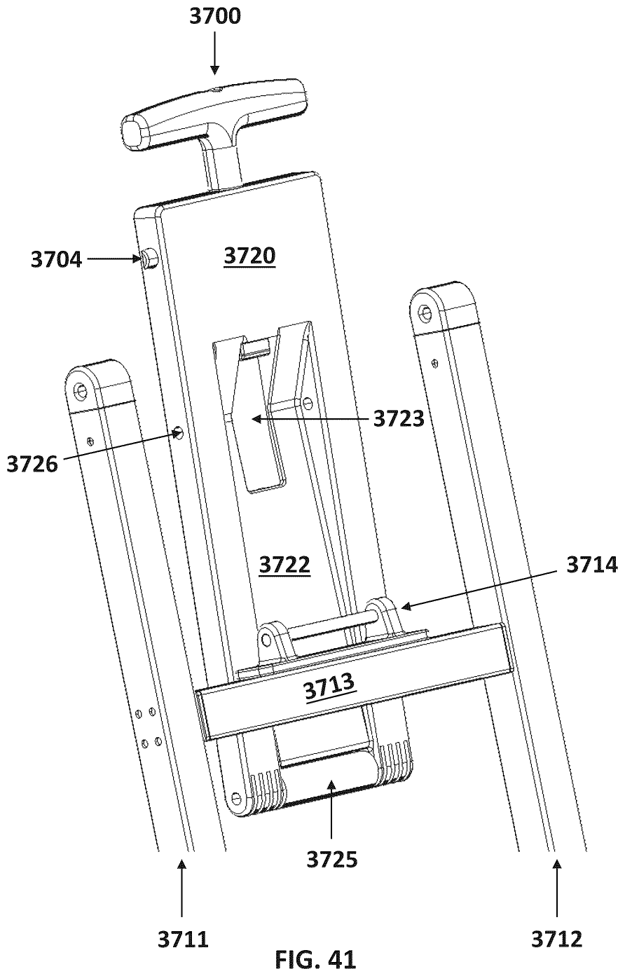

In some cases, the system may comprise a first member 3720. FIGS. 40-41 schematically illustrate various non-limiting examples of the first member 3720.

In some cases, the first member 3720 may comprise a first plate. In some cases, the first plate may form a front side, a left side, a right side, a top side, a bottom side, and at least a portion of the back side of the first member. In some cases, the first plate may comprise one or more hollowed interior regions. In some cases, a second plate may be secured along or adjacent to the one or more hollowed interior regions to form an enclosed or partially enclosed interior space between the first and second plates. In some cases, the enclosed or partially enclosed interior space may be configured to house the handle assembly or a portion thereof. In some cases, the enclosed or partially enclosed interior space may be configured to accommodate the latch mechanism 3701, the spring element 3702, and/or the one or more locking pins 3704. In some cases, the handle 3700 may be disposed outside of and/or external to the enclosed or partially enclosed interior space. In some cases, the protrusion 3703 forming the second end of the latch mechanism may be configured to move into or out of the enclosed or partially enclosed interior space when the handle 3700 is pulled or released.

In some cases, the first plate may form a front side, a left side, a right side, a top side, a bottom side, and a portion of the back side of the first member, and the second plate may form another portion of the back side of the first member. In some cases, the second plate may be attached or coupled to an upper portion of the back side of the first plate to form the upper back portion of the first member. In some cases, the second plate may not or need not extend below the upper portion of the back side of the first plate. In some cases, the second plate may be seated within a slightly recessed portion or section of the back side of the first plate so that the edges and outer surface of the second plate lie flush with the outer edges and surfaces of the back side of the first plate.

In some cases, the first plate may have a first set of dimensions and the second plate may have a second set of dimensions. In some cases, the first set of dimensions and the second set of dimensions may include a length, a width, and/or a thickness of the first and second plates. In some cases, the first set of dimensions may be different than the second set of dimensions. In some cases, the first set of dimensions may be greater than the second set of dimensions. In other cases, the second set of dimensions may be greater than the first set of dimensions. In some cases, the first plate may have a greater length, width, and/or thickness than the second plate.

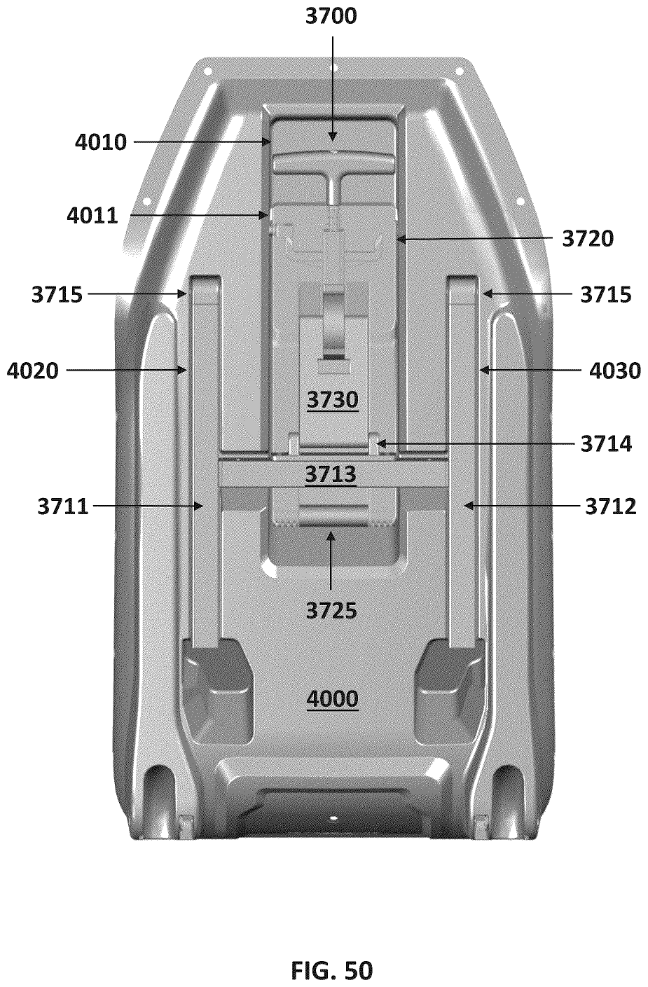

In some cases, the sides of the first member may comprise one or more holes or apertures 3721 for the locking pins. In some cases, the locking pins may be configured to move or extend through the one or more holes or apertures. In some cases, at least a portion of the locking pins may be configured to extend outwards through the one or more holes or apertures to engage one or more slots 4011 provided in a shell or a protective cover 4000 of the bag (e.g., as shown in FIGS. 50-52) to lock the first member 3720 in place. In some cases, the locking pins may be retracted back towards the enclosed or partially enclosed interior region and fully separated or disengaged from the one or more slots 4011 to release the first member 3720 from the locked position.

In some cases, the first member 3720 may comprise a recessed region 3722 extending along the front side of the first member. In some cases, the recessed region 3722 may be configured to receive or accommodate a second member 3730.

In some cases, the recessed region 3722 may comprise a sloped bottom surface that is angled downwards from a lower end of the first member towards an upper end of the first member. In some cases, the recessed region 3722 may comprise a left side wall and a right side wall forming a left and right side of the recessed region. In some cases, the recessed region 3722 may comprise a sloped front wall that is disposed at an obtuse angle relative to the bottom surface of the recessed region. In some cases, the angle between the sloped front wall and the bottom surface of the recessed region may be greater than 90 degrees.

In some cases, the first member 3720 may comprise an opening or an aperture 3723 extending through a portion of the bottom surface of the recessed region and/or a portion of the sloped front wall of the recessed region. In some cases, the opening or the aperture 3723 may be configured to receive or accommodate the second member 3730 or any portion(s) thereof.

In some cases, the first member 3720 may be pivotably coupled to a shell or a protective cover 4000 (e.g., as described elsewhere herein). In some cases, a connector 3725 may be attached or coupled to the shell or the protective cover. In some cases, the connector 3725 may comprise a through hole that is aligned with corresponding through holes formed through the lower end of the first member 3720. In some cases, the through holes may be configured to receive a pin or a rod to enable a pivotable coupling (L1) between the lower end of the first member 3720 and a portion of the shell or the protective cover 4000.

In some cases, the first member 3720 may comprise one or more through holes 3726. In some cases, the one or more through holes 3726 may be aligned with one or more other through holes formed through the second member 3730. In some cases, the through holes may be configured to receive a pin or a rod to enable a pivotable coupling between the first member 3720 and the second member 3730.

### Second Member

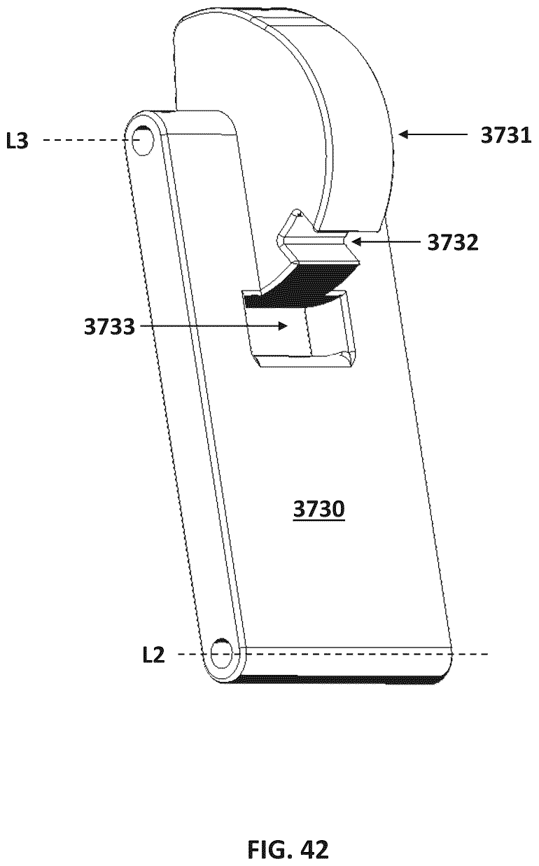

In some cases, the system may comprise a second member 3730. FIG. 42 schematically illustrates a non-limiting example of the second member 3730.

In some cases, the second member 3730 may comprise a first end pivotably coupled to the first member 3720. In some cases, the second member may comprise a second end pivotably coupled to a cross member 3713 extending between the legs of the leg assembly.

In some cases, the second member 3730 may comprise a body with an upper (first) end and a lower (second) end. In some cases, the upper end may comprise a first set of holes configured to enable a pivotable coupling (L3) between the first member 3720 and the second member 3730. In some cases, the lower end may comprise a second set of holes configured to enable another pivotable coupling (L2) between the second member 3730 and the leg assembly.

In some cases, the second member 3730 may comprise one or more lobes 3731. In some cases, the one or more lobes 3731 may have an eccentric shape or profile. In some cases, the one or more lobes may be positionally offset from a center line extending laterally across the body of the second member. In some cases, a central longitudinal axis of the one or more lobes may be aligned with another center line extending longitudinally across the body of the second member.

In some cases, the one or more lobes 3731 may comprise one or more slots. In some cases, the one or more slots may comprise a slot 3732 configured to receive the protrusion 3703 forming the second end of the latch mechanism (e.g., when the protrusion is aligned with the one or more slots). In some cases, the one or more slots may comprise a plurality of slots each configured to receive the protrusion 3703 depending on the angular orientation of the one or more lobes 3731 relative to the latch mechanism or the protrusion 3703. In some cases, the plurality of slots may be spaced apart along a curvature of the one or more lobes.

In some cases, the angular orientation of the one or more lobes 3731 relative to the latch mechanism or the protrusion 3703 may change or vary as the first member pivots relative to the second member (or vice versa). In some cases, the one or more lobes 3731 may be aligned with the protrusion when the first member is disposed at a predetermined angular orientation relative to the second member. In some cases, the leg assembly may be in a fully extended position when the first member is disposed at the predetermined angular orientation relative to the second member. In some cases, the one or more lobes 3731 may not or need not be aligned with the protrusion when the first member is disposed at a different angular orientation relative to the second member. In some cases, the leg assembly may not or need not be in an extended or fully extended position when the first member is disposed at a different angular orientation relative to the second member.

In some cases, the one or more lobes 3731 may be disposed along the upper end of the body of the second member. In some cases, a portion of the one or more lobes 3731 may be configured to extend past the upper end of the body of the second member. In some cases, a portion of the one or more lobes 3731 may extend from the upper end of the body of the second member to a more centrally disposed portion of the body of the second member. In some cases, a portion of the one or more lobes 3731 may extend from the upper end of the body of the second member to an opening or a window 3733 formed through the more centrally disposed portion of the body of the second member.

In some cases, the body of the second member may be wider and/or longer than the one or more lobes. In some cases, the body of the second member may extend past the leftmost and/or rightmost surfaces or edges of the one or more lobes.

In some cases, the one or more lobes may have a greater height and/or thickness than the body of the second member. In some cases, the one or more lobes may extend past the uppermost and/or lowermost surfaces or edges of the body of the second member.

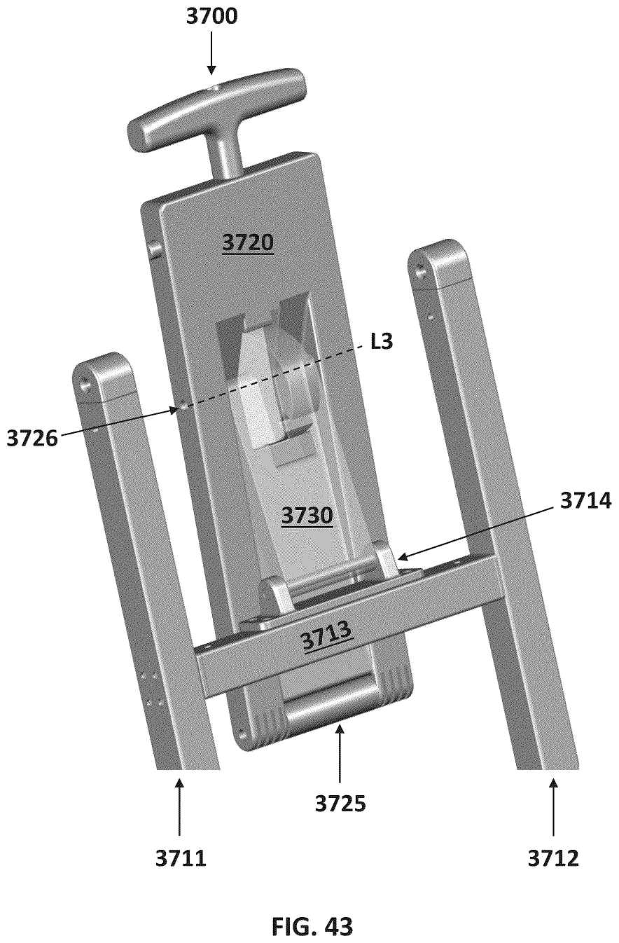

FIGS. 43-48 schematically illustrate a sub-assembly comprising the first member 3720 and the second member 3730. In some cases, the first member 3720 and the second member 3730 may be pivotably coupled about a pivotable coupling (L3). In some cases, the first set of holes in the upper end of the second member 3730 may be aligned with the one or more through holes 3726 in the first member 3720 to enable the pivotable coupling.

In some cases, when the first and second members are pivotably coupled together, the one or more lobes 3731 of the second member may be positioned within the recessed region 3722 extending along the front side of the first member. In some cases, a portion of the one or more lobes 3731 may be positioned within the opening or aperture 3723 extending through the bottom surface of the recessed region and/or the sloped front wall of the recessed region 3722. In some cases, the one or more lobes 3731 may extend or protrude through the opening or aperture 3723. In some cases, the one or more lobes 3731 may pivot or rotate through the opening or aperture 3723. In some cases, the one or more lobes 3731 and the opening or aperture 3723 may be sized and shaped so that the one or more lobes can move through the opening or aperture without interfering with the pivoting movement of the first and second members.

In some cases, the first member and the second member may be pivotably coupled along an axis. In some cases, the axis may be configured to extend through the recessed region 3722 of the first member. In some cases, the axis may be configured to extend through the one or more lobes 3731 of the second member.

### Leg Assembly

In some cases, the system may comprise a leg assembly. In some cases, the leg assembly may comprise a first leg 3711 and a second leg 3712. In some cases, the first leg 3711 and the second leg 3712 may be connected to a cross member 3713 extending between the first and second legs of the leg assembly.

In some cases, the leg assembly may be coupled to the second member 3730. In some cases, the second member 3730 may be pivotably coupled to the leg assembly along a pivotable coupling (L2). In some cases, an additional connector 3714 may be provided to enable the pivotable coupling between the second member and the leg assembly. In some cases, the additional connector 3714 may be attached to the cross member 3713. In some cases, the additional connector 3714 may have one or more protruding segments with through holes that can be aligned with the second set of holes extending through the lower end of the second member. In some cases, a pin or a rod may be inserted through the through holes in the additional connector and the holes in the lower end of the second member to form the pivotable coupling (L2) between the second member 3730 and the leg assembly.

### Pivotable Couplings

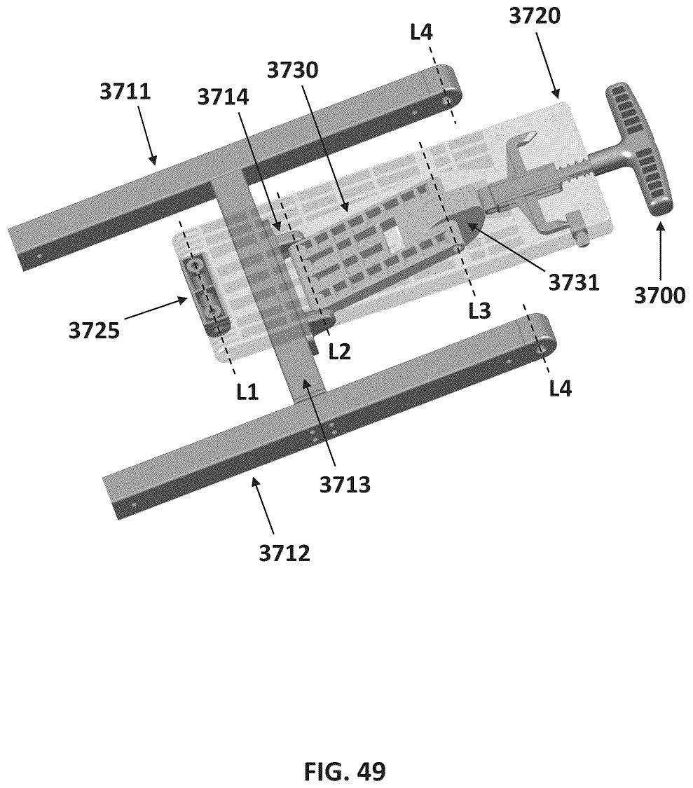

FIG. 49 schematically illustrates the various pivotable couplings joining together the first member 3720, the second member 3730, the leg assembly, and the shell or the protective cover of the bag. As discussed elsewhere herein, the pivotable couplings may include a pivotable coupling (L1) between the first member 3720 and the shell or protective cover of the bag, a pivotable coupling (L2) between the second member 3730 and the leg assembly, and a pivotable coupling (L3) between the first member 3720 and the second member 3730.

In some cases, the upper ends 3715 of the first and second legs of the leg assembly may be pivotably coupled to another portion or section of the shell or protective cover of the bag. In some cases, the upper ends of the first and second legs may be pivotably coupled to the shell or protective cover at pivotable couplings (L4).

### Retracted Position

FIGS. 50-52 schematically illustrate a system comprising a handle assembly and a leg assembly in a retracted position. In some cases, when the handle assembly is in the retracted position, the handle 3700, the first member 3720, and/or the second member 3730 may be positioned at least partially within a recessed region 4010 provided along a central portion of the front side of the shell or protective cover 4000. In some cases, when the leg assembly is in the retracted position, the leg assembly may be positioned at least partially within one or more other recessed regions 4020, 4030 that are spaced apart and offset from the central portion of the front side of the shell or protective cover.

### Deploying the Leg Mechanism

When a subject wishes to deploy the leg mechanism, the subject may pull the handle upwards to initiate the deployment of the leg mechanism. When the handle is pulled upwards, the latch mechanism 3701 may be translated upwards so that the distal ends of the one or more arms of the latch mechanism engage the one or more locking pins. As described elsewhere herein, when the distal ends of the one or more arms are drawn upwards to engage the inner surfaces of the one or more locking pins, the locking pins 3704 may be drawn inwards and separated or disengaged from one or more slots 4011 extending into or along a surface or a sidewall of the recessed region 4010 to release the handle assembly from a locked position. Once the handle assembly is released from the locked position, the handle assembly and the first member 3720 may be pivoted outwards and/or downwards towards the ground surface to activate the outward extension of the second member 3730 and the leg assembly.

### Extended Position

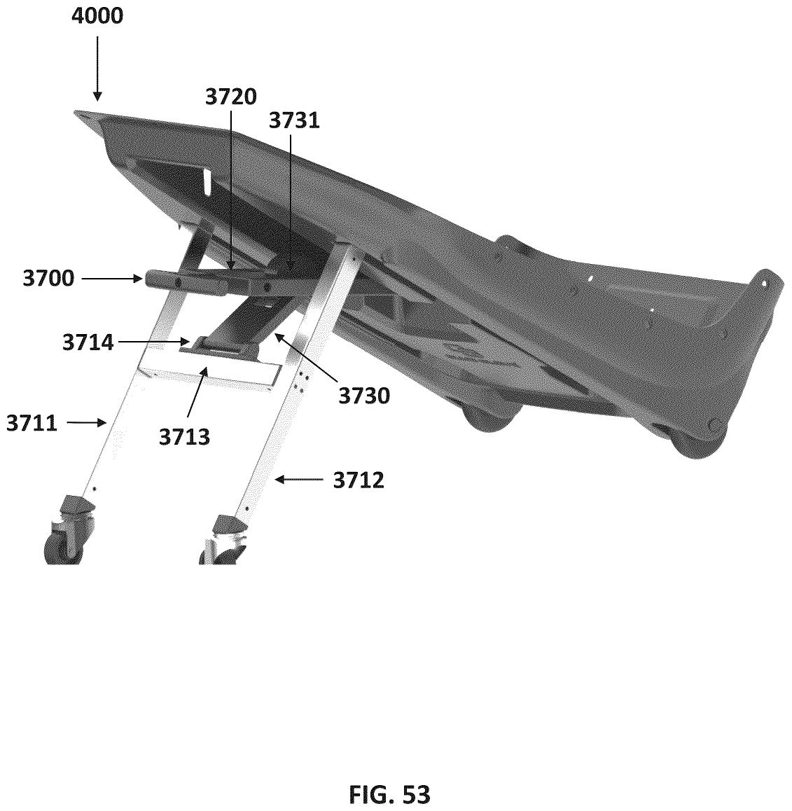

FIGS. 53-56 schematically illustrate the handle assembly and the leg assembly in an extended position. In some cases, when the handle assembly is in the extended position, the handle 3700, the first member 3720, and/or the second member 3730 may be positioned outside of the recessed region 4010 provided along the central portion of the front side of the shell or protective cover 4000. In some cases, when the leg assembly is in the extended position, the one or more legs of the leg assembly may be positioned outside the one or more other recessed regions 4020, 4030 that are spaced apart and offset from the central portion of the front side of the shell or protective cover.

In some cases, when the leg assembly is fully extended and deployed, the first member 3720 may be placed in contact with and/or may be supported by the cross member 3713 extending between the legs of the leg assembly. In some cases, the handle portion of the handle assembly may be configured to extend past the cross member 3713 so that the handle portion can be easily accessed and manipulated by the subject. In some cases, the first member 3720 and/or the handle portion of the handle assembly may be oriented horizontally and/or disposed parallel to the ground surface when the leg assembly is fully extended and deployed.

### Locking the Leg Mechanism

In some cases, when the leg assembly is deployed and extended outwards, the slot 3732 in the one or more lobes 3731 may be aligned with the protrusion 3703 of the latch mechanism. In some cases, the handle may be manipulated (e.g., by pulling or releasing the handle) to drive the protrusion 3703 into the slot 3732 and lock the leg assembly in the extended position. In some cases, the protrusion 3703 may be configured to automatically move into the slot 3732 (e.g., with the aid of a spring element that naturally biases the protrusion 3703 towards the slot 3732) when the slot 3732 is placed in alignment with the protrusion 3703.

### Unlocking the Leg Mechanism

When a subject wishes to retract the leg mechanism, the subject may manipulate the handle (e.g., by pulling the handle) to disengage the protrusion 3703 from the slot 3732. Afterwards, the handle may be pivotable back upwards to retract the leg assembly back towards the shell or protective cover of the bag.

### Retracting the Leg Mechanism

When a subject wishes to retract the leg mechanism, the subject may pivot the handle and/or the first member back upwards towards the protective cover or shell to initiate the retraction of the leg mechanism. In some cases, when the handle is pivoted back upwards, the latch mechanism 3701 may be configured to automatically engage or reengage the locking pins to draw the locking pins back inwards so that the handle assembly, the first member, and/or the second member can be positioned back within the recessed region(s) of the shell or protective cover. In some cases, when the handle is pivoted back upwards and positioned within a recessed region of the shell or protective cover, the latch mechanism 3701 may be configured to automatically disengage the locking pins so that the locking pins extend back outwards to engage or reengage the one or more slots 4011 extending into or along a surface or a sidewall of the recessed region, thereby locking the handle assembly in place.

In some cases, when the handle is pivoted back upwards, the handle and/or the latch mechanism may be manually manipulated (e.g., by pulling the handle) to engage and draw the locking pins back inwards so that the handle assembly, the first member, and/or the second member can be positioned back within a recessed region of the shell or protective cover. In some cases, when the handle is pivoted back upwards and positioned within the recessed region of the shell or protective cover, the handle and/or the latch mechanism may be manually manipulated (e.g., by releasing the handle) to disengage the locking pins so that the locking pins extend back outwards to engage or reengage the one or more slots 4011 extending into or along a surface or a sidewall of the recessed region, thereby locking the handle assembly back in place.

All patents, publications, and other references cited herein, including priority documents, are fully incorporated by reference to the extent such disclosure is not inconsistent with this technology and for all jurisdictions in which such incorporation is permitted. It is understood that the materials, designs, constructions, and structures; components; and assemblies and sub-assemblies described and illustrated herein represent only some embodiments of the technology. It is appreciated by those skilled in the art that various changes, optimizations, and additions can be made to such products and materials without departing from the spirit and scope of the present disclosure. It is intended that all such embodiments be covered by the claims presented herewith.

What is claimed is:

1. A bag comprising:
a body;
a shell coupled to the body, wherein the shell comprises a central recessed region and a plurality of recessed regions disposed along the central recessed region;
a leg mechanism comprising (i) a plurality of legs comprising a first leg pivotably coupled to a first portion of the shell and a second leg pivotably coupled to a second portion of the shell and (ii) a cross member extending between the first leg and the second leg, wherein the plurality of legs are pivotable between (1) a retracted position in which the plurality of legs are positioned entirely within the plurality of recessed regions and (2) an extended position in which one or more end portions of the plurality of legs are positioned outside of the plurality of recessed regions;
a handle assembly comprising a handle and a first member pivotably coupled to a third portion of the shell, wherein the handle assembly is configured to pivot between (1) a first position in which the handle assembly is disposed entirely within the central recessed region and (2) a second position in which the handle assembly is positioned outside of the central recessed region;
a latch mechanism integrated with the first member and operatively coupled to the handle, wherein the latch mechanism comprises an engagement feature that is operable by manipulating the handle; and
a second member connecting the first member to the cross member, wherein the second member is configured to receive the engagement feature in order to lock the plurality of legs in the extended position.

2. The bag of claim 1, wherein the latch mechanism comprises one or more arms with a distal end that is angled upwards.

3. The bag of claim 2, wherein the distal end is configured to disengage one or more locking pins from one or more slots formed along or through a surface or a sidewall of the central recessed region when the handle is pulled.

4. The bag of claim 3, wherein the handle assembly is pivotable about the third portion of the shell when the one or more locking pins are disengaged from the one or more slots.

5. The bag of claim 3, wherein the latch mechanism is configured to release the locking pins when the handle is released so that the locking pins reengage the one or more slots.

6. The bag of claim 5, wherein the handle assembly is fixed in place within the central recessed region when the one or more locking pins reengage the one or more slots.

7. The bag of claim 1, wherein the first member comprises a recessed region configured to receive the second member.

8. The bag of claim 7, wherein the first member and the second member are pivotably coupled along an axis extending through the recessed region.

9. The bag of claim 7, wherein the recessed region comprises a sloped bottom surface, a left side wall, a right side wall, and a sloped front wall.

10. The bag of claim 9, wherein the recessed region comprises an aperture or a window extending through the sloped bottom surface and/or the sloped front wall.

11. The bag of claim 10, wherein a portion of the second member is configured to extend or pivot through the aperture or the window.

12. The bag of claim 1, wherein the second member comprises a first end pivotably coupled to the first member and a second end pivotably coupled to the cross member.

13. The bag of claim 12, wherein the second member comprises a body and one or more lobes that are eccentrically shaped.

14. The bag of claim 13, wherein the one or more lobes comprise a slot configured to receive the engagement feature when the plurality of legs are in the extended position.

15. The bag of claim 13, wherein the one or more lobes are configured to extend or pivot through a portion or a section of the first member.

16. The bag of claim 13, wherein the body of the second member is wider and/or longer than the one or more lobes.

17. The bag of claim 13, wherein the one or more lobes have a greater height and/or thickness than the body of the second member.

18. The bag of claim 13, wherein the one or more lobes are positionally offset from a center line extending laterally across the body of the second member.

19. The bag of claim 13, wherein the one or more lobes are configured to extend past the first end of the body of the second member.

20. The bag of claim 13, wherein the second member comprises an opening or a window extending through the body of the second member.
